(19) United States
(12) Patent Application Publication
(10) Pub. No.: US 2026/0117107 A1
(43) Pub. Date: Apr. 30, 2026

(54) COMPOSITIONS COMPRISING 1,3,3,3-TETRAFLUOROPROPENE, METHODS OF MAKING SAME, AND USES THEREOF

(71) Applicant: THE CHEMOURS COMPANY FC, LLC, Wilmington, DE (US)

(72) Inventors: SHENG PENG, Hockessin, DE (US); JOSHUA HUGHES, Wilmington, DE (US); MICHAEL A. BRADLEY, Hockessin, DE (US); LUKE DAVID SIMONI, Wilmington, DE (US)

(73) Assignee: THE CHEMOURS COMPANY FC, LLC, Wilmington, DE (US)

(21) Appl. No.: 19/424,312

(22) Filed: Dec. 18, 2025

Related U.S. Application Data
(63) Continuation-in-part of application No. PCT/US2025/034081, filed on Jun. 18, 2025.
(60) Provisional application No. 63/662,824, filed on Jun. 21, 2024.
(60) Provisional application No. 63/676,034, filed on Jul. 26, 2024.
(60) Provisional application No. 63/678,588, filed on Aug. 2, 2024.
(60) Provisional application No. 63/808,836, filed on May 20, 2025.

(51) Int. Cl. C09K 5/04

(52) U.S. Cl. CPC C09K 5/044; C09K 2205/122; C09K 2205/126

(57) ABSTRACT

Disclosed herein are fluoroolefin compositions, methods of producing the same, methods and systems using the same, and systems containing the HFO-1234ze compositions. The inventive compositions are useful as refrigerants in air conditioning and refrigeration systems, and also as blowing agents.

### CROSS-REFERENCE TO RELATED APPLICATIONS

This application is a Continuation-in-Part of International PCT Application No. PCT/US2025/034081 filed Jun. 18, 2025, which claims the benefit of priority of U.S. Provisional Application 63/662,824 filed Jun. 21, 2024, U.S. Provisional Application 63/676,034 filed Jul. 26, 2024, U.S. Provisional Application 63/678,588 filed Aug. 2, 2024, and U.S. Provisional Application 63/808,836 filed May 20, 2025, the disclosure of each of which is incorporated herein by reference it its entirety.

### FIELD OF THE INVENTION

The present invention is directed to fluoropropene compositions, methods of producing the same, and methods and systems using the same.

### BACKGROUND OF THE INVENTION

The fluorocarbon industry has been working for the past few decades to find replacement refrigerants for the ozone depleting chlorofluorocarbons (CFCs) and hydrochlorofluorocarbons (HCFCs) being phased out as a result of the Montreal Protocol. The solution for many applications has been the commercialization of hydrofluorocarbon (HFC) compounds for use as refrigerants, solvents, fire extinguishing agents, blowing agents and propellants. These new compounds, such as HFC refrigerants, HFC-134a and HFC-125 being the most widely used at this time, have zero ozone depletion potential (ODP) and thus are not affected by the current regulatory phase-out as a result of the Montreal Protocol. In addition to ozone depleting concerns, global warming is another environmental concern in many of these applications. HFC refrigerants such as HFC-134a and HFC-125 respectively have global warming potentials (GWP) of 1,300 and 3,170 according to the UN's IPCC Fifth Assessment Report (AR5).

This regulatory landscape is continuously evolving, taking into consideration properties beyond just ODP and GWP. More particularly, there is a need for refrigerant compositions that not only meet low ODP standards and have low global warming potentials, but that also exhibit low or no flammability, provide superior performance in a variety of applications and which meet the standards of evolving regulations.

There is a need in this art for new refrigerant compositions that meet evolving regulations as well as provide heat transfer and refrigerant characteristics that meet or exceed the effectiveness of conventional refrigerants and refrigerant blends.

1,3,3,3-tetrafluoropropene (HFO-1234ze) (CF₃CH═CHF), like HFO-1234yf, has zero ozone depletion and very low global warming potential, and has thus been identified as a potential useful refrigerant. For example, U.S. Pat. No. 7,862,742 discloses compositions comprising HFO-1234ze and HFO-1234yf. U.S. Pat. No. 9,302,962 discloses methods for making HFO-1234ze. The disclosures of U.S. Pat. Nos. 7,862,742 and 9,302,962 are hereby incorporated by reference in their entireties.

1,3,3,3-tetrafluoropropene (HFO-1234ze) exists as both a Z-isomer and an E-isomer. The Z-isomer, in particular, i.e., HFO-1234ze(Z), which has zero ozone depletion and very low global warming potential and with a boiling point of 10.6° C., possesses physical properties that make it an attractive option for heat pump and air conditioning applications or for use as a blowing agent, either as a single fluid or in blends.

The instant invention provides economical manufacturing processes to make HFO-1234ze(Z) and provide HFO-1234ze(Z)-based compositions which meet the evolving regulatory landscape.

### SUMMARY OF THE INVENTION

The foregoing general description and the following detailed description are exemplary and explanatory only and are not restrictive of the invention, as defined in the appended claims. The various embodiments of the invention can be used alone or in combinations with each other. Other features and advantages of the present invention will be apparent from the following more detailed description of the preferred embodiment, taken in conjunction with the accompanying drawings, which illustrate, by way of example, the principles of the invention.

In one aspect, the invention relates to a process of preparing 1,1,1,3,3-pentafluoropropane (CF₃CH₂CHF₂, HFC-245fa), the process comprising fluorinating 1,1,1,3,3-pentachloropropane (CCl₃CH₂CHCl₂, HCC-240fa) with a fluorination agent in the presence of a fluorination catalyst under conditions which are free of or substantially free of a superacid, to produce a reaction mixture comprising HFC-245fa.

In one aspect, the invention relates to a process of preparing a mixture comprising Z-1,3,3,3-tetrafluoropropene and E-1,3,3,3-tetrafluoropropene, the process comprising: (i) reacting vinyl chloride (CH₂═CHCl) and carbon tetrachloride (CCl₄) in the presence of catalyst system comprising a metal-containing compound and a phosphorus-containing compound to make a reaction mixture comprising 1,1,1,3,3-pentachloropropane (CCl₃CH₂CHCl₂, HCC-240fa); (ii) fluorinating the HCC-240fa with a fluorination agent in the presence of a fluorination catalyst under conditions which are free of or substantially free of a superacid, to produce a reaction mixture comprising 1,1,1,3,3-pentafluoropropane (CF₃CH₂CHF₂, HFC-245fa); and (iii) contacting HFC-245fa in the gas phase with a catalyst, in the presence of an oxygen containing gas, to form a reaction mixture comprising Z-1,3,3,3-tetrafluoropropene and E-1,3,3,3-tetrafluoropropene.

### BRIEF DESCRIPTION OF THE SEVERAL VIEWS OF THE DRAWINGS

The following detailed description of preferred embodiments of the present invention will be better understood when read in conjunction with the appended drawing. For the purposes of illustrating the invention, there is shown in the drawing an embodiment which is presently preferred. It is understood, however, that the invention is not limited to the precise arrangements and instrumentalities shown. In the drawings:

FIG. 1 depicts a distillation step of an integrated process according to a first embodiment of the present invention;

FIGS. 2A-2B depict the integrated process according to embodiments of the present invention;

FIG. 3 depicts a distillation step of an integrated process according to a second embodiment of the present invention;

FIG. 4 depicts a distillation process to separate HFO-1234ze(Z) from HFO-1234ze(E);

FIG. 5 depicts the integrated process according to the first embodiment of the present invention;

FIG. 6 depicts the integrated process according to the first embodiment of the present invention, including a step of isomerizing HFO-1234ze(E) to HFO-1234ze(Z);

FIGS. 7-8 show combination with other compounds and/or adjust of component ratios as needed for desired blend composition;

FIG. 9 depicts an exemplary pressure swing distillation system and method for separation of HFC-245fa and HF, according to an embodiment of the present invention;

FIG. 10 depicts an exemplary extractive distillation system and method for separation of HFO-1234ze(E) and HFO-1234ze(Z) from HFC-245fa;

FIG. 11 is a T-x (temperature-mass %) phase diagram of a binary composition of HFO-1234ze(Z) and isobutane;

FIG. 12 is a T-x (temperature-mass %) phase diagram of a binary composition of HFO-1234ze(Z) and butane;

FIG. 13 is a T-x (temperature-mass %) phase diagram of a binary composition of HFO-1234ze(Z) and pentane;

FIGS. 14A, 14B and 14C provide graphical representations of the average glide, the CAP relative to the incumbent fluid, and the COP relative to the incumbent fluid, respectively, for a composition according to Example 6;

FIGS. 15A, 15B and 15C provide graphical representations of the average glide, the CAP relative to the incumbent fluid, and the COP relative to the incumbent fluid, respectively, for a composition according to Example 7;

FIGS. 16A, 16B and 16C provide graphical representations of the average glide, the CAP relative to the incumbent fluid, and the COP relative to the incumbent fluid, respectively, for a composition according to Example 8;

FIGS. 17A, 17B and 17C provide graphical representations of the average glide, the CAP relative to the incumbent fluid, and the COP relative to the incumbent fluid, respectively, for a composition according to Example 9;

FIGS. 18A, 18B and 18C provide graphical representations of the average glide, the CAP relative to the incumbent fluid, and the COP relative to the incumbent fluid, respectively, for a composition according to Example 10;

FIGS. 19A, 19B and 19C provide graphical representations of the average glide, the CAP relative to the incumbent fluid, and the COP relative to the incumbent fluid, respectively, for a composition according to Example 11;

FIGS. 20A, 20B and 20C provide graphical representations of the average glide, the CAP relative to the incumbent fluid, and the COP relative to the incumbent fluid, respectively, for a composition according to Example 14;

FIG. 21 is a graphical representation of compositions according to Example 14 in terms of the bubble point pressure (BP) and dew point pressure (DP);

FIGS. 22A, 22B and 22C provide graphical representations of the average glide, the CAP relative to the incumbent fluid, and the COP relative to the incumbent fluid, respectively, for a composition according to Example 15; and

FIGS. 23A and 23B are graphical representations of compositions according to Example 15 in terms of the bubble point pressure (BP) and dew point pressure (DP).

### DETAILED DESCRIPTION OF THE INVENTION

### Definitions

A refrigerant is defined as a heat transfer fluid that undergoes a phase change from liquid to gas and back again during a cycle used to transfer of heat.

A heat transfer system is the system (or apparatus) used to produce a heating or cooling effect in a particular space. A heat transfer system may be a mobile system or a stationary system.

Examples of heat transfer systems are any type of refrigeration systems and air conditioning systems including, but are not limited to, stationary heat transfer systems, air conditioners, freezers, refrigerators, heat pumps, flooded evaporator heat pumps, direct expansion chillers heat pumps, chillers, flooded evaporator chillers, direct expansion chillers, walk-in coolers, mobile refrigerators, mobile heat transfer systems, mobile heat pumps, mobile air conditioning units, dehumidifiers, submerged (immersion) cooling systems, data center cooling systems, semiconductor chip cooling systems, outdoor communication equipment cooling systems and combinations thereof.

Refrigeration capacity (also referred to as cooling capacity) is a term which defines the change in enthalpy of a refrigerant in an evaporator per pound of refrigerant circulated, or the heat removed by the refrigerant in the evaporator per unit volume of refrigerant vapor exiting the evaporator (volumetric capacity). The refrigeration capacity is a measure of the ability of a refrigerant or heat transfer composition to produce cooling. Therefore, the higher the capacity, the greater the cooling that is produced. Cooling rate refers to the heat removed by the refrigerant in the evaporator per unit time.

Coefficient of performance (COP) is the amount of heat removed divided by the required energy input to operate the cycle. The higher the COP, the higher is the energy efficiency. COP is directly related to the energy efficiency ratio (EER) that is the efficiency rating for refrigeration or air conditioning equipment at a specific set of internal and external temperatures.

As used herein, a working fluid is a composition comprising a compound or mixture of compounds that primarily function to transfer heat from one location at a lower temperature (e.g., an evaporator) to another location at a higher temperature (e.g., a condenser) in a cycle wherein the working fluid undergoes a phase change from a liquid to a vapor, is compressed and is returned back to liquid through cooling of the compressed vapor in a repeating cycle. The cooling of a vapor compressed above its critical point can return the working fluid to a liquid state without condensation. The repeating cycle may take place in systems such as heat pumps, refrigeration systems, refrigerators, freezers, air conditioning systems, air conditioners, chillers, and the like. Working fluids may be a portion of formulations used within the systems. The formulations may also contain other chemical components (e.g., additives) such as those described below.

The term “subcooling” refers to the reduction of the temperature of a liquid below that liquid's saturation point for a given pressure. The saturation point is the temperature at which the vapor is completely condensed to a liquid, but subcooling continues to cool the liquid to a lower temperature liquid at the given pressure. By cooling a liquid below the saturation temperature (or bubble point temperature), the net refrigeration capacity can be increased. Subcooling thereby improves refrigeration capacity and energy efficiency of a system. Subcool amount is the amount of cooling below the saturation temperature (in temperature units).

Superheat is a term that defines how far above its saturation vapor temperature (the temperature at which, if the composition is cooled, the first drop of liquid is formed, also referred to as the “dew point”) a vapor composition is heated. By heating a vapor above the saturation point, the likelihood of condensation upon compression is minimized, and thus superheating minimizes the risk of liquid entering the compressor. The superheat can also contribute to the cycle's cooling and heating capacity.

Temperature glide (sometimes referred to simply as “glide”) is the absolute value of the difference between the starting and ending temperatures of a phase-change process by a refrigerant within a component of a refrigerant system, exclusive of any subcooling or superheating. This term may be used to describe condensation or evaporation of a zeotropic composition. When referring to the temperature glide of a refrigeration, air conditioning or heat pump system, it is common to provide the average temperature glide being the average of the temperature glide in the evaporator and the temperature glide in the condenser.

The net refrigeration effect is the quantity of heat that each kilogram of refrigerant absorbs in the evaporator to produce useful cooling.

The mass flow rate is the quantity of refrigerant in kilograms circulating through the refrigeration, heat pump or air conditioning system over a given period of time.

As used herein, the term “lubricant” means any material added to a composition or a compressor (and in contact with any heat transfer composition in use within any heat transfer system) that provides hydrodynamic lubrication to the compressor to aid in preventing parts from seizing.

Flammability is a term used to mean the ability of a composition to ignite and/or propagate a flame. For refrigerants and other heat transfer compositions, the lower flammability limit (“LFL”) is the minimum concentration of the heat transfer composition in air that is capable of propagating a flame through a homogeneous mixture of the composition and air under test conditions specified in ASTM (American Society of Testing and Materials) E681. The upper flammability limit (“UFL”) is the maximum concentration of the heat transfer composition in air that is capable of propagating a flame through a homogeneous mixture of the composition and air under the same test conditions. Determination of whether a refrigerant compound or mixture able to propagate a flame or not is also done by testing under the conditions of ASTM E-681.

During a refrigerant leak, the more volatile components of a mixture may leak preferentially. Thus, the composition in the system as well as the vapor leaking can vary over the time period of the leak. Thus, a non-flammable mixture may become able to propagate a flame under leakage scenarios. In order to be classified as non-flammable by ASHRAE (American Society of Heating, Refrigeration and Air-conditioning Engineers), a refrigerant or heat transfer composition must be non-flammable as formulated, but also under leakage conditions.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced. For mixtures, a weighted average can be calculated based on the individual GWPs for each component.

Ozone depletion potential (ODP) is a number that refers to the amount of ozone depletion caused by a substance. The ODP is the ratio of the impact on ozone of a chemical compared to the impact of a similar mass of CFC-11 (fluorotrichloromethane). Thus, the ODP of CFC-11 is defined to be 1.0. Other CFCs and HCFCs have ODPs that range from 0.01 to 1.0. HFCs and HFOs have zero ODP because they do not contain chlorine or other ozone depleting halogens.

An azeotropic composition may refer to a constant-boiling mixture of two or more substances that behave as a single substance. One way to characterize an azeotropic composition is that the vapor produced by partial evaporation or distillation of the liquid has the same composition as the liquid from which it is evaporated or distilled. For example, the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a refrigeration or air conditioning system during operation. Additionally, an azeotropic composition will not fractionate upon leakage from a refrigeration or air conditioning system.

As used herein, “near-azeotrope” or “azeotrope-like” refers to a composition of two or more refrigerant compounds that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. In contrast, the vapor and liquid compositions of non-near-azeotrope compositions change to a substantial degree during boiling or evaporation. As used herein, “near-azeotrope” refers to a composition exhibiting near-azeotropic behavior.

As used herein, “near-azeotropic behavior” refers to a behavior exhibiting dew point pressure and bubble point pressure with virtually no pressure differential. In some embodiments, the difference in the dew point pressure and bubble point pressure at a given temperature is 10% or less, alternatively 9% or less, alternatively 8% or less, alternatively 7% or less, alternatively 6% or less, alternatively 5% or less, alternatively 4% or less, alternatively 3% or less, alternatively 2% or less, alternatively 1% or less, or any value, range, or sub-range therebetween. In some instances, certain of the Examples identify azeotropes or near azeotropes based on a difference between the dew point pressure and bubble point pressure at a given temperature is 5% or less. However, it will be understood by those skilled in the art that this difference may be higher, e.g., 10% or less, for characterization of a near azeotropic composition.

Another manner to characterize a near-azeotropic composition is that the bubble point vapor pressure and the dew point pressure of the composition at a particular temperature are substantially the same. Herein, a composition of the invention is near-azeotropic if, after 50 weight percent (50 wt. %) of the composition is removed, such as by evaporation or boiling off, the difference in vapor pressure, between the original composition and the composition remaining after 50 weight percent of the original composition has been removed, is less than about 10 percent (10%).

A near-azeotropic composition can also be characterized by the area that is adjacent to the maximum or minimum bubble-point pressure in a plot of composition vapor pressure at a given temperature as a function of mole fraction of components in the composition.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do not materially affect the basic and novel characteristic(s) of the claimed invention. The term ‘consisting essentially of’ occupies a middle ground between “comprising” and ‘consisting of’. Typically, components of the refrigerant mixtures and the refrigerant mixtures themselves can contain minor amounts (e.g., less than about 0.5 weight percent total) of impurities and/or byproducts (e.g., from the manufacture of the refrigerant components or reclamation of the refrigerant components from other systems) which do not materially affect the novel and basic characteristics of the refrigerant mixture.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein the term “about” in certain embodiments can be quantified to mean±1%, ±2%, ±3% and up to and including ±10% of the stated value, and all whole numbers and fractions therebetween.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### Processes of Making

In one embodiment, the present invention relates to methods of producing 1,1,1,3,3-pentachloropropane (CCl₃CH₂CHCl₂, HCC-240fa) by reaction of carbon tetrachloride (CCl₄) with vinyl chloride (CH2=CHCl) in the liquid phase.

In one embodiment, the present invention relates to methods of producing 1,1,1,3,3-pentafluoropropane (CF₃CH₂CHF₂, HFC-245fa) by fluorination of the HCC-240fa in the liquid phase, preferably in the presence of a fluorination catalyst, and under conditions which are free of or substantially free of a superacid.

In one embodiment, the present invention relates to methods of producing 1,3,3,3-tetrafluoropropene (CF₃CH═CHF, HFO-1234ze) by way of an integrated sequence of reactions. In one embodiment, the present invention relates to methods of producing E-1,3,3,3-tetrafluoropropene (E-HFO-1234ze or HFO-1234ze(E)) and Z-1,3,3,3-tetrafluoropropene (Z-HFO-1234ze or HFO-1234ze(Z)) by way of an integrated sequence of reactions.

In one embodiment, the present invention relates to methods of producing a mixture of HFO-1234ze(E) and HFO-1234ze(Z) by way of an integrated sequence of reactions, separation, and/or purification.

In one embodiment, the present invention relates to methods of producing HFO-1234ze(Z) by way of an integrated sequence of reactions, separation, and/or purification.

In some embodiments, the present invention provides an integrated process for producing HFO-1234ze(Z) or a mixture comprising both HFO-1234ze(Z) and HFO-1234ze(E).

In one embodiment, the integrated sequence of reactions of the present invention is carried out in a reactor comprising a series of reaction zones in fluid communication with each other. In another embodiment, the integrated sequence of reactions of the present invention is carried out in a series of reactors, each of which comprises a reaction zone, in fluid communication with each other. In certain embodiments, each reactor is a cylindrical tube or pipe, which may be straight or coiled. The reactors are depicted as boxed labeled with a step number in the accompanying figures.

In some embodiments, one or more, and preferably all, of the steps of the integrated process are carried out in a common location or facility, or in locations or facilities which are proximate each other. In some embodiments, the outlet of a first reactor for a first reaction is preferably in fluid communication with the inlet of a downstream reactor for a second reaction, and so forth, thereby eliminating the need for storage, handling and/or transportation of the product of each reaction. In other embodiments, where separate reactors are used for each reaction of the integrated process, the reactors are all located at a common manufacturing site, and the product produced in each reactor may be stored onsite, if needed, or may be transferred directly from an upstream reactor to a downstream reactor via piping, tubing, etc. which fluidly connects the reactors. In some embodiments, the integrated process is preferably carried out proximate a hydrogen fluoride manufacturing site, and/or proximate a vinyl chloride manufacturing site, and/or proximate a carbon tetrachloride manufacturing site.

In addition to the reactors disclosed herein, heaters, effluent lines, units associated with mass transfer, contacting vessels (pre-mixers), distillation columns, and feed and material transfer lines associated with reactors, heaters, vessels, columns, and units that are used in the processes of embodiments disclosed herein should be constructed of materials resistant to corrosion, such as those recited herein with respect to the reactors.

In one embodiment, the integrated process comprises reaction of carbon tetrachloride with vinyl chloride in the liquid phase to produce HCC-240fa (Step 1); followed by fluorination of the HCC-240fa in the liquid phase, preferably in the presence of a fluorination catalyst and in the absence of or substantially in the absence of a superacid, to produce HFC-245fa (Step 2); and dehydrofluorination of the HFC-245fa to produce a mixture comprising HFO-1234ze(Z) and HFO-1234ze(E) (Step 3).

In some embodiments, the integrated process further comprises separation of HFO-1234ze(Z) from the mixture produced by Step 3, to obtain a composition comprising HFO-1234ze(Z) as a product of the integrated process.

In some embodiments, the integrated process further comprises separation of HFO-1234ze(Z) or separation of HFO-1234ze(Z) and HFO-1234ze(E) from the mixture produced by Step 3, to obtain a composition comprising either HFO-1234ze(Z) or HFO-1234ze(Z) and HFO-1234ze(E) as a product of the integrated process.

In some embodiments, the integrated process further comprises separation of HFO-1234ze(Z), HFO-1234ze(E) and HFC-245fa from the mixture produced by Step 3, and thus the product of the integrated process is a composition comprising HFO-1234ze(Z), HFO-1234ze(E) and HFC-245fa.

In some embodiments, the integrated process further comprises separation of HFO-1234ze(Z), HFO-1234ze(E), HCFO-1233zd(E) and HFC-245fa from the mixture produced by Step 3, and thus the product of the integrated process is a composition comprising HFO-1234ze(Z), HFO-1234ze(E), HCFO-1233zd(E) and HFC-245fa. The amount of HCFO-1233zd(E) present in the composition produced by the integrated process is preferably less than about 1 wt. % based on the total weight of the composition.

In some embodiments, where the Z isomer is the primary desired product, the integrated process may further comprise an optional step to isomerize any HFO-1234ze(E) which is present in the product mixture to the Z isomer. Thus, in some embodiments, the integrated process further comprises separation and/or recovery of HFO-1234ze(E) from the mixture produced by Step 3 and isomerization of the HFO-1234ze(E) to HFO-1234ze(Z) (optional Step 4).

The reactions of the integrated processes are reflected in the reaction sequences shown below:
Step 1: CCl4+CH2=CHCl→CCl3CH2CHCl2 (HCC-240fa)
Step 2: CCl3CH2CHCl2 (HCC-240fa)+HF→CF3CH2CHF2 (HFC-245fa)
Step 3: CF3CH2CHF2 (HFC-245fa)→CF3CH═CHF (HFO-1234ze(Z))+CF3CH═CHF (HFO-1234ze(E)+HF
Step 4: CF3CH═CHF (HFO-1234ze(E))→CF3CH═CHF (HFO-1234ze(Z)) (Optional)

### CCl4 and CH2=CHCl→HCC-240fa

According to embodiments of the present invention, a method comprises reaction of carbon tetrachloride with vinyl chloride to produce HCC-240fa, for example as disclosed in U.S. Pat. No. 11,731,925 or 6,313,360, the disclosure of each of which is incorporated herein by reference in its entirety. In some embodiments, the method is the first reaction in an integrated process (i.e., integrated sequence of reactions) to produce HFO-1234ze(Z) and/or HFO-1234ze(E).

More particularly, in one embodiment, HCC-240fa may be produced by a metal catalyzed olefin insertion process that includes the use of a metal and a ligand by insertion of an olefin (e.g., vinyl chloride) into a haloalkane reactant (e.g., carbon tetrachloride). In particular, in one embodiment, the olefin insertion process comprises contacting carbon tetrachloride with vinyl chloride in the presence of a catalyst system that consists of metallic iron and a phosphine as set forth in U.S. Pat. No. 11,731,925 or a catalyst system comprising an organophosphate solvent, iron metal and ferric chloride as set forth in U.S. Pat. No. 6,313,360, to produce HCC-240fa under predetermined reaction parameters.

In one embodiment, the invention provides an olefin insertion process comprising contacting carbon tetrachloride with vinyl chloride in the presence of a catalyst system that comprises a catalyst and co-catalyst to produce HCC-240fa under reaction conditions which suppress or minimize formation of byproduct telomers, oligomers, dimers and other polymeric products.

In one embodiment, the carbon tetrachloride feed comprises carbon tetrachloride and one or more additional compounds selected from trichloroethylene (CClH═CCl2), tetrachloroethylene (CCl2=CCl2), hexachloroethane (CCl3CCl3), bromotrichloromethane (CCl3Br), chloroform (CCl3H), 1,1,1-trichloroethane (CCl3CH3), 1,1,2-trichloroethane (CHCl2CH2Cl), trans-1,2-dichloroethylene (E-CHCl=CHCl), cis-1,2-dichloroethylene (Z—CHCl═CHCl) and 1,1-dichloroethylene (CH2=CCl2). In one embodiment, the total amount of the additional compounds is less than 5 wt. %, or less than 4 wt. %, or less than 3 wt. %, or less than 2 wt %, preferably less than 1 wt. %. In one embodiment, the carbon tetrachloride feed comprises at least about 95% by weight, at least about 96% by weight, at least about 97% by weight, at least about 98% by weight, at least about 99% by weight, at least 99.5% by weight, at least 99.6% by weight, at least 99.7% by weight, at least 99.8% by weight, or about 99.9% by weight of carbon tetrachloride and one or more of the additional compounds. In some embodiments, the moisture content of the carbon tetrachloride feed is preferably less than about 100 ppm, or less than about 50 ppm, or less than about 30 ppm, inclusive of all values and ranges therebetween.

In one embodiment, the vinyl chloride feed material for the reaction to produce HCC-240fa comprises vinyl chloride and one or more additional compounds selected from C₂H₄ (FC-1150, ethylene), C₃H₈ (propane), CH₃Cl, methanol, C₂H₃Cl (FC-1140), C₄H₆ (1-butyne), C₄H₄ (1-buten-3-yne), C₃H₈O (CH₃CH₂OCH₃), C₂H₅Cl and C₂H₅Br. In one embodiment, the total amount of the additional compounds is less than 5 wt. %, or less than 4 wt. %, or less than 3 wt. %, or less than 2 wt %, preferably less than 1 wt. %. In one embodiment, the vinyl chloride feed comprises at least about 95% by weight, at least about 96% by weight, at least about 97% by weight, at least about 98% by weight, at least about 99% by weight, at least 99.5% by weight, at least 99.6% by weight, at least 99.7% by weight, at least 99.8% by weight, or about 99.9% by weight of vinyl chloride and one or more of the additional compounds. In some embodiments, the moisture content of the vinyl chloride feed is preferably less than about 100 ppm, or less than about 50 ppm, or less than about 30 ppm, inclusive of all values and ranges therebetween.

In some embodiments, the catalysts useful in the present invention include metal ions and neutral metallic species. Suitable catalysts include, for example, but are not limited to, cuprous salts, cupric salts, organometallic cuprous compounds, metallic iron components, metallic nickel components and iron chlorides. Exemplary cuprous salts and organometallic cuprous compounds include, without limitation, cuprous chloride (CuCl), cuprous bromide, cuprous cyanide, cuprous sulfate, and cuprous phenyl. The iron powder useful in this invention is preferably a fine powder of pure metallic iron, preferably with a particle size smaller than 325 mesh. Preferably, cuprous chloride or iron powder is used as the catalyst.

In certain embodiments, the metallic iron component of the catalyst may be from any source (including a combination of sources) of an iron component, may be any iron containing species such as FeCl₂ and FeCl₃, and may be iron powder, iron shavings, iron wire, iron screen or iron turnings. In other embodiments, copper or copper halides may be used in combination with an organic nitrile compound, such as but not limited to acetonitrile or propionitrile.

In certain embodiments, the metallic iron component of the catalyst may be from any source (including a combination of sources) of a nickel component, may be any nickel containing species, and may be nickel powder, nickel shavings, nickel wire, nickel screen, nickel shots or nickel turnings.

Co-catalysts useful in the present invention include, but are not limited to, organic ligands capable of forming a complex with the catalyst used and capable of bringing the catalyst into solution.

In some embodiments, suitable ligands include organic amines, such as, without limitation, tert-butylamine, n-butylamine, sec-butylamine, 2-propylamine, benzylamine, tri-n-butylamine, pyridine and combinations thereof. In one embodiment, the preferred organic amine is tert-butylamine. Alternatively, the co-catalyst may be a nitrile including, without limitation, acetonitrile, propionitrile, n-butyronitrile, benzonitrile, phenylacetonitrile and combinations thereof. In one embodiment, the preferred nitrile is acetonitrile particularly where the catalyst is a copper containing material.

As another alternative, the co-catalyst may be an amide including, without limitation, hexamethylphosphoramide (HMPA), dimethylformamide and combinations thereof. In one embodiment, hexamethylphosphoramide is the most preferred amide. Also suitable are combinations of amines, nitriles, amides, phosphines and phosphates.

The co-catalysts are chelating agents and may also serve as solvents. In some embodiments, a solvent may help dissolve the solid catalyst. When a solvent is used, it preferably serves as the co-catalyst. Useful solvents non-exclusively include nitrile compounds. The catalysts, co-catalysts and solvents useful in the present invention are commercially available.

In some embodiments, the co-catalyst is a phosphorous containing compound, such as a phosphine ligand, such as an alkylphosphine or arylphosphine, including but not limited to triphenyl phosphine, tributyl phosphine and the like. In one embodiment, the phosphine ligand comprises triphenylphosphine. In another embodiment, the phosphine ligand consists essentially of triphenylphosphine. In another embodiment, the phosphine ligand consists of triphenylphosphine.

In other embodiments, the catalyst may comprise a phosphorous containing compound, such as a phosphate, such as but not limited to, trimethyl phosphate, triethyl phosphate, tripropyl phosphate, tributyl phosphate, diethyl phosphate, dibutyl phosphate, monophenyl phosphate, monobutyl phosphate, dimethylphenyl phosphate, diethylphenyl phosphate, dimethylethyl phosphate, phenyl ethyl methyl phosphate and a C5 to C20 long chain phosphate.

The catalysts and co-catalysts useful in the present invention form a catalyst system. In one embodiment, the catalyst is selected from cuprous salts, organometallic cuprous compounds, iron wire, iron shavings, iron powder, iron chlorides, nickel powder, nickel shavings, nickel wire, nickel screen, nickel shots or nickel turnings. In one embodiment, the co-catalyst is selected from organic amines, nitriles, amides, phosphates, phosphines and combinations thereof.

In one embodiment of the catalyst system, the catalyst is CuCl and the co-catalyst is acetonitrile (CH₃CN), tert-butylamine (t-Bu-NH₂), n-butylamine (n-Bu-NH₂), sec-butylamine (sec-Bu-NH₂), benzyl-amine (benzyl-NH₂), ethanol-amine, pyridine or tri-n-butylamine (n-Bu₃N). In another embodiment of the catalyst system, the catalyst is iron powder, or iron wire, and/or ferric chloride and the co-catalyst is HMPA, tributylphosphite ((BuO)₃P), trichloroethylphosphite ((ClCH₂CH₂O)₃P), triphenylphosphite ((PhO)₃P), tributylphosphate, or triphenylphosphate. In another embodiment of the catalyst system, the catalyst system is cuprous chloride/tert-butylamine, cuprous chloride/acetonitrile, iron powder/hexamethylphosphoramide or iron powder/tributylphosphate. Most preferably, cuprous chloride/tert-butylamine or iron powder/tributylphosphate is used.

In some embodiments, the iron catalyst comprises iron metal, iron oxide, iron hydrate, and/or iron hydroxide during the reaction start-up or when a new iron catalyst is introduced to replace an old or spent catalyst. However, over the course of the reaction, the iron halides concentration increases and thus iron halide become the dominant catalyst of the catalyst system.

In some embodiments, the moisture content of the catalyst system is preferably less than about 1000 ppm, or less than about 750 ppm, or less than about 500 ppm, inclusive of all values and ranges therebetween.

Metal salts, especially metal halides, and organic phosphate esters or nitrile complexes produces free chloride ions, trace HCl formation and/or iron halides which, in the presence of moisture, lead to free chloride in an acidic environment and corrosive media. Accordingly, in some embodiments, the total moisture present in the reactor for this insertion reaction is controlled or maintained to be below 500 ppm, preferably below 200 ppm, more preferably below 100 ppm, to minimize corrosion in the reaction.

The reaction product produced by the reaction of CCl₄ with vinyl chloride preferably comprises HCC-240fa and one or more additional compounds. In one embodiment, the one or more additional compounds are selected from 1-chlorobutane; 1,2,3-trichloropropene (CHCl═CCl—CH2Cl, HCO-1240xd); HCO-1230xd (CHCl═CCl—CHCl2, 1,2,3,3-tetrachloropropene); 1,1,1,3-tetrachloropropane (CCl3-CH2-CH3, HCC-250fb); 1,4 dichlorobutane; 1,2-dichloro-cyclobutane, 1,1,4,4-tetrachlorobutadiene; 1,1,3,4 tetrachlorobutadiene; 1,1,1,2,3-pentachloropropane (HCC-240db); 1,1,3,3-tetrachloro-1-propene (CCl2=CH—CHCl2); C₅H₇Cl₃ isomer(s), C₄H₇Cl₃ isomer(s), and mixtures thereof, or at least two additional compounds or at least three additional compounds or more.

In some embodiments, the reaction is carried out under conditions which suppress or minimize formation of byproduct telomers, oligomers, dimers and other polymeric products, particularly those of the formula CCl₃(CH₂CHCl)ₙCl, where n≥2. As such, according to the present invention, the formation of waste, such as byproduct telomers, oligomers, dimers and other polymeric products is minimized or suppressed by running the reaction at a pressure no greater than 50 psig, preferably no greater than 45 psig, and more preferably no greater than 40 psig. In some embodiments, corrosion can be minimized by controlling the moisture content to be about 500 ppm or less, or about 200 ppm or less, or about 100 ppm or less. In one embodiment, the iron catalyst comprises iron metal, iron oxide, iron hydrate, and/or iron hydroxide.

In some embodiments, the product stream of the process of the present invention, as described above for the production of HCC-240fa, comprises, consists essentially of, or consists of, HCC-240fa, one or more of the additional compounds, and less than about 10 wt. % byproduct telomers, oligomers, dimers and other polymeric products of the formula CCl₃(CH₂CHCl)ₙCl, where n≥2, more preferably less than about 8 wt. %, more preferably less than about 6 wt. %, or less than about 5 wt. %, or less than about 4 wt. %, or less than about 3 wt. %, or less than about 2 wt. % or less than about 1 wt. %, or less than about 0.5 wt. %, based on a total weight of the product stream.

In one embodiment, the total amount of additional compound(s) in the HCC-240fa composition ranges from greater than 0 wt. % to less than or equal to about 5 wt. %, about 4 wt. %, about 3 wt. %, about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, or from 0.1 ppm (weight) to about 1 wt. %, or from 0.001 wt. % to about 1 wt. %, or from 0.001 wt. % to about 0.5 wt. %, or from 0.001 wt. % to 0.4 wt. % or less, or from 0.001 wt. % to 0.1 wt. % or less, or about 0.1 wt. %, based on the total weight of the composition, and all values and integers between all such ranges.

In one embodiment, the HCC-240fa reaction product/feed composition comprises at least about 95% by weight, at least about 96% by weight, at least about 97% by weight, at least about 98% by weight, at least about 99% by weight, at least 99.5% by weight, at least 99.6% by weight, at least 99.7% by weight, at least 99.8% by weight, or about 99.9% by weight of HCC-240fa and the one or more additional compounds.

In one embodiment, the HCC-240fa is utilized as a feed material for subsequent reactions in the integrated process disclosed herein, namely for production of HFC-245fa under conditions which are free of or substantially free of a superacid.

### CCl3CH2CHCl2 (HCC-240fa)+HF→CF3CH2CHF2 (HFC-245fa)

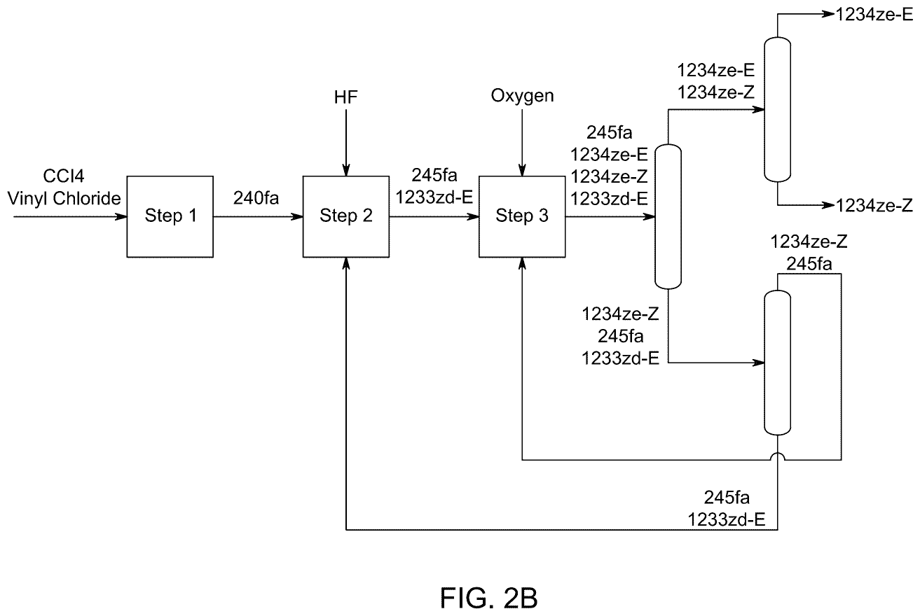

In one embodiment, as shown in FIGS. 2A-2B, a method of the present invention comprises reacting HCC-240fa with hydrogen fluoride (HF), in the liquid phase, preferably in the presence of a fluorination catalyst, under conditions which are free of or substantially free of a superacid, to form a reaction product comprising HFC-245fa. According to the present invention, HCC-240fa fluorination is carried out in the absence of or substantially in the absence of a superacid, to form a reaction product comprising HFC-245fa.

In some embodiments, the method is the second reaction in the integrated process (i.e., integrated sequence of reactions) to produce HFO-1234ze(Z) and/or HFO-1234ze(E). Thus, in some embodiments, the source of the HCC-240fa feed is the product of the first reaction (i.e., reaction of carbon tetrachloride and vinyl chloride).

In some embodiments, the catalyst for the fluorination of the HCC-240fa is a Lewis acid catalyst, such as a metal halide catalyst, including but not limited to antimony halides, tin halides, thallium halides, iron halides and combinations of two or more. In some embodiments, the metal halide catalyst comprises at least one metal selected from Sb, Ta, Nb, Sn, Ti and combinations thereof. In certain embodiments, metal chlorides and metal fluorides are employed, including but not limited to SbCl₅, SbCl₃, SbF₅, SnCl₄, TiCl₄, NiF₅, FeCl₃, and combinations of two or more of these.

In some embodiments, examples of liquid phase fluorination catalysts include but are not limited to antimony halide, tin halide, tantalum halide, titanium halide, niobium halide, molybdenum halide, iron halide, fluorinated chrome halide, fluorinated chrome oxide or combinations thereof. In some embodiments, examples of liquid phase fluorination catalysts include but are not limited to SbCl₅, SbCl₃, SbF₅, SnCl₄, TaCl₅, TiCl₄, NbCl₅, MoCl₆, FeCl₃, fluorinated species of SbCl₅, fluorinated species of SbCl₃, fluorinated species of SnCl₄, fluorinated species of TaCl₅, fluorinated species of TiCl₄, fluorinated species of NbCl₅, fluorinated species of MoCl₆, fluorinated species of FeCl₃, or combinations thereof. These catalysts can be readily regenerated by any means known in the art if they become deactivated.

In one embodiment, the liquid phase fluorination catalyst is selected from SbCl₅, SnCl₄, TaCl₅, TiCl₄, NbCl₅, and fluorinated species thereof. In another embodiment, the liquid phase fluorination catalyst is selected from SbCl₅, SnCl₄, TaCl₅, TiCl₄ and/or fluorinated species thereof. In another embodiment the liquid phase fluorination catalyst is SbF₅ or SbCl₅.

In one embodiment, the fluorination catalyst is MFₓ, MClₓ, where M is a metal and x is an integer from 1 to 5. In some embodiments, the fluorination catalyst is MFₓCl_{y}, where M is a metal, x+y=5, and neither x nor y can equal 0.

As used herein, a superacid is any acid system that is stronger than 100% sulfuric acid and that has an H0 (Hammett acidity function) of ≤−12. See, e.g., Superacid Chemistry, Olah, George A. et al., Wiley (2009). More specifically, as used herein, a superacid or superacid system includes, but is not limited to, an acid of the formula HₓF_{y}+MF₆₋, where M is one of Sb, Ta, and Nb, where x=1, and where y=0 or where x/y>1.

In one embodiment, HCC-240fa fluorination is carried out for a predetermined duration under conditions free of (i.e., in the absence of) a superacid to form a reaction product comprising HFC-245fa, and under conditions selected to avoid the formation of a superacid. For example, the concentrations of MFₓ or MClₓ, or MFₓCl_{y}, HF, and HCC-240fa for the HCC-240fa fluorination reaction are selected to avoid the formation of a superacid.

In one embodiment, HCC-240fa fluorination is carried out for a predetermined duration under conditions substantially free of (i.e., substantially in the absence of) a superacid to form a reaction product comprising HFC-245fa, and under conditions selected to avoid or minimize the formation of a superacid. For example, the concentrations of the MFₓ or MClₓ, or MFₓCl_{y}, HF, and HCC-240fa for the HCC-240fa fluorination reaction are selected to avoid or minimize the formation of a superacid.

As used herein in terms of the presence of a superacid, “substantially free of” or “substantially in the absence of” means that less than 5 mol % of a superacid is present or formed during the reaction, based on the total metal concentration of the catalyst system.

The HFC-245fa may be separated from any other compounds present in the reaction product by conventional techniques such as distillation. Azeotropic compositions of HFC-245fa and HF can be produced in this manner, as is known in the art, and thus in some embodiments may be subjected to azeotropic distillation in order to isolate the HFC-245fa.

According to this process, the conversion is between about 80% to about 100%. According to this process, selectivity of HFC-245fa is between about 90% to about 95%.

In one embodiment, a molar ratio of HCC-240fa to HF is from about 1:1 to about 50:1, preferably from about 1:1 to about 30:1.

In one embodiment, a molar ratio of HCC-240fa to the catalyst is from about 0.02 to about 1, preferably from about 0.2 to about 1.

In one embodiment, a molar ratio of HF to the catalyst is from about 1:1 to about 5.9:1, preferably from about 1:1 to about 5:1.

The overall concentrations of the fluorination catalyst, HF, and HCC-240fa for the HCC-240fa fluorination reaction are selected to avoid or minimize the formation of a superacid.

In one embodiment, the reaction may be carried out at a temperature of between about 80° C. to about 150° C., or between about 90° C. to about 140° C.

In one embodiment, the reaction is conducted at a pressure of from about 50 psig to about 500 psig, preferably from about 80 psig to about 300 psig. In general, increasing the pressure in the reactor above atmospheric pressure will act to increase the contact time of the reactants in the process. Longer contact times will necessarily increase the degree of conversion in a process, without having to increase temperature.

Depending on the temperature of the reactor, the product mixture from the reactor will contain varying amounts of unreacted HCC-240fa and other constituents.

In one embodiment, the reaction mixture produced by the fluorination of HCC-240fa comprises HFC-245fa and one or more additional compounds selected from Table 1 and/or Table 2, or at least two additional compounds or at least three additional compounds or more.

TABLE 1

| Name | Structure | Chemical Name |
|---|---|---|
| HFC-143a | CF3—CH3 | 1,1,1-trifluoroethane |
| HCFO-1225zc | CF2═CH—CCl2F | 3,3-dichloro-1,1,3-trifluoropropene |
| HFC-236fa | CF3—CH2—CF3 | 1,1,1,3,3,3-Hexafluoropropane |
| HFO-E/Z-1234ze | CHF═CH—CF3 | 1,3,3,3-tetrafluoropropene |
| HCFC-22 | CHClF2 | Chlorodifluoromethane |
| CFC-12 | CCl2F2 | Dichlorofluoromethane |
| HCFC-142b | CClF2—CH3 | 1-Chloro-1,1-difluoroethane |
| HCFC-133a | CH2Cl—CF3 | 1-Chloro-2,2,2-Trifluoroethane |
| HCFO-1224 | C3HClF4 | N/A |
| HCFC-235fa | CClF2—CH2—CF3 | 1-Chloro-1,1,3,3,3-pentafluoropropane |
| HCFO-1233 | C3H2ClF3 | N/A |
| HCFC-235da | CF3—CHCl—CHF2 | 2-Chloro-1,1,1,3,3-pentafluoropropane |
| HCFC-123 | CHCl2—CF3 | 1,1-Dichloro-2,2,2-trifluoroethane |
| HCFC-141b | CCl2F—CH3 | 1,1-Dichloro-1-fluoroethane |
| HCFC-234fb | CCl2F—CH2—CF3 | 1,1-Dichloro-1,3,3,3-tetrafluoropropane |
| HCFO-1223xd | CHCl═CCl—CF3 | 1,2-dichloro-3,3,3-trifluoropropene |
| HCC-20 | CHCl3 | trichloromethane (chloroform) |
| HCFC-224aa | CHClF—CCl2—CF3 | 1,2,2-trichloro-1,3,3,3-tetrafluoropropane |
| CFO-1213xa | CCl2═CCl—CF3 | 1,1,2-trichloro-3,3,3-trifluoropropene |
| HCFC-233da | CHCl2—CHCl—CF3 | 1,1,2-Trichloro-3,3,3-trifluoropropane |
| HCFC-223aa | CHClF—CCl2—CHF2 | 1,2,2-trichloro-1,3,3-trifluoropropane |

TABLE 2

| Name | Structure | Chemical Name |
|---|---|---|
| HFO-E-1234ze | CHF═CH—CF3 | 1,3,3,3,-tetrafluoropropene |
| HFC-338mf | CF3—CH2—CF2—CF3 | 1,1,1,2,2,4,4,4-octofluorobutane |
| HFC-356mff | CF3—CH2—CH2—CF3 | 1,1,1,4,4,4-hexafluorobutane |
| HFO-1234ze(Z) | CHF═CH—CF3 | 1,3,3,3,-tetrafluoropropene |
| HFO-1234zc | CF2═CH—CHF2 | 1,1,3,3-tetrafluoropropene |
| HFC-347 isomer | C4F7H33 | heptafluorobutane isomer |
| HCFC-133a | CH2Cl—CF3 | 1-Chloro-2,2,2-Trifluoroethane |
| HCFC-244bb | CF3—CClF—CH3 | 2-Chloro-1,1,1,2-tetrafluoropropane |
| HCFC-235fa | CClF2—CH2—CF3 | 1-Chloro-1,1,3,3,3-pentafluoropropane |
| HCFO-1326mxz(Z) | CF3—CCl═CH—CF3 | Z-2-chloro-1,1,1,4,4,4-hexafluoro-2-butene |
| HCFO-1224yd | CHCl═CF—CF3 | 1-Chloro-2,3,3,3-tetrafluoropropene |
| HCFO-1233zd(E) | CHCl═CH—CF3 | E-1-chloro-3,3,3-trifluoropropene |
| HCFO-1224zc | CF2═CH—CClF2 | 3-Chloro-1,1,3,3-tetrafluoropropene |
| HCC-160 | CH2Cl—CH3 | Chloroethane (ethyl chloride) |
| HCFC-244 | C3H3ClF4 | N/A |
| HCFO-1335 | C4H2ClF5 | N/A |
| HCFC-123 | CHCl2—CF3 | 1,1-Dichloro-2,2,2-trifluoroethane |
| HCFC-123a | CClF2—CHClF | 1,2-Dichloro-1,1,2-trifluoroethane |
| HCFO-1233zd(Z) | CHCl═CH—CF3 | Z-1-chloro-3,3,3-trifluoropropene |
| 1233zd (Br) | CF3CH═CHBr | 1-Bromo-3,3,3-trifluoropropene |
| CFO-1214ya | CCl2═CF—CF3 | 1,1-dichloro-2,3,3,3-tetrafluoropropene |
| HCC-30 | CH2Cl2 | Dichloromethane (Methylene chloride) |
| CFC-113 | CCl2F—CClF2 | 1,1,2-Trichloro-1,2,2-trifluoroethane |
| HCFO-1223xd | CHCl═CCl—CF3 | 1,2-dichloro-3,3,3-trifluoropropene |
| HCO-1130a | CCl2═CH2 | 1,1-dichloroethylene |
| HCO-1130 | CHCl═CHCl | 1,2-dichloroethylene |

In one embodiment, the total amount of the additional compounds is greater than 0 and less than about 5 weight percent, about 4 weight percent, about 3 weight percent, about 2 weight percent, about 1 weight percent, about 0.5 weight percent, about 0.1 weight percent.

In one embodiment, the compositions of the present invention comprise HFC-245fa and one additional compound, or two additional compounds, or three or more additional compounds selected from Table 1 and/or Table 2.

In one embodiment, the compositions of the present invention comprise at least about 95% by weight, at least 98% by weight, at least about 99% by weight, at least 99.5% by weight, at least 99.6% by weight, at least 99.7% by weight, at least 99.8% by weight, or about 99.9% by weight of HFC-245fa and one or more additional compounds selected from Table 1 and/or Table 2, and mixtures thereof.

In one embodiment, for any of the foregoing compositions, the total amount of additional compound(s) in the composition comprising HFC-245fa ranges from greater than 0 wt. % to less than or equal to about 5 wt. %, about 4 wt. %, about 3 wt. %, about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, and all values therebetween up to 1 wt. %. In another embodiment, the total amount of additional compound(s) ranges from 0.1 ppm (weight) to about 1 wt. %. In another embodiment, the total amount of additional compound(s) ranges from 0.001 wt. % to about 1 wt. %. In another embodiment, the total amount of additional compound(s) ranges from 0.001 wt. % to about 0.5 wt. %. In another embodiment, the total amount of additional compound(s) ranges from 0.001 wt. % to 0.4 wt. % or less, based on the total weight of the composition. In another embodiment, the total amount of additional compound(s) ranges from 0.001 wt. % to 0.1 wt. % or less, based on the total weight of the composition. In one embodiment, the total amount of additional compound(s) is about 0.1 wt. % based on the total weight of the composition.

In one embodiment, the compositions comprise at least about 99% by weight, in some cases at least about 99.5% by weight, of HFC-245fa and one or more additional compounds selected from Table 1 and/or Table 2, and mixtures thereof, wherein the total amount of the additional compound(s) is about 1% by weight or less, or about 0.5% by weight or less, or about 0.4% by weight or less, or about 0.3% by weight or less, or about 0.2% by weight or less, or about 0.1% by weight or less, based on the total weight of the composition.

In one embodiment, the reaction mixture preferably comprises the exemplary composition shown in Table 3.

TABLE 3

| Compound Name | ppm (wt.) |
|---|---|
| HFC-143a | 8 |
| HCFO-1225zc | 129 |
| HFC-236fa | 38 |
| HFO-E/Z-1234ze | 87 |
| HCFC-22 | 394 |
| CFC-12 | — |
| HCFC-142b | 31 |
| HCFC-133a | 14 |
| HCFO-1224 | 27 |
| HCFC-235fa | 3861 |
| HCFO-1233 | 43 |
| HCFC-235da | 9 |
| Unknown (HCFC) | 2634 |
| Acetone/HCFC-123 | — |
| HCFC-141b | 804 |
| HCFC-234fb | 15 |
| HCFC-1223xd | 110 |
| Unknown (HCFC) | 230 |
| HCC-20 | 6 |
| HCFC-224aa | — |
| CFC-1213xa | 4 |
| HCFC-233da | — |
| Toluene | 2 |
| HCFC-223aa | — |
| Others | 48 |
| HFC-245fa | 99.1506% |

In one embodiment, the reaction mixture preferably comprises the exemplary composition shown in Table 4.

TABLE 4

| Compound name | Percent (mol %) |
|---|---|
| HFO-E-1234ze | 8.96453E−05 |
| HFC-338mf | 5.15947E−05 |
| HFC-245fa | 99.79409 |
| HFC-356mff | 0.01362 |
| HFO-Z-1234ze + HFO-1234zc + HFC-347 isomer | 0.00158 |
| HCFC-133a | 0.00029 |
| HCFC-244bb | 0.00037 |
| HCFC-235fa | 0.00340 |
| HCFO-Z-1326mxz | 0.02643 |
| HCFO-1224yd | 0.01540 |
| HCFO-E-1233zd | 0.06520 |
| HCFO-1224zc | 0.02305 |
| HCC-160 | 0.00028 |
| HCFC-244 | 0.00449 |
| HCFO-1335 | 0.00014 |
| HCFC-123 | 0.00319 |
| HCFC-123a | 0.00083 |
| HCFO-Z-1233zd | 0.00023 |
| 1233zd (Br) | 3.53341E−05 |
| CFO-1214ya | 0.00012 |
| HCC-30 | 0.01262 |
| CFC-113 | 0.04428 |
| HCFO-1223xd | 6.29217E−05 |
| HCO-Z-1130 | 9.13973E−05 |

In one embodiment, the compositions comprise, consist of or consist essentially of (i) HFC-245fa, (ii) 3,3-dichloro-1,1,1-trifluoropropane (CF₃CH₂CHCl₂ or HFC-243fa), (iii) 3-chloro-1,1,1,3-tetrafluoropropane (CF₃CH₂CHFCl or HCFC-244fa), (iv) one or more additional compounds selected from 233da, (E)-2,4,5-trichloro-1,1,1,6,6,6-hexafluorohex-2-ene, (Z)-2,4,5-trichloro-1,1,1,6,6,6-hexafluorohex-2-ene, (E)-2-chloro-4-(dichloromethyl)-1,1,1,5,5,5-hexafluoropent-2-ene, (Z)-2-chloro-4-(dichloromethyl)-1,1,1,5,5,5-hexafluoropent-2-ene, (E)-4,5,5-trichloro-1,1,1,6,6,6-hexafluorohex-2-ene, (E)-4-chloro-2-(dichloromethyl)-1,1,1,5,5,5-hexafluoropent-2-ene, (Z)-4-chloro-2-(dichloromethyl)-1,1,1,5,5,5-hexafluoropent-2-ene, (2Z,4E)-2,5-dichloro-1,1,1,6,6,6-hexafluorohexa-2,4-diene, (E)-1,3-dichloro-5,5,5-trifluoro-2-(trifluoromethyl)pent-1-ene, (Z)-1,3-dichloro-5,5,5-trifluoro-2-(trifluoromethyl)pent-1-ene, (E)-4,5-dichloro-1,1,1,6,6,6-hexafluorohex-2-ene, and (E)-4,5,6-trichloro-1,1,1,6,6-pentafluorohex-2-ene, and (v) optionally one or more additional compounds selected from any of Table 1, Table 2, Table 3, Table 4, and combinations thereof, wherein the total amount of the additional compound(s) is about 1% by weight or less, or about 0.5% by weight or less, or about 0.4% by weight or less, or about 0.3% by weight or less, or about 0.2% by weight or less, or about 0.1% by weight or less, based on the total weight of the composition.

The HFC-245fa may be separated from any other compounds present in the reaction product by conventional techniques such as distillation. Azeotropic compositions of HFC-245fa and HF can be produced in this manner, as is known in the art, and thus in some embodiments, the azeotropic composition may be subjected to separation techniques, such as but not limited to scrubbing, azeotropic distillation, pressure swing distillation, or extractive distillation, in order to isolate the HFC-245fa from HF.

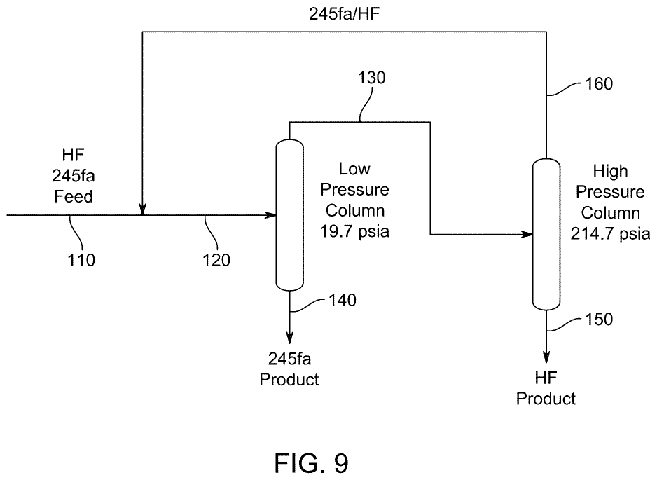

For example, FIG. 9 depicts an exemplary pressure swing distillation system and method for separating HFC-245fa from HF. The system comprises a low pressure distillation column and a high pressure distillation column. An azeotropic composition 110 is fed to the low pressure column, and a high purity product stream 140 comprising HFC-245fa is produced and withdrawn from a bottom of the low pressure column. A composition 130 comprising HF in major amounts and HFC-245fa in minor amounts is withdrawn from the other end of the low pressure column, and is fed to the high pressure column. Distillation of the composition 130 in the high pressure column produces a product stream 150 comprising HF and a recycle stream 160 comprised of a mixture of HFC-245fa and HF which is sent back to the initial feed stream 110 to form a combined feed stream 120. Molar flow rates and compositions of each stream are provided in Table A.

TABLE A

| | |
|---|---|
| Moles/Hr | Mole % |

| Stream | 245fa | HF | 245fa | HF |
|---|---|---|---|---|
| 110 | 1.000 | 0.596 | 62.7% | 37.3% |
| 120 | 1.661 | 1.437 | 53.6% | 46.4% |
| 130 | 0.661 | 1.437 | 31.5% | 68.5% |
| 140 | 1.000 | trace | 100.0% | trace |
| 150 | trace | 0.596 | trace | 100.0% |
| 160 | 0.661 | 0.841 | 44.0% | 56.0% |

In one embodiment, the HFC-245fa produced by the hydrofluorination of HCC-240fa in the absence of or substantially in the absence of a superacid is utilized as a feed material for subsequent reactions in the integrated process disclosed herein, namely for the production of HFO-1234ze(Z) and/or HFO-1234ze(E).

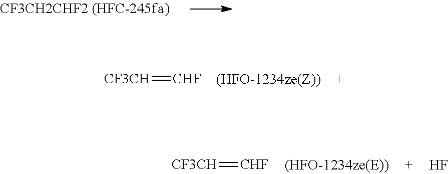

In one embodiment, the present invention is directed to a method comprising dehydrofluorination of HFC-245fa, in the presence or absence of an oxygen containing gas, to form a reaction mixture comprising HFO-1234ze(Z), HFO-1234ze(E) and HF.

In one embodiment, the method is the third reaction in the integrated process (i.e., integrated sequence of reactions) to produce HFO-1234ze(Z) and/or HFO-1234ze(E). Thus, in some embodiments, the source of the HFC-245fa feed is the product of the second reaction (i.e., liquid phase, non-superacid fluorination of HCC-240fa).

In one embodiment, the HFC-245fa feed composition has a moisture content of less than about 50 ppm, preferably less than about 20 ppm, more preferably less than about 10 ppm, and comprises HFC-245fa and one or more additional compounds selected from Table 1 and/or Table 2. In one embodiment, the non-absorbable gases (NAGs or NCGs) in the HFC-245fa feed composition may be greater than 0% and may include, for example but not limited to, air and a mixture of air and nitrogen.

Dehydrofluorination of the HFC-245fa may be carried out by any method known in the art. For example, in one embodiment, the integrated process of the present invention comprises a step of dehydrofluorination of the HFC-245fa using a strong base in aqueous or alcoholic solution or by means of a catalyst comprising at least one of chromium, aluminum and/or zinc, preferably a chromium-containing catalyst, in the presence of oxygen at elevated temperature, to form HFO-1234ze(Z), as disclosed in U.S. Patent No. Application Publication No. 2008/0051611, the disclosure of which is incorporated herein by reference in its entirety. In one embodiment, the dehydrofluorination reaction may take place in the vapor phase in the presence or absence of catalyst, or in the liquid phase by reaction with a caustic composition, such as NaOH or KOH. These reactions are described in more detail in U.S. Patent Publication Nos. 2008/0051611 and 2006/0106263, the entire disclosure of each of which is incorporated herein by reference.

In one embodiment, a method of the present invention comprises dehydrofluorination of HFC-245fa (e.g., the HFC-245fa produced by Step 2) to form a reaction mixture comprising HFO-1234ze(Z) and HFO-1234ze(E). In some embodiments, this method constitutes Step 3 of an integrated process of the present invention.

In one embodiment, the dehydrofluorination of the HFC-245fa of Step 3 is carried out in the presence of an oxygen containing gas, such as air. According to this process embodiment, the instant invention relates to feeding an amount of HFC-245fa to a dehydrofluorination reactor containing a catalyst in the presence of an oxygen containing gas, such as air, at a predetermined rate and a predetermined temperature. In one embodiment, the oxygen containing gas is present in an amount from greater than 0 ppm to less than 10 mol % of the total feed. In one embodiment, the reactor is preferably a fixed bed reactor.

In another embodiment, no additional oxygen containing gas is added to the reactor, and the oxygen content of the HFC-245fa feed composition is sufficient to facilitate the dehydrofluorination reaction.

For example, dehydrofluorination of the HFC-245fa may be carried out in accordance with U.S. Pat. No. RE48,889, the entire disclosure of which is incorporated herein by reference. More particularly, the HFC-245fa and HFO-1234ze(Z) are contacted in the gas phase with a catalyst comprising at least one catalyst selected from fluorinated Cr₂O₃ or fluorinated alumina, Cr/Ni on fluoride alumina, optionally additional elements such as Zn, K, Na, Mg could present in these catalyst as part of the catalyst composition in the presence or absence of an oxygen containing gas, to form a mixture comprising HFO-1234ze(Z) and HFO-1234ze(E) and optionally unreacted HFC-245fa, or to form HFO-1234ze(E) and optionally unreacted HFC-245fa. Where a mixture of HFO-1234ze(Z) and HFO-1234ze(E) are formed, the process optionally comprises separating the HFO-1234ze(E) from the HFO-1234ze(Z) and any unreacted HFC-245fa, if present, and returning the HFO-1234ze(Z) to be fed to the reactor with additional HFC-245fa.

According to the process of the present invention, both E-HFO-1234ze and Z-HFO-1234ze, among other compounds, are produced from the HFC-245a. The conversion is between about 10% to about 100%. The E/Z ratio is about 3:1 and can be adjusted in the range of 10 to 1 by varying reaction conditions, such as temperature, pressure and contact time.

Hydrogen fluoride may be removed by scrubbing, by passing the reactor effluent through a solution of aqueous caustic such as but not limited to a NaOH, KOH, Na₂CO₃, NaHCO₃, K₂CO₃, or KHCO₃ solution or by passing the reactor effluent through another type of scrubbing solution such as but not limited to water or concentrated sulfuric acid, by an adsorbent, by distillation, or by any combination of one or more of such methods.

In one embodiment, the dehydrofluorination reaction may be carried out at a temperature of between about 200° C. to about 400° C., or between about 250° C. to about 375° C., or about 250° C. to about 350° C., and in some cases at a temperature of about 370° C.

In one embodiment, the contact time is typically from about 10 to about 80 seconds, and more preferably from about 30 to about 60 seconds, and most preferably from about 45 to about 50 seconds.

The reaction pressure can be subatmospheric, atmospheric, or superatmospheric. In one embodiment, the reaction is conducted at a pressure of from 14 psig to about 100 psig. In another embodiment, the reaction is conducted at a pressure of from 14 psig to about 60 psig. In yet another embodiment, the reaction is conducted at a pressure of from 40 psig to about 85 psig. In yet another embodiment, the reaction is conducted at a pressure of from 50 psig to 75 psig. In general, increasing the pressure in the reactor above atmospheric pressure will act to increase the contact time of the reactants in the process. Longer contact times will necessarily increase the degree of conversion in a process, without having to increase temperature.

Depending on the temperature of the reactor and the contact time, the product mixture from the reactor will contain varying amounts of unreacted HFC-245fa and other constituents. More particularly, depending on the temperature of the reactor and the contact time, the reactor effluent of this process embodiment using HFC-245fa as the feed may include one or more of HFO-1141, HFC-143a, HFC-152a, trifluoropropyne, HFO-1234yf, E-HFO-1234ze, Z-HFO-1234ze, HFC-245fa, E-HCFO-1233zd and Z-HCFO-1233zd.

In one embodiment, the reactor feed is preheated in a vaporizer to a temperature of from about 30° C. to about 100° C. In another embodiment, the reactor feed is preheated in a vaporizer to a temperature of from about 30° C. to about 80° C.

The catalyst can be readily regenerated by any means known in the art if they become deactivated. For example, an oxygen containing gas may be supplied for regeneration of the catalyst.

The deyhydrofluorination reaction is free of isomerization or substantially free of isomerization from HFO-1234ze(Z) to HFO-1234ze(E). By “free of isomerization” it is meant that the process to make HFO-1234ze(E) is independent of HFO-1234ze(Z) to HFO-1234ze(E) isomerization, and that the HFO-1234ze(Z) content in the reactor feed, if present, is purposely selected based on the reaction equilibrium at a given pressure and temperature to render it as functionally inert and not a net contributor to the production of HFO-1234ze(E) by isomerization. By “substantially free of isomerization” it is meant that the process for making HFO-1234ze(E) does not employ a separate step for converting, isomerizing or otherwise using the Z isomer to obtain the E isomer, wherein the amount of Z converted to E is less than about 5 mol percent, less than about 2 mol percent and typically about 0 mol percent.

In one embodiment, the composition produced by the dehydrofluorination of HFC-245fa comprises HFO-1234ze(Z). In some embodiments, the composition comprises HFO-1234ze(Z) and one or more additional compounds selected from Group I.

In one embodiment, the composition produced by the dehydrofluorination of HFC-245fa, and more particularly by the integrated process disclosed herein, comprises HFO-1234ze(E) and HFO-1234ze(Z). In some embodiments, the composition comprises (i) HFO-1234ze(E); (ii) HFO-1234ze(Z); (iii) one or more additional compounds selected from Group I; and (iv) one or more additional compounds selected from Group II.

Group I and Group II additional compounds are defined hereinafter.

In one embodiment, the composition produced by the dehydrofluorination of HFC-245fa, and more particularly by the integrated process disclosed herein, comprises HFO-1234ze(E), HFO-1234ze(Z) and HFC-245fa. In some embodiments, the composition comprises (i) HFO-1234ze(E); (ii) HFO-1234ze(Z); (iii) HFC-245fa; (iv) one or more additional compounds selected from Group I; (v) one or more additional compounds selected from Group II; and (vi) one or more additional compounds selected from Tables 1 and/or 2.

In one embodiment, the total amount of additional compound(s) in the HFO-1234ze(Z) composition or HFO-1234ze(E)/HFO-1234ze(Z) composition ranges from greater than 0 wt. % to less than or equal to about 5 wt. %, about 4 wt. %, about 3 wt. %, about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, or from 0.1 ppm (weight) to about 1 wt. %, or from 0.001 wt. % to about 1 wt. %, or from 0.001 wt. % to about 0.5 wt. %, or from 0.001 wt. % to 0.4 wt. % or less, or from 0.001 wt. % to 0.1 wt. % or less, or about 0.1 wt. %, based on the total weight of the composition, and all values and integers between all such ranges.

In one embodiment, the HFO-1234ze(Z) composition or HFO-1234ze(E)/HFO-1234ze(Z) composition comprises at least about 95% by weight, at least about 96% by weight, at least about 97% by weight, at least about 98% by weight, at least about 99% by weight, at least 99.5% by weight, at least 99.6% by weight, at least 99.7% by weight, at least 99.8% by weight, or about 99.9% by weight of HFO-1234ze(E), HFO-1234ze(Z) and the one or more additional compounds.

In one embodiment, the integrated process of the present invention further comprises separating HFO-1234ze(E) and HFO-1234ze(Z) from the reaction mixture produced by Step 3, such that the composition produced by the process comprises HFO-1234ze(E) and HFO-1234ze(Z). The process may also comprise optionally purifying the HFO-1234ze(E) and HFO-1234ze(Z), such as by distillation, fractionation, azeotropic distillation, extractive distillation, adsorption, absorption, or another conventional purification method known in the art, or a combination of any such purification methods.

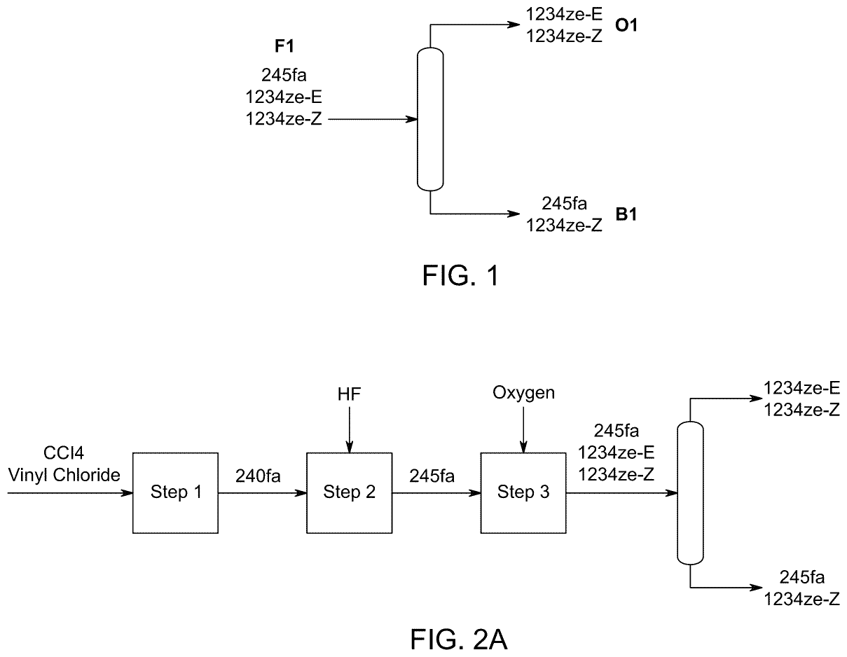

For example, as shown in FIGS. 1-2A, in some embodiments, the integrated process comprises distilling the reaction mixture F1 of Step 3 via a first distillation column, producing a bottoms stream B1 comprising HFC-245fa and HFO-1234ze(Z), and recovering an overhead stream O1 comprising a mixture of HFO-1234ze(E) and HFO-1234ze(Z).

In some embodiments, the composition produced by the integrated process, which includes distillation of the reaction product, comprises HFO-1234ze(E), HFO-1234ze(Z), one or more additional compounds selected from Group I, and one or more additional compounds selected from Group II.

In some embodiments, the mixture of HFO-1234ze(E) and HFO-1234ze(Z) may then be further purified to separate HFO-1234ze(E) from HFO-1234ze(Z).

In some embodiments, the processes of the present invention further comprise separating HFO-1234ze(E), HFO-1234ze(Z) and HFC-245fa from the reaction mixture produced by Step 3, such that the composition produced by the process comprises HFO-1234ze(E), HFO-1234ze(Z) and HFC-245fa. The process may also comprise optionally purifying the HFO-1234ze(E), HFO-1234ze(Z) and HFC-245fa, such as by distillation, fractionation, azeotropic distillation, extractive distillation, adsorption, absorption, or another conventional purification method known in the art, or a combination of any such purification methods.

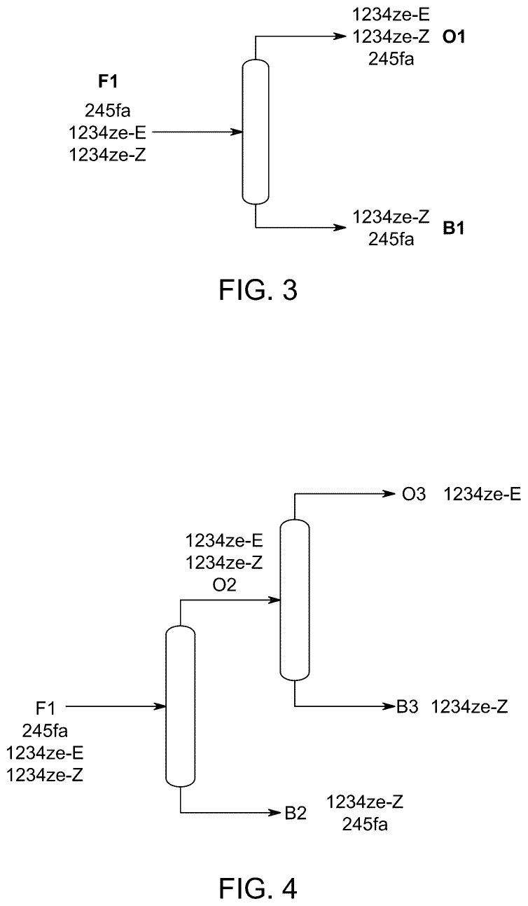

For example, as shown in FIG. 3, in some embodiments, the integrated process comprises distilling the reaction mixture F1 of Step 3A, which comprises HFC-245fa, HFO-1234ze(Z) and HFO-1234ze(E), via a first distillation column, producing a bottoms stream B1 comprising HFC-245fa and HFO-1234ze(Z), and recovering an overhead stream O1 comprising a mixture of HFO-1234ze(E), HFO-1234ze(Z) and HFC-245fa.

In some embodiments, the composition produced by the integrated process, which includes distillation of the reaction product, comprises HFO-1234ze(E); HFO-1234ze(Z); HFC-245fa; one or more additional compounds selected from Group I; one or more additional compounds selected from Group II; and one or more additional compounds selected from Tables 1 and/or 2.

The concentrations of the components of the overhead stream O1 and bottoms stream B1 may be adjusted as desired by varying the operating conditions of the distillation column. Exemplary feed compositions, overhead streams and bottom streams are shown in Table 5.

TABLE 5

Concentration by weight

| | | | |
|---|---|---|---|
| Stream | 245fa | 1234ze-E | 1234ze-Z |

Mixture of 1234ze-E + 1234ze-Z with 10 ppm 245fa

| | | | |
|---|---|---|---|
| F1 | 60.0% | 30.0% | 10.0% |
| O1 | 10 ppm | 99.0% | 1.0% |
| B1 | 86.1% | 0.0% | 12.9% |

Mixture of 1234ze-E + 1234ze-Z with 0.5 weight % 245fa

| | | | |
|---|---|---|---|
| F1 | 60.0% | 30.0% | 10.0% |
| O1 | 0.5% | 74.7% | 24.8% |
| B1 | 100.0% | 0.0% | 0.0% |

Mixture of 1234ze-E + 1234ze-Z with 10 weight % 245fa

| | | | |
|---|---|---|---|
| F1 | 60.0% | 30.0% | 10.0% |
| O1 | 10.0% | 67.5% | 22.5% |
| B1 | 100.0% | 0.0% | 0.0% |

Mixture of 1234ze-E + 1234ze-Z with 10 ppm 245fa

| | | | |
|---|---|---|---|
| F1 | 7.2% | 73.0% | 19.8% |
| O1 | 10 ppm | 84.1% | 15.9% |
| B1 | 54.4% | 0.0% | 45.6% |

Mixture of 1234ze-E + 1234ze-Z with 0.5 weight % 245fa

| | | | |
|---|---|---|---|
| F1 | 7.2% | 73.0% | 19.8% |
| O1 | 0.5% | 78.3% | 21.2% |
| B1 | 100.0% | 0.0% | 0.0% |

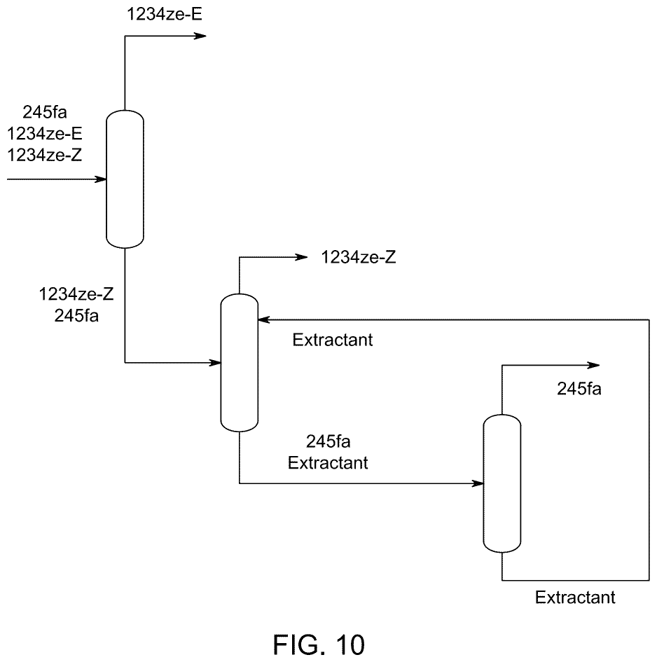

In another embodiment, as shown in FIG. 10, extractive distillation may be used to separate each of HFO-1234ze(E), HFO-1234ze(Z) and HFC-245fa from the reaction mixture F1 of Step 3A. The extractive distillation comprises (i) distilling the reaction mixture F1, which comprises HFO-1234ze(E), HFO-1234ze(Z) and HFC-245fa, via a first distillation column to producing a bottoms stream comprising HFC-245fa and HFO-1234ze(Z) and an overhead stream comprising HFO-1234ze(E), (ii) contacting the HFO-1234ze(Z)/HFC-245fa bottoms stream with at least one extractive agent, to form a bottoms stream comprising HFC-245fa and the extractive agent and an overhead stream comprising HFO-1234ze(Z), (iii) distilling HFC-245fa/extractive agent stream to separate the HFC-245fa from the extractive agent, and (iv) recycling the extractive agent.

Hydrocarbon extractive agents of the present invention comprise compounds having only carbon and hydrogen, with about 4 to about 10 carbon atoms. Hydrocarbon extractive agents may be linear, branched, or cyclic and may be saturated or unsaturated compounds. Representative hydrocarbon extractive agents include but are not limited to n-pentane, 2-methylbutane, cyclopentane, 1-pentene, 2-pentene, n-hexane, 2-methylpentane, 3-methylpentane, 2,2-dimethylbutane, 2,3-dimethylbutane, 2,2-dimethylhexane, 2,4-dimethylhexane, 2,5-dimethylhexane, 3,4-dimethylhexane, and cyclohexane. Cyclic hydrocarbon ethers used as extractive agents with the present invention have from 2 to 6 carbon atoms. Cyclic hydrocarbon ethers in this invention denote cyclic ethers consisting of C, H and O, wherein the number of carbon atoms is from 2 to 6. Examples of these compounds include furan, tetrahydrofuran (THF), ethylene oxide, propylene oxide (1,2-epoxypropane), oxetane and tetrahydropyran. Non-cyclic hydrocarbon ethers used as extractive agents with the present invention have the formula CxH2x+1OCyH2y+1 wherein x and y are 1 or greater and x+y is from 3 to 6. Examples of these compounds include diethyl ether, diisopropyl ether and methyl tert-butyl ether. Alcohols used as extractive agents with the present invention have the formula C_{z}H_{2z}+1OH wherein z is from 1 to 4. Examples of these compounds include methanol, ethanol, n-propanol, and iso-propanol. Ketones used as extractive agents with the present invention have the formula CₘH₂ₘ+1C(O)CnH₂ₙ₊₁ wherein m and n are 1 or greater and m+n is at most 5. Examples of these compounds include acetone and butanone. Ester extractive agents comprise compounds formed by reaction of an acid and an alcohol. Carboxylate esters are those formed by reaction of a carboxylic acid. Ester extractive agents include carboxylate esters such as methyl formate, ethyl formate, propyl formate, isopropyl formate, methyl acetate, ethyl acetate, propyl acetate, isopropyl acetate, methyl propionate, ethyl propionate, propyl propionate, methyl butyrate, and ethyl butyrate. Ester extractive agents also include esters formed from inorganic acids, including dimethyl carbonate, dimethyl sulfate and the like. Chlorocarbons used as extractive agents with the present invention have the formula CₓH_{2x+2-y}Cl_{y}, wherein x is 1 or 2 and y is from 2 to 4.

In some embodiments, the integrated process of the present invention further comprises separating HFO-1234ze(E), HFO-1234ze(Z), HCFO-1233zd(E) and HFC-245fa from the reaction mixture produced by Step 3, such that the composition produced by the process comprises HFO-1234ze(E), HFO-1234ze(Z), HCFO-1233zd(E) and HFC-245fa. The process may also comprise optionally purifying the HFO-1234ze(E), HFO-1234ze(Z), HCFO-1233zd(E) and HFC-245fa, such as by distillation, fractionation, azeotropic distillation, extractive distillation, adsorption, absorption, or another conventional purification method known in the art, or a combination of any such purification methods. The amount of HCFO-1233zd(E) present in the composition produced by the process is preferably less than about 1 wt. % based on the total weight of the composition.

In some embodiments, the integrated process of the present invention further comprises separating HFO-1234ze(Z) and HFC-245fa from the reaction mixture produced by Step 3, such that the composition produced by the process comprises HFO-1234ze(E), HFO-1234ze(Z) and HFC-245fa, which is particularly suitable for use as a blowing agent. The process may also comprise optionally purifying the HFO-1234ze(Z) and HFC-245fa, such as by distillation, fractionation, azeotropic distillation, extractive distillation, adsorption, absorption, or another conventional purification method known in the art, or a combination of any such purification methods. The amount of HFC-245fa present in the composition produced by the process is less than about 30 wt. %, preferably less than about 10 wt. %, more preferably less than about 5 wt. %, based on the total weight of the composition.

In some embodiments, as shown in FIG. 2B, the reaction mixture of Step 3 comprises HFC-245fa, HFO-1234ze(E), HFO-1234ze(Z) and HCFO-1233zd(E), and Integrated Process A comprises distilling the reaction mixture via a first distillation column producing a bottoms stream comprising HFC-245fa, HCFO-1233zd(E) and HFO-1234ze(Z), and an overhead stream comprising a mixture of HFO-1234ze(E) and HFO-1234ze(Z). The mixture of HFO-1234ze(E) and HFO-1234ze(Z) may then be further purified to separate HFO-1234ze(E) from HFO-1234ze(Z).

In some embodiments, the integrated process of the present invention further comprises further distillation or purification of the bottoms stream (HFC-245fa, HCFO-1233zd(E) and HFO-1234ze(Z)) to produce a mixture of HFO-1234ze(Z) and HFC-245fa (second overhead stream), which may optionally be recycled to the deyhydrofluorination reaction, and a mixture of HFO-1234zd(E) and HFC-245fa (second bottoms stream). The HFO-1234zd(E)/HFC-245fa mixture may either be purged (not shown) or, as shown in FIG. 2B, may be optionally recycled to the HCC-240fa fluorination reaction (Step 2). For further utilization, in some embodiments, the HCFO-1233zd can be converted to HFC-245fa instead of being purged as waste. Similarly, the HFC-245fa may be recycled to the HCC-240fa fluorination reactor and undergo purification to be used as feed, instead of being purged as waste.

The feed composition for the dehydrofluorination reaction of Step 3 comprises HFC-245fa and one or more additional compounds selected from Tables 1 and/or 2.

HCFO-1233zd(E) thus may be present in the feed as an additional compound of the HFC-245fa composition, or it can be generated during the HFC-245fa dehydrofluorination reaction through various chemical transformations of one or more of the chlorinated compounds of the HFC-245fa feed composition.

In one embodiment, the integrated process of the present invention further comprises separating HFO-1234ze(Z) from the reaction mixture produced by Step 3. The process may also comprise optionally purifying the HFO-1234ze(Z), such as by distillation, fractionation, azeotropic distillation, extractive distillation, adsorption, absorption, or another conventional purification method known in the art, or a combination of any such purification methods.

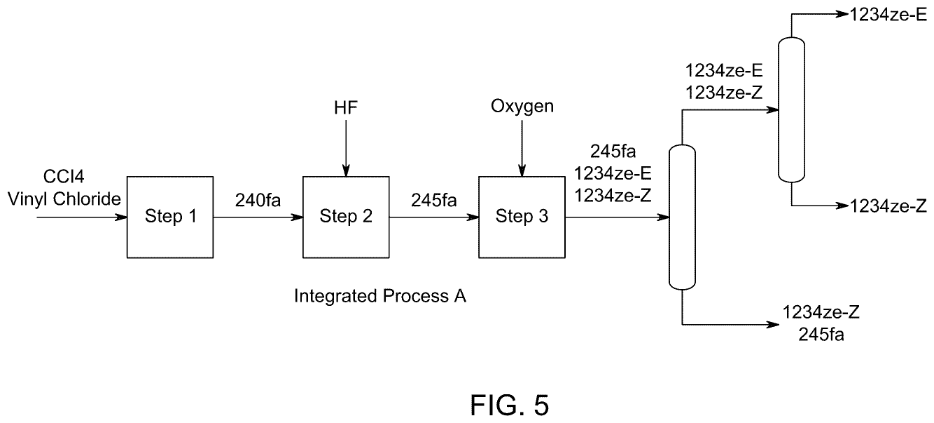

For example, as shown in FIGS. 4-5, in some embodiments, the integrated process comprises distilling the reaction mixture F1 of Step 3 via a first distillation column, producing a bottoms stream B2 comprising a first mixture of HFC-245fa and HFO-1234ze(Z), recovering an overhead stream O2 comprising a second mixture of HFO-1234ze(E) and HFO-1234ze(Z) and optionally HFC-245fa, distilling the second mixture 02 in a second distillation column to produce a bottoms stream B3 comprising HFO-1234ze(Z) and an overhead stream O3 comprising HFO-1234ze(E).

In some embodiments, the composition produced by the integrated process, which includes distillation of the reaction product, comprises HFO-1234ze(Z) and one or more additional compounds selected from Group I.

The concentrations of the components of the overhead streams O2, O3 and bottoms streams B2, B3 may be adjusted as desired by varying the operating conditions of the distillation columns. Exemplary feed compositions, overhead streams and bottom streams are shown in Table 6.

TABLE 6
Concentration by weight

| Stream | 245fa | 1234ze-E | 1234ze-Z |
|---|---|---|---|
| F1 | 60.0% | 30.0% | 10.0% |
| O2 | 10 ppm | 99.0% | 1.0% |
| B2 | 86.1% | 0.0% | 12.9% |
| O3 | 0.0% | 100.0% | 0.0% |
| B3 | 0.1% | 0.0% | 99.9% |
| F1 | 7.2% | 73.0% | 19.8% |
| O2 | 0.0% | 84.1% | 15.9% |
| B2 | 54.4% | 0.0% | 45.6% |
| O3 | 0% | 100% | 0% |
| B3 | 0% | 0% | 100% |

In some embodiments all or a portion of the bottoms stream (i.e., HFC-245a and Z-HFO-1234ze) may be recycled back to the feed of the reactor. In other embodiments, all or a portion of the bottoms stream (i.e., HFC-245a and Z-HFO-1234ze) may be utilized for another end use or application, such as components to make up a blended or reclaimed composition.

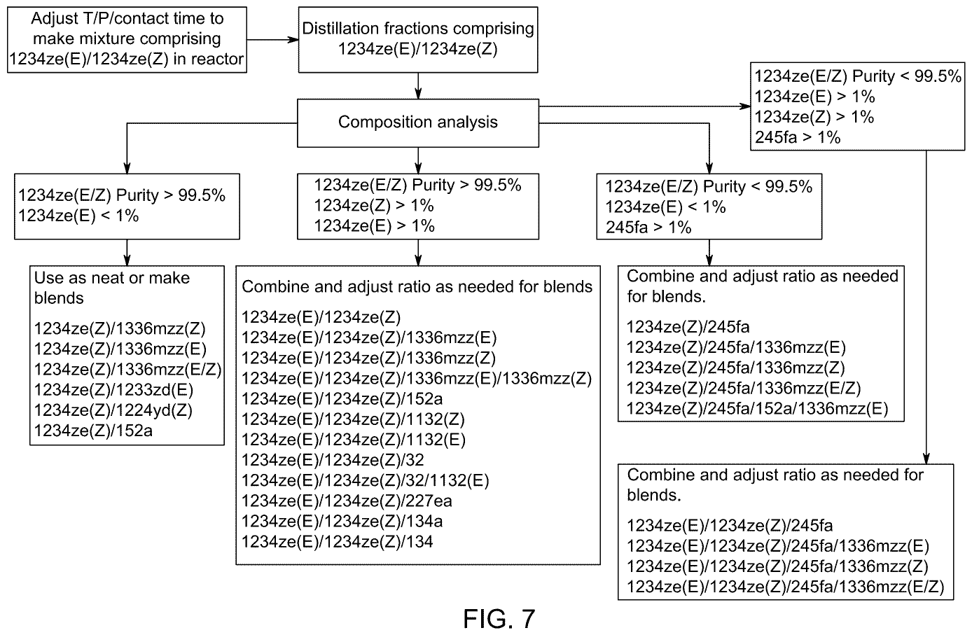

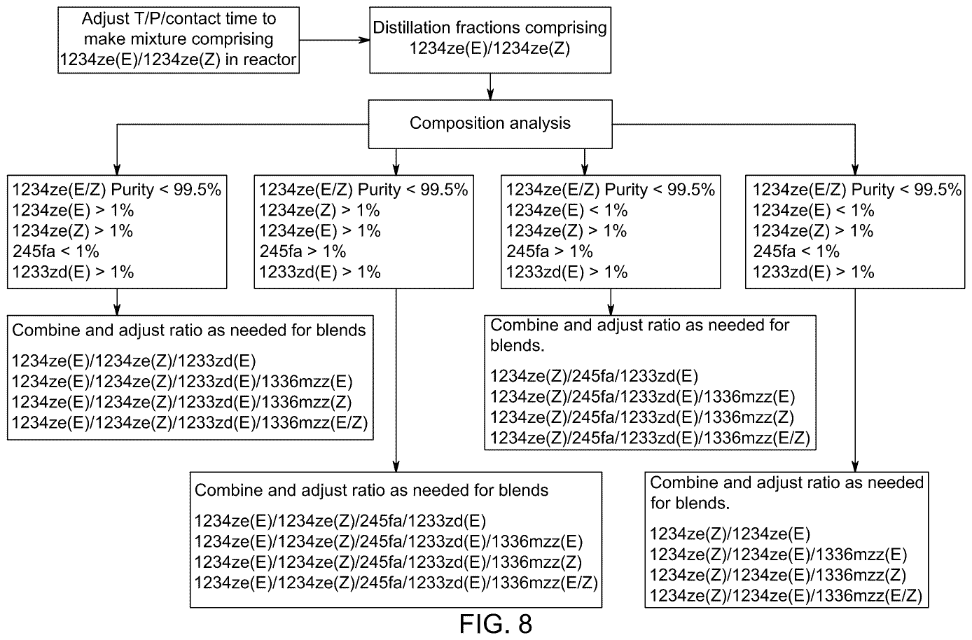

Referring to FIGS. 7-8, in one embodiment, parameters such as contact time, temperature and pressure of one or more of the reactions of the integrated process and subsequent distillation, separation and/or purification processes may be adjusted in order to achieve a desired ratio of components in the distillation fraction (e.g., E-HFO-1234ze:Z-HFO-1234ze or E-HFO-1234ze:Z-HFO-1234ze:HFC-245fa or E-HFO-1234ze:Z-HFO-1234ze:E-HCFO-1233zd:HFC-245fa). Accordingly, the processes of the present invention simplify manufacturing and reduce costs, since the desired mixture is directly prepared by the manufacturing process and the components are very pure.

Further, referring to FIGS. 7-8, in some embodiments, the integrated process further comprises a step of adjusting the composition of the final product (distillation fraction) to achieve a desired blend, if needed after analysis of the composition. For example, as part of each integrated process, an additional amount of E-HFO-1234ze, Z-HFO-1234ze, E-HCFO-1233zd and/or HFC-245fa may be added to adjust the ratios of the compounds to achieve a desired blend composition, and/or one or more other compounds such as but not limited to one or more HFOs (e.g., one or more of, for example but not limited to, HFO-1336mzz(E), HFO-1336mzz(Z), HFO-1224yd(Z), HFO-1132(Z) and HFO-1132(E)), HFCs (e.g., one or more of, for example but not limited to, HFC-32, HFC-134a, HFC-134, HFC-227ea and HFC-152a), hydrofluoroethers (HFE), hydrocarbons, ethers, aldehydes, ketones, and the like may be added to the final product to obtain a desired blend composition.

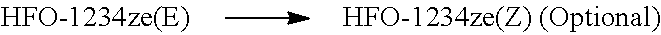

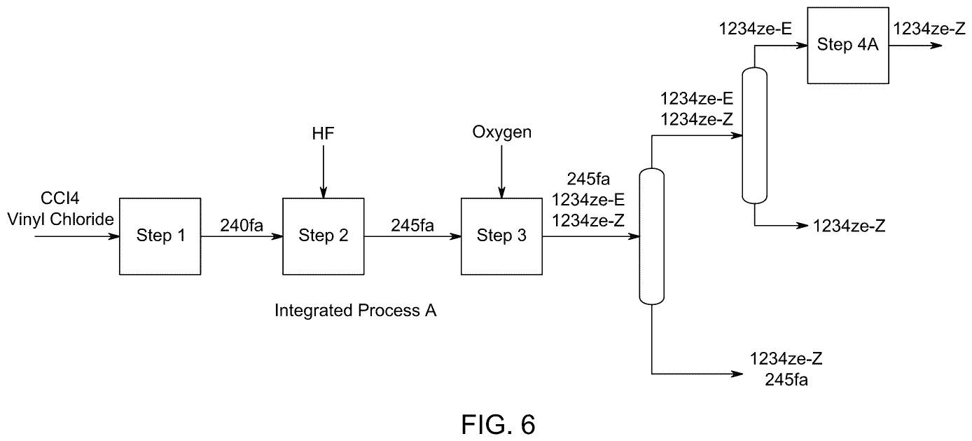

Optionally, in one embodiment, as shown in FIG. 6, the process further also comprises isomerizing the E-HFO-1234ze of the overhead stream O3 to Z-HFO-1234ze (Optional Step 4). The E-HFO-1234ze may be optionally purified before and/or after the isomerization reaction.

More particularly, in some embodiments, where the primary desired product is Z-HFO-1234ze, the E-HFO-1234ze may also be separated and recovered from the reaction mixture by known methods and further treated for isomerization to Z-HFO-1234ze. The isomerization step or method comprises reacting the E-HFO-1234ze, preferably in the vapor phase, with at least one fluorinated catalyst, optionally in the presence of an oxygen containing gas. The E-HFO-1234ze may optionally be purified before isomerization.

In one embodiment, the contacting for the isomerization reaction occurs at a reaction temperature from about 50° C. to about 450° C., preferably from about 50° C. to about 400° C., and more preferably 50° C. to about 375° C., to isomerize at least a portion the E-HFO-1234ze into Z-HFO-1234ze. The contact time is typically from about 2 to about 90 seconds, or from about 10 to about 70 seconds.

In some embodiments, a catalyst suitable for use in the isomerization reaction scheme includes a vapor phase chromium oxide (Cr₂O₃) or aluminum oxide (Al₂O₃) catalyst. In one embodiment, the isomerization catalyst includes chromium oxide supported on aluminum oxide. In one embodiment, the isomerization catalyst includes zinc doped chromium oxide. Suitable isomerization catalysts include, but are not limited to, chromium oxide, fluorinated chromium oxide, oxyfluorides of chrome, chromium halide, alumina, aluminum fluoride, fluorided alumina, metal compounds on aluminum fluoride, metal compounds on fluorided alumina; oxides, fluorides, and oxyfluorides of magnesium, zinc and mixtures of magnesium and zinc and/or aluminum; lanthanum oxide and fluorided lanthanum oxide; carbon, acid-washed carbon, activated carbon, three dimensional matrix carbonaceous materials; and metal compounds supported on carbon. The metal compounds are oxides, fluorides, and oxyfluorides of at least one metal selected from the group consisting of sodium, potassium, rubidium, cesium, yttrium, lanthanum, cerium, praseodymium, neodymium, samarium, chromium, iron, cobalt, rhodium, nickel, copper, zinc, and mixtures thereof. In one embodiment, the catalyst comprises fluorinated alumina optionally doped with one or more of Zn, Mg and Co. The catalyst is contacted for a time sufficient to affect the desired isomerization.

The reaction pressure used in the isomerization reaction can be subatmospheric, atmospheric, or super-atmospheric. In one embodiment, the reaction pressure for the isomerization reaction is about 10 to about 150 psig.

In some embodiments, the overall conversion of E-HFO-1234ze into Z-HFO-1234ze may be about 2% to about 70%.

In one embodiment, the Z-HFO-1234ze produced from the integrated process disclosed herein is of a high purity and is free of or substantially free of chlorinated compounds, making it suitable for etching gas applications. By “high purity” is meant a purity greater than 99.5 wt. %, or greater than 99.6 wt. %, or greater than 99.7 wt. %, or greater than 99.8 wt. %, preferably 99.9 wt. % or greater. By “substantially free of” with respect to chlorinated compounds is meant that the amount of chlorinated compounds present in the composition is less than about 100 ppm, preferably less than about 50 ppm, more preferably less than about 10 ppm, and most preferably less than about 1 ppm.

In one embodiment, the Z-HFO-1234ze produced from the integrated process disclosed herein has a purity of greater than about 99.9% and is free of or substantially free of chlorinated compounds.

In one embodiment, the highly pure composition comprises Z-HFO-1234ze and one or more additional compounds selected from Group I. In one embodiment, the highly pure Z-HFO-1234ze is free of or substantially free of E-HFO-1234ze, with “substantially free of” meaning that the total amount of E-HFO-1234ze present in the composition is less than about 10 ppm, preferably less than about 1 ppm.

In one embodiment, the Z-HFO-1234ze having high purity and being free of or substantially free of chlorinated compounds is particularly suited for etching gas applications.

In one embodiment, the Z-HFO-1234ze having high purity and being free of or substantially free of chlorinated compounds is suitable for use in a pharmaceutical grade application. For example, the Z-HFO-1234ze may be used as a propellant in a sprayable composition of a medical product such as a metered dose inhaler. For pharmaceutical grade applications, the Z-HFO-1234ze preferably has a purity of at least 99.9%.

In some embodiments, any of the process embodiments disclosed herein may further comprise passing the reaction mixture through a drying media or desiccant, such as activated alumina, silica gel, molecular sieve, zeolite, and the like for moisture removal. In some embodiments, optionally, the reaction mixture of any of the process embodiments disclosed herein may further be contacted with an absorbent, such as an aluminium-containing absorbent, activated carbon, or a mixture thereof, for removing trace amounts of HF. In some embodiments, the absorbent material may generate CaF₂ upon reaction with the HF removed from the reaction mixture.

In some embodiments, for any of the processes described herein, an inert diluent gas is used as a carrier gas for one or more of the reactants. In one embodiment, the carrier gas is selected from nitrogen, argon, helium, or carbon dioxide.

The reactor or vessel, distillation columns, feed lines, effluent lines and any other associated units utilized in carrying out any of the process embodiments disclosed herein should be constructed from materials which are resistant to the corrosive effects of hydrogen fluoride, such as nickel and its alloys, including Hastelloy, Monel, and Inconel, or vessels lined with fluoropolymers. These may be a single tube, or multiple tubes packed with an appropriate catalyst depending on the reaction to be carried out.

For any of the process embodiments disclosed herein, the desired Z-HFO-1234ze or Z-HFO-1234ze/E-HFO-1234ze mixture may be purified by a conventional method for purifying reaction products and separated from the reaction mixture by methods known in the art (e.g., distillation).

Any unreacted feed materials may be recycled back to the reactor with additional material for further production of the reaction mixture. Further, any excessive amount of hydrogen fluoride present may be removed by scrubbing, distillation, and the like.

For the integrated process disclosed herein, the heat of reaction generated in any step of the process can be recovered and utilized. The heat of reaction for each step of each integrated process disclosed herein is provided in Table A below, the heats of reaction having been calculated with GaussView 5.0.

TABLE A

| Process | | Delta Ho |
|---|---|---|
| Step | Reaction | (Kcal/mole) |
| 1 | CCl4 + VCM → 240fa | −31.9 |
| 2 | 240fa + 5HF → 245fa + 5HCl | −29.1 |
| 3 | 245fa → 1234ze(E) + HF | 22.4 |
| 4 | 1234ze(E) → 1234ze(Z) | −2.2 |

In some embodiments, the heat of reaction generated in any step of the integrated process can be utilized in the same process where energy such as heating is required and/or applied to other operations where heat is needed. For example, in some embodiments, the heat of the reaction generated by the exothermic reactions of Step 1 and/or 2 can be utilized as heat for the endothermic reaction of Step 3. As further examples, in some embodiments, the heat of reaction generated in any step of each integrated process disclosed herein can be used as heat for reactions or steps of the integrated process, such as distillation, separation, and/or material vaporization (e.g., vaporization of a starting or intermediate material such as HCC-240fa). Alternatively or additionally, in some embodiments, the heat of reaction generated in any step of each integrated process disclosed herein can be applied to other (different) processes or chemical reactions being carried out at the same site or at an adjacent site, such as a thermoconvertor for waste treatment or other chemical production, or facility heating such as for heating of a building. It will be understood by those skilled in the art that utilization of the heat of reaction can be carried out with proper engineering design processes and protocols in place.

Additionally, one or more of the components used to form the compositions of the present invention may be prepared from recycled or reclaimed refrigerant. More particularly, one or more of the components used to form the HFO-1234ze(Z) compositions disclosed herein may be recycled or reclaimed by means of removing contaminants, such as air, water, or residue, which may include lubricant or particulate residue from system components. The means of removing the contaminants may vary widely, but can include distillation, decantation, filtration, and/or drying by use of molecular sieves or other absorbents. Then the recycled or reclaimed component(s) may be utilized as a starting material for any of the reactions described above, in conjunction with a virgin, recycled or reclaimed feed material.

For example, one or more of carbon tetrachloride, vinyl chloride, HCC-240fa or HFC-245fa, which is a feed material for at least one of the above-described reaction, may be prepared for recovered and recycled or reclaimed material. The source of the recovered and recycled or reclaimed material is not limited. For example, any of the feed materials, and particularly HFC-245fa, could comprise reclaimed material from a reclaimer. Alternatively, any of the feed materials, such as carbon tetrachloride, vinyl chloride and/or HCC-240fa, may comprise material which was recovered from a waste stream processed, onsite or offsite, to be of suitable purity for use in any of the above reactions. Such recovered and recycled/reclaimed materials may be used as feed materials for any of the above reactions optionally together with additional virgin materials or materials recycled from the process itself.

### Compositions

In one embodiment, the present disclosure provides a composition comprising HFC-245fa and one or more additional compounds selected from Tables 1 and/or 2.

In one embodiment, the HFC-245fa composition is produced by fluorination of HCC-240fa in the presence of a fluorination catalyst and in the absence of or substantially in the absence of a superacid. In one embodiment, the fluorination reaction is as disclosed herein.

In one embodiment, compositions of the present invention comprise at least about 98% by weight, at least about 99% by weight, at least 99.5% by weight, at least 99.6% by weight, at least 99.7% by weight, at least 99.8% by weight, or about 99.9% by weight of HFC-245fa and the one or more of the additional compounds.

In one embodiment, the compositions comprise at least about 99% by weight, in some cases at least about 99.5% by weight, of HFC-245fa and the one or more additional compounds, wherein the total amount of the additional compound(s) is about 1% by weight or less, or about 0.5% by weight or less, or about 0.4% by weight or less, or about 0.3% by weight or less, or about 0.2% by weight or less, or about 0.1% by weight or less, based on the total weight of the composition.

In one embodiment, the present disclosure provides a composition comprising HFO-1234ze(Z) and one or more additional compounds selected from Group I.

In one embodiment, the HFO-1234ze(Z) composition is produced by dehydrofluorination of the HFC-245fa which has been produced by fluorination of HCC-240fa in the presence of a catalyst and in the absence of or substantially in the absence of a superacid. In one embodiment, the dehydrofluorination and fluorination reactions are as disclosed herein. In one embodiment, the HFO-1234ze(Z) composition is produced by the integrated process of the present invention.

In one embodiment, compositions of the present invention comprise at least about 98% by weight, at least about 99% by weight, at least 99.5% by weight, at least 99.6% by weight, at least 99.7% by weight, at least 99.8% by weight, or about 99.9% by weight of HFO-1234ze(Z) and the one or more additional compounds.

In one embodiment, the compositions comprise at least about 99% by weight, in some cases at least about 99.5% by weight, of HFO-1234ze(Z) and the one or more additional compounds, wherein the total amount of the additional compound(s) is about 1% by weight or less, or about 0.5% by weight or less, or about 0.4% by weight or less, or about 0.3% by weight or less, or about 0.2% by weight or less, or about 0.1% by weight or less, based on the total weight of the composition.

In some embodiments, for any of the compositions disclosed herein, the HFO-1234ze(Z) component of the composition may be a distilled component, a component which has been separated from a product mixture, or a combination of both.

In one embodiment, the present disclosure provides a composition comprising HFO-1234ze(E), HFO-1234ze(Z), one or more additional compounds selected from Group I and one or more additional compounds selected from Group II.

In one embodiment, the HFO-1234ze(Z)/HFO-1234ze(E) composition is produced by dehydrofluorination of the HFC-245fa which has been produced by fluorination of HCC-240fa in the presence of a catalyst and under conditions free of or substantially free of a superacid. In one embodiment, the dehydrofluorination and fluorination reactions are as disclosed herein. In one embodiment, the HFO-1234ze(Z)/HFO-1234ze(E) composition is produced by the integrated process of the present invention.

In one embodiment, compositions of the present invention comprise at least about 98% by weight, at least about 99% by weight, at least 99.5% by weight, at least 99.6% by weight, at least 99.7% by weight, at least 99.8% by weight, or about 99.9% by weight of HFO-1234ze(Z), HFO-1234ze(E) and the one or more additional compounds.

In one embodiment, the compositions comprise at least about 99% by weight, in some cases at least about 99.5% by weight, of HFO-1234ze(Z), HFO-1234ze(E) and the one or more additional compounds, wherein the total amount of the additional compound(s) is about 1% by weight or less, or about 0.5% by weight or less, or about 0.4% by weight or less, or about 0.3% by weight or less, or about 0.2% by weight or less, or about 0.1% by weight or less, based on the total weight of the composition.

In one embodiment, for any of the compositions disclosed herein, the total amount of additional compound(s) ranges from greater than 0 wt. % to less than or equal to about 5 wt. %, about 4 wt. %, about 3 wt. %, about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, or from 0.1 ppm (weight) to about 1 wt. %, or from 0.001 wt. % to about 1 wt. %, or from 0.001 wt. % to about 0.5 wt. %, or from 0.001 wt. % to 0.4 wt. % or less, or from 0.001 wt. % to 0.1 wt. % or less, or about 0.1 wt. %, based on the total weight of the composition, and all values and integers between all such ranges.

In some embodiments, certain precursor compounds to HFO-1234ze(Z) or HFO-1234ze(E) contain compounds that then appear as additional compounds in the HFO-1234ze(Z) or HFO-1234(Z)/HFO-1234ze(E) compositions. In other embodiments, these precursor compounds may themselves react during the HFO-1234ze(Z) or HFO-1234ze(E) formation to produce additional compounds that then appear in the HFO-1234ze(Z) or HFO-1234ze(Z)/HFO-1234ze(E) compositions. In other embodiments, the reaction conditions under which the HFO-1234ze(Z) and/or HFO-1234ze(E) is produced also produce by-products, by which is meant adventitious reaction pathways may occur simultaneously to produce compounds other than HFO-1234ze(Z) and/or HFO-1234ze(E) and the quantity and identity of these additional compounds will depend upon the particular conditions under which the HFO-1234ze(Z) and/or HFO-1234ze(E) is produced.

In one embodiment, the Z-HFO-1234ze produced from any of the processes disclosed herein is of a high purity and is free of or substantially free of chlorinated compounds, making it suitable for etching gas and/or pharmaceutical applications. By “high purity” is meant a purity greater than 99.5 wt. %, or greater than 99.6 wt. %, or greater than 99.7 wt. %, or greater than 99.8 wt. %, preferably 99.9 wt. % or greater. By “substantially free of” with respect to chlorinated compounds is meant that the amount of chlorinated compounds present in the composition is less than about 100 ppm, preferably less than about 50 ppm, more preferably less than about 10 ppm, and most preferably less than about 1 ppm.

In one embodiment, the Z-HFO-1234ze produced from any of the processes disclosed herein is particularly suitable for use a blowing agent.

In one embodiment, the Z-HFO-1234ze produced from any of the processes disclosed herein is particularly suitable for use a coolant for direct to chip cooling.

### Blend Compositions

In another embodiment, compositions of the present invention comprise HFO-1234ze(Z) and at least one compound selected from HFO-1234yf, HFO-1234ze(E), HFO-1132(E), HFO-1132(Z), HFO-1252zc, HFO-1225ye(E), HFO-1225ye(Z), HFO-1243yc, HFO-1243zf, HFO-1336mzz(E), HFO-1336mzz(Z), HFO-1336yf, HFO-1336ze(E), HFO-1336ze(Z), HCFO-1233zd(E), HCFO-1233zd(Z), HCFO-1224yd(Z), HCFO-1224yd(E), CFO-1112(E), CFO-1112(Z), HFC-245fa, HFC-236fa, HFC-227ea, trans-1,2-dichloroethylene, HFO-1132(E), HFO-1132(Z), HFC-152a, HFC-134a, HFC-134, HFC-32, HFC-125, ammonia, carbon dioxide, butane, isobutane, cyclobutene, propane, cyclopropane, isobutene, cyclobutene, propylene, pentane and isopentane.

In another embodiment, compositions of the present invention comprise HFO-1234ze(Z) and at least one compound selected from HFO-1234yf, HFO-1234ze(E), HFO-1132(E), HFO-1132(Z), HFO-1252zc, HFO-1225ye(E), HFO-1225ye(Z), HFO-1243yc, HFO-1243zf, HFO-1336mzz(E), HFO-1336mzz(Z), HFO-1336yf, HFO-1336ze(E), HFO-1336ze(Z), HCFO-1233zd(E), HCFO-1233zd(Z), HCFO-1224yd(Z), HCFO-1224yd(E), CFO-1112(E), CFO-1112(Z), HFC-245fa, HFC-236fa, HFC-227ea, trans-1,2-dichloroethylene, HFO-1132(E), HFO-1132(Z), HFC-152a, HFC-134a, HFC-134, HFC-32, HFC-125, ammonia, carbon dioxide, butane, isobutane, cyclobutene, propane, cyclopropane, isobutene, cyclobutene, propylene, pentane and isopentane, and further comprise one or more additional compounds selected from Group I.

In another embodiment, blend compositions of the present invention comprise HFO-1234ze(Z) and at least one compound selected from HFO-1234ze(E), HCFO-1233zd(E), HCFO-1233zd(Z), HFO-1243zf, HFC-32, HFC-134, HFC-152a, ammonia, butane, isobutane, cyclobutane, cyclopropane, propane, propylene, carbon dioxide and mixtures thereof.

In another embodiment, blend compositions of the present invention comprise HFO-1234ze(Z) and at least one compound selected from HFO-1234ze(E), HCFO-1233zd(E), HCFO-1233zd(Z), HFO-1243zf, HFC-32, HFC-152a, ammonia, carbon dioxide, butane, isobutane, cyclobutane, cyclopropane, propane, propylene and mixtures thereof, and further comprise one or more additional compounds selected from Group I.

In another embodiment, blend compositions of the present invention comprise HFO-1234ze(Z) and at least one compound selected from HFO-1234ze(E), HCFO-1233zd(E), HFC-245fa, HFO-1336mzz(E), HFO-1336mzz(Z), HFC-227ea, HFC-134a and HFC-134.

In one embodiment, compositions of the present invention comprise HFO-1234ze(Z) and at least one compound selected from HFO-1234ze(E), HFC-245fa, HCFO-1233zd(E), and mixtures thereof.

In compositions of the present invention comprise HFO-1234ze(Z), at least one compound selected from HFO-1234ze(E), HFC-245fa, HCFO-1233zd(E) and mixtures thereof, and one or more additional compounds selected from Group I.

For any of the compositions disclosed herein, the HFO-1234ze(Z) is preferably produced by one of the integrated processes disclosed herein. For any of the compositions disclosed herein, the HFO-1234ze(Z) may be a component separated from the final reaction mixture, a distilled component, or a combination of both.

In another embodiment, blend compositions of the present invention comprise HFO-1234ze(Z) and HFO-1234ze(E), the mixture preferably being produced directly from the integrated process disclosed herein. In one embodiment, after purification and/or separation, no blending or mixing steps are required to achieve the desired blend composition (i.e., the E:Z ratio in the mixture after purification/separation meets the desired blend composition). In another embodiment, after purification and/or separation, the E:Z ratio may be adjusted by blending with additional amounts of Z-HFO-1234ze and/or E-HFO-1234ze.

As noted above, such compositions produced by the integrated process comprise HFO-1234ze(E), HFO-1234ze(Z), one or more additional compounds selected from Group 1, and one or more additional compounds selected from Group II.

In some embodiments, compositions of the present invention comprise HFO-1234ze(E) in an amount of about 0.0001 wt % to about 99.99 wt % and HFO-1234ze(Z) in an amount of about 0.0001 wt % to about 99.99 wt %, or HFO-1234ze(E) in an amount of about 0.001 wt % to about 99.99 wt % and HFO-1234ze(Z) in an amount of about 0.001 wt % to about 99.99 wt %, or HFO-1234ze(E) in an amount of about 0.01 wt % to about 99.99 wt % and HFO-1234ze(Z) in an amount of about 0.01 wt % to about 99.99 wt %, or HFO-1234ze(E) in an amount of about 0.1 wt % to about 99.9 wt % and HFO-1234ze(Z) in an amount of about 0.1 wt % to about 99.9 wt %, or HFO-1234ze(E) in an amount of about 0.2 wt % to about 99.8 wt % and HFO-1234ze(Z) in an amount of about 0.2 wt % to about 99.8 wt %, or HFO-1234ze(E) in an amount of about 0.3 wt % to about 99.7 wt % and HFO-1234ze(Z) in an amount of about 0.3 wt % to about 99.7 wt %, or HFO-1234ze(E) in an amount of about 0.4 wt % to about 99.6 wt % and HFO-1234ze(Z) in an amount of about 0.4 wt % to about 99.6 wt %, or HFO-1234ze(E) in an amount of about 0.5 wt % to about 99.5 wt % and HFO-1234ze(Z) in an amount of about 0.5 wt % to about 99.5 wt %, or HFO-1234ze(E) in an amount of about 1 wt % to about 99 wt % and HFO-1234ze(Z) in an amount of about 1 wt % to about 99 wt %, or HFO-1234ze(E) in an amount of about 2 wt % to about 98 wt % and HFO-1234ze(Z) in an amount of about 2 wt % to about 98 wt %, or HFO-1234ze(E) in an amount of about 4 wt % to about 96 wt % and HFO-1234ze(Z) in an amount of about 4 wt % to about 96 wt %, or HFO-1234ze(E) in an amount of about 5 wt % to about 95 wt % and HFO-1234ze(Z) in an amount of about 5 wt % to about 95 wt %, or HFO-1234ze(E) in an amount of about 10 wt % to about 90 wt % and HFO-1234ze(Z) in an amount of about 10 wt % to about 90 wt %, or HFO-1234ze(E) in an amount of about 20 wt % to about 80 wt % and HFO-1234ze(Z) in an amount of about 20 wt % to about 80 wt %, or HFO-1234ze(E) in an amount of about 30 wt % to about 70 wt % and HFO-1234ze(Z) in an amount of about 30 wt % to about 70 wt %, or HFO-1234ze(E) in an amount of about 40 wt % to about 60 wt % and HFO-1234ze(Z) in an amount of about 40 wt % to about 60 wt %, or in one particular embodiment HFO-1234ze(Z) in an amount of about 84 wt % and HFO-1234ze(E) in an amount of about 16 wt %, based on the total composition, with up to about 0.5 wt % containing one or more additional compounds selected from Group I and one or more additional compounds selected from Group II.

In one embodiment, compositions of the present invention comprising HFO-1234ze(Z) and HFO-1234ze(E) are suitable for use as heat transfer fluids in a heat pump, preferably a high temperature heat pump.

In one embodiment, compositions for heat pumps, preferably high temperature heat pumps, comprise HFO-1234ze(E) in an amount of about 0.0001 wt % to about 99.99 wt % and HFO-1234ze(Z) in an amount of about 0.0001 wt % to about 99.99 wt %, or HFO-1234ze(E) in an amount of about 0.001 wt % to about 99.99 wt % and HFO-1234ze(Z) in an amount of about 0.001 wt % to about 99.99 wt %, or HFO-1234ze(E) in an amount of about 0.01 wt % to about 99.99 wt % and HFO-1234ze(Z) in an amount of about 0.01 wt % to about 99.99 wt %, or HFO-1234ze(E) in an amount of about 0.1 wt % to about 99.9 wt % and HFO-1234ze(Z) in an amount of about 0.1 wt % to about 99.9 wt %, or HFO-1234ze(E) in an amount of about 0.2 wt % to about 99.8 wt % and HFO-1234ze(Z) in an amount of about 0.2 wt % to about 99.8 wt %, or HFO-1234ze(E) in an amount of about 0.3 wt % to about 99.7 wt % and HFO-1234ze(Z) in an amount of about 0.3 wt % to about 99.7 wt %, or HFO-1234ze(E) in an amount of about 0.4 wt % to about 99.6 wt % and HFO-1234ze(Z) in an amount of about 0.4 wt % to about 99.6 wt %, or HFO-1234ze(E) in an amount of about 0.5 wt % to about 99.5 wt % and HFO-1234ze(Z) in an amount of about 0.5 wt % to about 99.5 wt %, or HFO-1234ze(E) in an amount of about 1 wt % to about 99 wt % and HFO-1234ze(Z) in an amount of about 1 wt % to about 99 wt %, or HFO-1234ze(E) in an amount of about 2 wt % to about 98 wt % and HFO-1234ze(Z) in an amount of about 2 wt % to about 98 wt %, or HFO-1234ze(E) in an amount of about 4 wt % to about 96 wt % and HFO-1234ze(Z) in an amount of about 4 wt % to about 96 wt %, or HFO-1234ze(E) in an amount of about 5 wt % to about 95 wt % and HFO-1234ze(Z) in an amount of about 5 wt % to about 95 wt %, or HFO-1234ze(E) in an amount of about 10 wt % to about 90 wt % and HFO-1234ze(Z) in an amount of about 10 wt % to about 90 wt %, or HFO-1234ze(E) in an amount of about 20 wt % to about 80 wt % and HFO-1234ze(Z) in an amount of about 20 wt % to about 80 wt %, or HFO-1234ze(E) in an amount of about 30 wt % to about 70 wt % and HFO-1234ze(Z) in an amount of about 30 wt % to about 70 wt %, or HFO-1234ze(E) in an amount of about 40 wt % to about 60 wt % and HFO-1234ze(Z) in an amount of about 40 wt % to about 60 wt %, or in one particular embodiment HFO-1234ze(Z) in an amount of about 84 wt % and HFO-1234ze(E) in an amount of about 16 wt %, based on the total composition, with up to about 0.5 wt %, or up to about 0.4 wt %, or up to about 0.3 wt %, or up to about 0.2 or 0.1 wt % containing one or more additional compounds selected from Group I and one or more additional compounds selected from Group II.

In some embodiments, compositions of the present invention comprise HFO-1234ze(Z) and at least one compound selected from HFO-1336mzz(E), HFO-1336mzz(Z), HFO-1224yd(Z) and HCFO-1233zd(E).

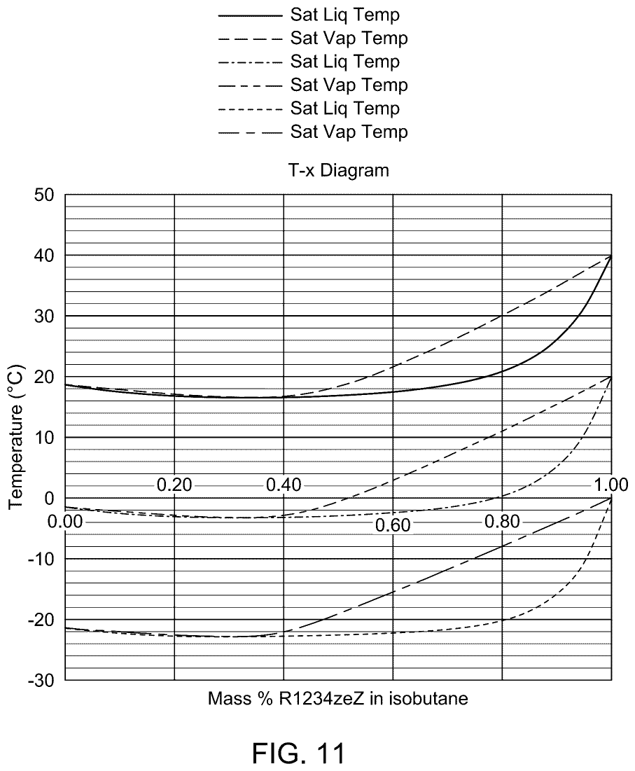

In some embodiments, a composition of the present invention comprises HFO-1234ze(Z) and isobutane (R-600a) (see FIG. 11).

In some embodiments, compositions of the present invention comprise HFO-1234ze(Z) and isobutane, and further comprise (i) one or more additional compounds selected from butane, propane, propylene, pentane and isopentane, or one or more additional compounds selected from methane, ethane, butadiene, allene, methyl cyclopropane, 2-methylpropene, propane, propyne and propylene; and (ii) further comprise one or more additional compounds selected from Group I.

In some embodiments, compositions of the present invention comprise HFO-1234ze(Z) in an amount of about 0.5 wt % to about 99.5 wt % and isobutane in an amount of about 0.5 wt % to about 99.5 wt %, based on the total composition, with up to about 2 wt %, or up to about 1.5 wt %, or up to about 1 wt %, or up to about 0.5 wt % containing (i) one or more additional compounds selected from butane, propane, propylene, pentane and isopentane, or one or more additional compounds selected from methane, ethane, butadiene, allene, methyl cyclopropane, 2-methylpropene, propane, propyne and propylene; and (ii) one or more additional compounds selected from Group I.

In some embodiments, the isobutane component of the composition comprises 99.9 wt. % isobutane and 0.1 wt. % one or more additional compounds selected from butane, 2-methylpropene, methyl cyclopropane, methane, ethane and combinations thereof. In some embodiments, the amount of butane in the composition is less than 100 ppm, preferably less than 50 ppm, based on the total weight of the isobutane component. In some embodiments, the amount of 2-methylpropene in the composition is less than 100 ppm, preferably less than 50 ppm, based on the total weight of the isobutane component. In some embodiments, the amount of methane in the composition is less than 100 ppm, preferably less than 50 ppm, based on the total weight of the isobutane component. In some embodiments, the amount of ethane in the composition is less than 100 ppm, preferably less than 50 ppm, based on the total weight of the isobutane component. In some embodiments, the amount of methyl cyclopropane in the composition is less than 100 ppm, preferably less than 50 ppm, based on the total weight of the isobutane component. In some embodiments, the total amount of methane and ethane in the composition is less than 100 ppm, preferably less than 50 ppm, based on the total weight of the isobutane component. In some embodiments, the total amount of butane, 2-methylpropene, methyl cyclopropane, methane and ethane in the composition is less than 100 ppm, preferably less than 50 ppm, based on the total weight of the isobutane component.

In some embodiments, the isobutane component of the composition comprises 99.9 wt. % isobutane and 0.1 wt. % one or more additional compounds selected from propane, butane, butadiene, propyne, allene, propylene, methane, ethane and combinations thereof. In some embodiments, the amount of propylene in the composition is less than 100 ppm, preferably less than 50 ppm, based on the total weight of the isobutane component. In some embodiments, the amount of propane in the composition is less than 100 ppm, preferably less than 50 ppm, based on the total weight of the isobutane component. In some embodiments, the amount of butane in the composition is less than 100 ppm, preferably less than 50 ppm, based on the total weight of the isobutane component. In some embodiments, the amount of butadiene in the composition is less than 100 ppm, preferably less than 50 ppm, based on the total weight of the isobutane component. In some embodiments, the amount of propyne in the composition is less than 100 ppm, preferably less than 50 ppm, based on the total weight of the isobutane component. In some embodiments, the amount of allene in the composition is less than 100 ppm, preferably less than 50 ppm, based on the total weight of the isobutane component. In some embodiments, the amount of methane in the composition is less than 100 ppm, preferably less than 50 ppm, based on the total weight of the isobutane component. In some embodiments, the amount of ethane in the composition is less than 100 ppm, preferably less than 50 ppm, based on the total weight of the isobutane component. In some embodiments, the total amount of methane and ethane in the composition is less than 100 ppm, preferably less than 50 ppm, based on the total weight of the isobutane component. In some embodiments, the total amount of butadiene, allene and propyne in the composition is less than 100 ppm, preferably less than 50 ppm, based on the total weight of the isobutane component. In some embodiments, the total amount of propane, butane, butadiene, propyne, allene, propylene, methane and ethane in the composition is less than 100 ppm, preferably less than 50 ppm, based on the total weight of the isobutane component.

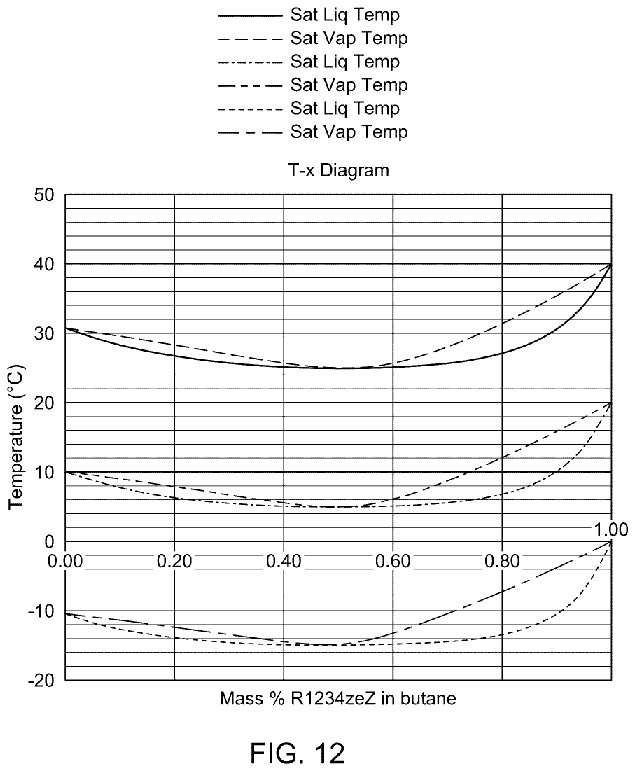

In some embodiments, a composition of the present invention comprises HFO-1234ze(Z) and butane (R-600) (see FIG. 12).

In some embodiments, compositions of the present invention comprise HFO-1234ze(Z) and butane, and further comprise one or more additional compounds selected from isobutane, propane, propylene, pentane and isopentane, and further comprise one or more additional compounds selected from Group I.

In some embodiments, compositions of the present invention comprise HFO-1234ze(Z) in an amount of about 0.5 wt % to about 99.5 wt % and butane in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from isobutane, propane, propylene, pentane and isopentane, and one or more additional compounds selected from Group I.

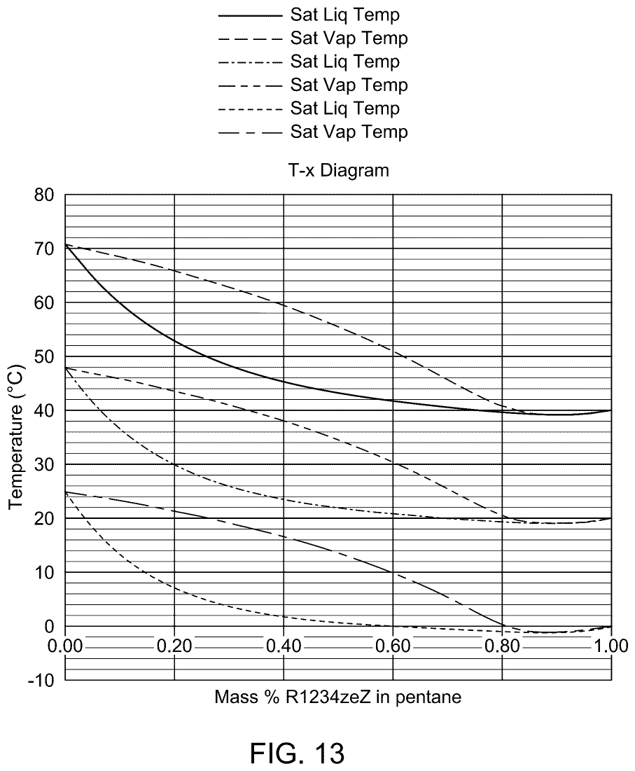

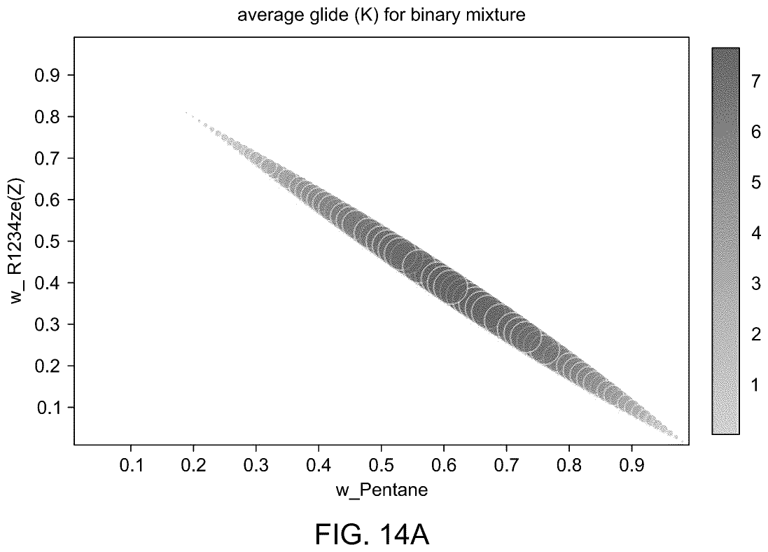

In some embodiments, a composition of the present invention comprises HFO-1234ze(Z) and pentane (R-601) (see FIG. 13).

In some embodiments, compositions of the present invention comprise HFO-1234ze(Z) and pentane, and further comprise one or more additional compounds selected from propane, propylene, butane, isobutane, butylene, isobutene and isopentane, and further comprise one or more additional compounds selected from Group I.

In some embodiments, compositions of the present invention comprise HFO-1234ze(Z) in an amount of about 0.5 wt % to about 99.5 wt % and pentane in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from propane, propylene, butane, isobutane, butylene, isobutene and isopentane, and one or more additional compounds selected from Group I.

In some embodiments, a composition of the present invention comprises HFO-1234ze(Z) and isobutene.

In some embodiments, compositions of the present invention comprise HFO-1234ze(Z) and isobutene, and further comprise one or more additional compounds selected from propane, propylene, isobutane, butylene, butane, pentane and isopentane, and further comprise one or more additional compounds selected from Group I.

In some embodiments, compositions of the present invention comprise HFO-1234ze(Z) in an amount of about 0.5 wt % to about 99.5 wt % and isobutene in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from propane, propylene, isobutane, butylene, butane, pentane and isopentane, and one or more additional compounds selected from Group I.

In some embodiments, a composition of the present invention comprises HFO-1234ze(Z) and propane.

In some embodiments, compositions of the present invention comprise HFO-1234ze(Z) and propane, and further comprise (i) one or more additional compounds selected from butane, isobutane, propylene, pentane and isopentane, or one or more additional compounds selected from methane, ethane, butadiene, allene, butane, cyclobutane, acetylene, propyne and propylene; and (ii) further comprise one or more additional compounds selected from Group I.

In some embodiments, compositions of the present invention comprise HFO-1234ze(Z) in an amount of about 0.5 wt % to about 99.5 wt % and propane in an amount of about 0.5 wt % to about 99.5 wt %, based on the total composition, with up to about 2 wt %, or up to about 1.5 wt %, or up to about 1 wt %, or up to about 0.5 wt % containing (i) one or more additional compounds selected from butane, isobutane, propylene, pentane and isopentane, or one or more additional compounds selected from methane, ethane, butadiene, allene, butane, cyclobutane, acetylene, propyne and propylene; and (ii) one or more additional compounds selected from Group I.

In some embodiments, the propane component of the composition comprises 99.9 wt. % propane and 0.1 wt. % one or more additional compounds selected from isobutane, butane, methane, ethane and combinations thereof. In some embodiments, the amount of methane is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component.

In some embodiments, the propane component of the composition comprises 99.9 wt. % propane and 0.1 wt. % one or more additional compounds selected from isobutane, butane, propylene, methane, ethane and combinations thereof. In some embodiments, the amount of propylene in the composition is less than 100 ppm, preferably less than 50 ppm, based on the total weight of the propane component. In some embodiments, the amount of methane in the composition is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component. In some embodiments, the total amount of propylene, methane and ethane in the composition is less than 100 ppm, preferably less than 50 ppm, based on the total weight of the propane component.

In some embodiments, the propane component of the composition comprises 99.9 wt. % propane and 0.1 wt. % impurities selected from isobutane, butane, propylene, butadiene, allene, propyne, methane, ethane and combinations thereof. In some embodiments, the amount of propylene in the composition is less than 100 ppm, preferably less than 50 ppm, based on the total weight of the propane component. In some embodiments, the amount of methane in the composition is less than 100 ppm, preferably less than 50 ppm, based on the total weight of the propane component. In some embodiments, the amount of ethane in the composition is less than 100 ppm, preferably less than 50 ppm, based on the total weight of the propane component. In some embodiments, the amount of butadiene in the composition is less than 100 ppm, preferably less than 50 ppm, based on the total weight of the propane component. In some embodiments, the amount of allene in the composition is less than 100 ppm, preferably less than 50 ppm, based on the total weight of the propane component. In some embodiments, the amount of propyne in the composition is less than 100 ppm, preferably less than 50 ppm, based on the total weight of the propane component. In some embodiments, the total amount of methane and ethane in the composition is less than 100 ppm, preferably less than 50 ppm, based on the total weight of the propane component. In some embodiments, the total amount of propylene, methane and ethane in the composition is less than 100 ppm, preferably less than 50 ppm, based on the total weight of the propane component. In some embodiments, the total amount of butadiene, allene and propyne in the composition is less than 100 ppm, preferably less than 50 ppm, based on the total weight of the propane component.

In some embodiments, a composition of the present invention comprises HFO-1234ze(Z) and propylene.

In some embodiments, compositions of the present invention comprise HFO-1234ze(Z) and propylene, and further comprise one or more additional compounds selected from propane, butane and isobutane, and further comprise one or more additional compounds selected from Group I.

In some embodiments, compositions of the present invention comprise HFO-1234ze(Z) in an amount of about 0.5 wt % to about 99.5 wt % and propylene in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from propane, butane and isobutane, and one or more additional compounds selected from Group I.

In some embodiments, a composition of the present invention comprises HFO-1234ze(Z) and ammonia.

In some embodiments, compositions of the present invention comprise HFO-1234ze(Z) and ammonia, and further comprise one or more additional compounds selected from N₂ and H₂O, and further comprise one or more additional compounds selected from Group I.

In some embodiments, compositions of the present invention comprise HFO-1234ze(Z) in an amount of about 0.5 wt % to about 99.5 wt % and ammonia in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from N₂ and H₂O, and one or more additional compounds selected from Group I.

In some embodiments, compositions of the present invention comprise (i) HFO-1234ze(Z); (ii) at least one hydrocarbon selected from butane, isobutane, cyclobutene, propane, cyclopropane, isobutene, cyclobutene, propylene, pentane and isopentane, and more preferably selected from butane, isobutane, propane, and propylene; and (iii) at least one fluorocarbon selected from HFC-134, HFC-134a, HFC-125, HFC-32, HFC-152a, and combinations thereof. In some embodiments, the compositions further comprise one or more additional compounds selected from Group I.

In some embodiments, compositions of the present invention comprise (i) HFO-1234ze(Z); (ii) at least one compound selected from carbon dioxide, ammonia, butane, isobutane, cyclobutene, propane, cyclopropane, isobutene, cyclobutene, propylene, pentane and isopentane, and more preferably selected from ammonia, butane, isobutane, propane, and propylene; and (iii) at least one fluorocarbon selected from HFC-134, HFC-134a, HFC-125, HFC-32, HFC-152a, and combinations thereof. In some embodiments, the compositions further comprise one or more additional compounds selected from Group I.

In some embodiments, any of the HFO-1234ze(Z)/hydrocarbon compositions disclosed herein have a flammability classification of 2L or 2 as determined by ASHRAE Standard 34 and ASTM E681-09.

In some embodiments, a composition of the present invention comprises HFO-1234ze(Z) and HFO-1336mzz(E).

In some embodiments, compositions of the present invention comprise HFO-1234ze(Z) and HFO-1336mzz(E), and further comprise one or more additional compounds selected from HCFO-1233xf, HFO-1336ft, HCFC-133a, CO-1140, HCFO-1233zd(E), HFC-245fa, HFO-1327mz, HFC-347mef, HFO-1243zf, and further comprise one or more additional compounds selected from Group I.

In some embodiments, compositions of the present invention comprise HFO-1234ze(Z) in an amount of about 0.5 wt % to about 99.5 wt % and HFO-1336mzz(E) in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from Group I, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf.

In one embodiment, compositions of the present invention comprising HFO-1234ze(Z) and HFO-1336mzz(E) are suitable for use as blowing agents or as heat transfer fluids in a heat pump, preferably a high temperature heat pump.

In one embodiment, compositions for heat pumps, preferably high temperature heat pumps, comprise HFO-1234ze(Z) in an amount of about 29 wt % to about 66 wt %, and HFO-1336mzz(E) in an amount of about 34 wt % to about 71 wt %, based on the total composition, with up to about 0.5 wt %, or up to about 0.4 wt %, or up to about 0.3 wt %, or up to about 0.2 or 0.1 wt % containing one or more additional compounds selected from Group I, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf.

In one embodiment, blowing agent compositions comprise HFO-1234ze(Z) in an amount of about 10 wt % to about 90 wt %, and HFO-1336mzz(E) in an amount of about 10 wt % to about 90 wt %, or HFO-1234ze(Z) in an amount of about 30 wt % to about 70 wt %, and HFO-1336mzz(E) in an amount of about 30 wt % to about 30 wt %, based on the total composition, with up to about 2 wt %, or up to about 1.5 wt %, or up to about 1 wt %, or up to about 0.5 wt % containing one or more additional compounds selected from Group I, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf.

In some embodiments, a composition of the present invention comprises HFO-1234ze(Z) and HFO-1336mzz(Z).

In some embodiments, compositions of the present invention comprise HFO-1234ze(Z) and HFO-1336mzz(Z), and further comprise one or more additional compounds selected from HFO-1336mzz(E), HFO-1327mz, HFO-1326mxz(Z), HFO-1326mxz(E), HFC-356mff, CHFC-346mdf, and HFC-263fb, and further comprise one or more additional compounds selected from Group I.

In some embodiments, compositions of the present invention comprise HFO-1234ze(Z) in an amount of about 0.5 wt % to about 99.5 wt % and HFO-1336mzz(Z) in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from HFO-1336mzz(E), HFO-1327mz, HFO-1326mxz(Z), HFO-1326mxz(E), HFC-356mff, CHFC-346mdf, and HFC-263fb, and one or more additional compounds selected from Group I.

In one embodiment, compositions of the present invention comprising HFO-1234ze(Z) and HFO-1336mzz(Z) are suitable for use as blowing agents or as heat transfer fluids in a heat pump, preferably a high temperature heat pump.

In some embodiments, compositions for heat pumps, preferably high temperature heat pumps, comprise HFO-1234ze(Z) in an amount of about 72 wt % to about 99.5 wt %, and HFO-1336mzz(Z) in an amount of about 0.5 wt % to about 28 wt %, based on the total composition, or HFO-1234ze(Z) in an amount of about 75 wt %, and HFO-1336mzz(Z) in an amount of about 25 wt %, based on the total composition, with up to about 0.5 wt %, or up to about 0.4 wt %, or up to about 0.3 wt %, or up to about 0.2 or 0.1 wt % containing one or more additional compounds selected from HFO-1336mzz(E), HFO-1327mz, HFO-1326mxz(Z), HFO-1326mxz(E), HFC-356mff, CHFC-346mdf, and HFC-263fb, and one or more additional compounds selected from Group I.

In one embodiment, blowing agent compositions of the present invention comprise HFO-1234ze(Z) in an amount of about 10 wt % to about 90 wt %, and HFO-1336mzz(E) in an amount of about 10 wt % to about 90 wt %, or HFO-1234ze(Z) in an amount of about 30 wt % to about 70 wt %, and HFO-1336mzz(E) in an amount of about 30 wt % to about 30 wt %, based on the total composition, with up to about 2 wt %, or up to about 1.5 wt %, or up to about 1 wt %, or up to about 0.5 wt % containing one or more additional compounds selected from HFO-1336mzz(E), HFO-1327mz, HFO-1326mxz(Z), HFO-1326mxz(E), HFC-356mff, CHFC-346mdf, and HFC-263fb, and one or more additional compounds selected from Group I.

In some embodiments, a composition of the present invention comprises HFO-1234ze(Z), HFO-1336mzz(Z) and HFO-1336mzz(E).

In some embodiments, compositions of the present invention comprise HFO-1234ze(Z), HFO-1336mzz(Z) and HFO-1336mzz(E), and further comprise one or more additional compounds selected from HCFO-1233xf, HFO-1336ft, HCFC-133a, CO-1140, HCFO-1233zd(E), HFC-245fa, HFO-1327mz, HFC-347mef, HFO-1243zf, and further comprise one or more additional compounds selected from HFO-1327mz, HFO-1326mxz(Z), HFO-1326mxz(E), HFC-356mff, CHFC-346mdf, and HFC-263fb, and further comprise one or more additional compounds selected from Group I.

In some embodiments, compositions of the present invention comprise HFO-1234ze(Z) in an amount of about 0.5 wt % to about 99.5 wt %, HFO-1336mzz(Z) in an amount of about 0.5 wt % to about 99.5 wt %, and HFO-1336mzz(E) in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from Group I, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf, and one or more additional compounds selected from HFO-1327mz, HFO-1326mxz(Z), HFO-1326mxz(E), HFC-356mff, CHFC-346mdf, and HFC-263fb.

In one embodiment, compositions of the present invention comprising HFO-1234ze(Z), HFO-1336mzz(Z) and HFO-1336mzz(E) are suitable for use as blowing agents or as heat transfer fluids in a heat pump, preferably a high temperature heat pump.

In one embodiment, compositions for heat pumps, preferably high temperature heat pumps, comprise HFO-1234ze(Z) in an amount of about 40 wt % to about 90 wt %, HFO-1336mzz(Z) in an amount of about 5 wt % to about 30 wt %, and HFO-1336mzz(E) in an amount of about 5 wt % to about 30 wt %, based on the total composition, with up to about 0.5 wt %, or up to about 0.4 wt %, or up to about 0.3 wt %, or up to about 0.2 or 0.1 wt % containing one or more additional compounds selected from Group I, and one or more additional compounds selected from HFO-1327mz, HFO-1326mxz(Z), HFO-1326mxz(E), HFC-356mff, CHFC-346mdf, and HFC-263fb, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf.

In one embodiment, blowing agent compositions comprise HFO-1234ze(Z) in an amount of about 30 wt % to about 80 wt %, HFO-1336mzz(Z) in an amount of about 30 wt % to about 80 wt %, and HFO-1336mzz(E) in an amount of about 30 wt % to about 80 wt %, based on the total composition, with up to about 2 wt %, or up to about 1.5 wt %, or up to about 1 wt %, or up to about 0.5 wt % containing one or more additional compounds selected from Group I, and one or more additional compounds selected from HCFO-1233xf, HFO-1336ft, HCFC-133a, CO-1140, HCFO-1233zd(E), HFC-245fa, HFO-1327mz, HFC-347mef, HFO-1243zf, and one or more additional compounds selected from HFO-1327mz, HFO-1326mxz(Z), HFO-1326mxz(E), HFC-356mff, CHFC-346mdf, and HFC-263fb.

In some embodiments, a composition of the present invention comprises HFO-1234ze(Z) and HCFO-1233zd(E).

In some embodiments, compositions of the present invention comprise HFO-1234ze(Z) and HCFO-1233zd(E), and further comprise one or more additional compounds selected from E-HFO-1234ze and HFC-245fa, and further comprise one or more additional compounds selected from Group I.

In some embodiments, compositions of the present invention comprise HFO-1234ze(Z) in an amount of about 0.5 wt % to about 99.5 wt % and HCFO-1233zd(E) in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from E-HFO-1234ze and HFC-245fa and one or more additional compounds selected from Group I.

In one embodiment, compositions of the present invention comprising HFO-1234ze(Z) and HCFO-1233zd(E) are suitable for use as blowing agents or as heat transfer fluids in a heat pump, preferably a high temperature heat pump.

In one embodiment, compositions for heat pumps, preferably high temperature heat pumps, comprise HFO-1234ze(Z) in an amount of about 20 wt % to about 80 wt % and HCFO-1233zd(E) in an amount of about 20 wt % to about 80 wt %, based on the total composition, with up to about 0.5 wt %, or up to about 0.4 wt %, or up to about 0.3 wt %, or up to about 0.2 or 0.1 wt % containing one or more additional compounds selected from E-HFO-1234ze and HFC-245fa and one or more additional compounds selected from Group I.

In one embodiment, blowing agent compositions comprise HFO-1234ze(Z) in an amount of about 30 wt % to about 70 wt % and HCFO-1233zd(E) in an amount of about 30 wt % to about 70 wt %, based on the total composition, with up to about 2 wt %, or up to about 1.5 wt %, or up to about 1 wt %, or up to about 0.5 wt % containing one or more additional compounds selected from E-HFO-1234ze and HFC-245fa and one or more additional compounds selected from Group I.

In some embodiments, a composition of the present invention comprises HFO-1234ze(Z) and HFC-245fa.

In some embodiments, compositions of the present invention comprise HFO-1234ze(Z) and HFC-245fa, and further comprise one or more additional compounds selected from Group I; and further comprise one or more additional compounds selected from (i) HFC-143a, HFC-1225zc, HFC-236fa, HFO-E-1234ze, HCFC-22, CFC-12, HCFC-142b, HCFC-133a, HCFC-1224, HCFC-235fa, HCFC-1233, HCFC-235da, HCFC-123, HCFC-141 b, HCFC-234fb, HCFC-1223xd, HCC-20, HCFC-224aa, CFC-1213xa, HCFC-233da, and HCFC-223aa, or (ii) HFO-E-1234ze, HFC-338mf, HFC-356mff, HFO-1234zc, HFC-347 isomer, HCFC-133a, HCFC-244bb, HCFC-235fa, HCFO-Z-1326mxz, HCFO-1224yd, HCFO-E-1233zd, HCFO-1224zc, HCC-160, HCFC-244, HCFO-1335, HCFC-123, HCFC-123a, HCFO-Z-1233zd, 1233zd (Br), CFO-1214ya, HCC-30, CFC-113, HCFO-1223xd, HCO-1130a and HCO-1130.

In some embodiments, compositions of the present invention comprise HFO-1234ze(Z) in an amount of about 0.5 wt % to about 99.5 wt % and HFC-245fa in an amount of about 0.0001 wt % to about 99.5 wt %, based on the total composition, with up to about 2 wt %, or up to about 1.5 wt %, or up to about 1 wt %, or up to about 0.5 wt % containing one or more additional compounds selected from Group I and one or more additional compounds selected from (i) HFC-143a, HFC-1225zc, HFC-236fa, HFO-E-1234ze, HCFC-22, CFC-12, HCFC-142b, HCFC-133a, HCFC-1224, HCFC-235fa, HCFC-1233, HCFC-235da, HCFC-123, HCFC-141 b, HCFC-234fb, HCFC-1223xd, HCC-20, HCFC-224aa, CFC-1213xa, HCFC-233da, and HCFC-223aa, or (ii) HFO-E-1234ze, HFC-338mf, HFC-356mff, HFO-1234zc, HFC-347 isomer, HCFC-133a, HCFC-244bb, HCFC-235fa, HCFO-Z-1326mxz, HCFO-1224yd, HCFO-E-1233zd, HCFO-1224zc, HCC-160, HCFC-244, HCFO-1335, HCFC-123, HCFC-123a, HCFO-Z-1233zd, 1233zd (Br), CFO-1214ya, HCC-30, CFC-113, HCFO-1223xd, HCO-1130a and HCO-1130.

In one embodiment, compositions of the present invention comprising HFO-1234ze(Z) and HFC-245fa are suitable for use as blowing agents or as heat transfer fluids in a heat pump, preferably a high temperature heat pump.

In one embodiment, compositions for heat pumps, preferably high temperature heat pumps, comprise HFO-1234ze(Z) in an amount of about 70 wt % to about 99 wt % and HFC-245fa in an amount of about 0.0001 wt % to about 30 wt %, based on the total composition, with up to about 0.5 wt %, or up to about 0.4 wt %, or up to about 0.3 wt %, or up to about 0.2 or 0.1 wt % containing one or more additional compounds selected from Group I; and one or more additional compounds selected from (i) HFC-143a, HFC-1225zc, HFC-236fa, HFO-E-1234ze, HCFC-22, CFC-12, HCFC-142b, HCFC-133a, HCFC-1224, HCFC-235fa, HCFC-1233, HCFC-235da, HCFC-123, HCFC-141b, HCFC-234fb, HCFC-1223xd, HCC-20, HCFC-224aa, CFC-1213xa, HCFC-233da, and HCFC-223aa, or (ii) HFO-E-1234ze, HFC-338mf, HFC-356mff, HFO-1234zc, HFC-347 isomer, HCFC-133a, HCFC-244bb, HCFC-235fa, HCFO-Z-1326mxz, HCFO-1224yd, HCFO-E-1233zd, HCFO-1224zc, HCC-160, HCFC-244, HCFO-1335, HCFC-123, HCFC-123a, HCFO-Z-1233zd, 1233zd (Br), CFO-1214ya, HCC-30, CFC-113, HCFO-1223xd, HCO-1130a and HCO-1130.

In one embodiment, blowing agent compositions comprise HFO-1234ze(Z) in an amount of about 70 wt % to about 99 wt % and HFC-245fa in an amount of about 0.0001 wt % to about 30 wt %, based on the total composition, with up to about 2 wt %, or up to about 1.5 wt %, or up to about 1 wt %, or up to about 0.5 wt % containing one or more additional compounds selected from Group I; and one or more additional compounds selected from (i) HFC-143a, HFC-1225zc, HFC-236fa, HFO-E-1234ze, HCFC-22, CFC-12, HCFC-142b, HCFC-133a, HCFC-1224, HCFC-235fa, HCFC-1233, HCFC-235da, HCFC-123, HCFC-141b, HCFC-234fb, HCFC-1223xd, HCC-20, HCFC-224aa, CFC-1213xa, HCFC-233da, and HCFC-223aa, or (ii) HFO-E-1234ze, HFC-338mf, HFC-356mff, HFO-1234zc, HFC-347 isomer, HCFC-133a, HCFC-244bb, HCFC-235fa, HCFO-Z-1326mxz, HCFO-1224yd, HCFO-E-1233zd, HCFO-1224zc, HCC-160, HCFC-244, HCFO-1335, HCFC-123, HCFC-123a, HCFO-Z-1233zd, 1233zd (Br), CFO-1214ya, HCC-30, CFC-113, HCFO-1223xd, HCO-1130a and HCO-1130.

In some embodiments, a blowing agent composition of the present invention comprises HFO-1234ze(Z) and HFO-1224yd(Z).

In some embodiments, blowing agent compositions of the present invention comprise HFO-1234ze(Z) and HFO-1224yd(Z), and further comprise one or more additional compounds selected from HFO-1234yf, HFO-1234ze(E), HFO-1243zf, HFC-263fb, HFC-254eb, CFC-1215yb, HCFC-244bb, HFO-1224 isomer(s) other than 1224yd(Z), HFO-1224yd(E), CFC-1112a, HCFC-225ca, HCFC-225cb and HCFC-234bb, and further comprise one or more additional compounds selected from Group I.

In some embodiments, blowing agent compositions of the present invention comprise HFO-1234ze(Z) in an amount of about 0.5 wt % to about 99.5 wt % and HFO-1224yd(Z) in an amount of about 0.5 wt % to about 99.5 wt %, based on the total composition, with up to about 2 wt %, or up to about 1.5 wt %, or up to about 1 wt %, or up to about 0.5 wt % containing one or more additional compounds selected from HFO-1234yf, HFO-1234ze(E), HFO-1243zf, HFC-263fb, HFC-254eb, CFC-1215yb, HCFC-244bb, HFO-1224 isomer(s) other than 1224yd(Z), HFO-1224yd(E), CFC-1112a, HCFC-225ca, HCFC-225cb and HCFC-234bb, and one or more additional compounds selected from Group I.

In some embodiments, compositions of the present invention comprise any one of the following mixtures, the mixtures having been produced directly from one or more of the integrated processes disclosed herein, and the mixtures having a compositional makeup including one or more additional compounds, as discussed in greater detail above: (i) E-HFO-1234ze and Z-HFO-1234ze; (ii) E-HFO-1234ze, Z-HFO-1234ze and HFC-245fa; (iii) E-HFO-1234ze, Z-HFO-1234ze and E-HCFO-1233zd; (iv) E-HFO-1234ze, Z-HFO-1234ze, HFC-245fa and E-HCFO-1233zd; 1234ze(Z)/1233zd(E); and (v) Z-HFO-1234ze, HFC-245fa and E-HCFO-1233zd.

In some embodiments, compositions of the present invention comprise HFO-1234ze(Z) and HFO-1234ze(E), the mixture of which may optionally have been produced directly from any of the integrated processes disclosed herein, and further comprise one or more compounds selected from HFC-134a and HFC-227ea.

In some embodiments, compositions of the present invention comprise HFO-1234ze(Z), HFO-1234ze(E) and HFC-227ea.

In some embodiments, compositions of the present invention comprise HFO-1234ze(Z), HFO-1234ze(E) and HFC-227ea, and further comprise one or more additional compounds selected from Group I, and further comprise one or more additional compounds selected from Group II, and further comprise one or more additional compounds selected from FC-1216 and HCFC-124.

In some embodiments, compositions of the present invention comprise HFO-1234ze(Z) in an amount of about 1 wt % to about 99 wt %, HFO-1234ze(E) in an amount of about 1 wt % to about 99 wt %, and HFC-227ea in an amount of about 0.1 wt % to about 30 wt %, based on the total composition, with up to about 0.5 wt % containing one or more additional compounds selected from Group I; one or more additional compounds selected from Group I; and/or one or more additional compounds selected from FC-1216 and HCFC-124.

In one embodiment, compositions of the present invention comprise HFO-1234ze(Z) in an amount of about 10 wt % to about 80 wt %, HFO-1234ze(E) in an amount of about 10 wt % to about 80 wt %, and HFC-227ea in an amount of about 0.1 wt % to about 30 wt %, based on the total composition, with up to about 0.5 wt % containing one or more additional compounds selected from Group I; one or more additional compounds selected from Group II; and/or one or more additional compounds selected from FC-1216 and HCFC-124.

In another embodiment, compositions of the present invention comprise HFO-1234ze(Z) in an amount of about 30 wt % to about 68 wt %, HFO-1234ze(E) in an amount of about 24 wt % to about 70 wt %, and HFC-227ea in an amount of about 0.1 wt % to about 8 wt %, based on the total composition, with up to about 0.5 wt % containing one or more additional compounds selected from Group I; one or more additional compounds selected from Group II; and/or one or more additional compounds selected from FC-1216 and HCFC-124.

In some embodiments, compositions of the present invention comprise HFO-1234ze(Z), HFO-1234ze(E) and HFC-134a.

In some embodiments, compositions of the present invention comprise HFO-1234ze(Z), HFO-1234ze(E), and HFC-134a, and further comprise (i) one or more additional compounds selected from Group I, (ii) one or more additional compounds selected from Group II, and/or (iii) one or more additional compounds selected from HFC-134, HCFC-124, HCFO-1122, HFC-143a, HCFC-31, HFC-32, HFC-125, CFC-114 and CFC-114a.

In some embodiments, compositions of the present invention comprise HFO-1234ze(Z) in an amount of about 0.1 wt % to about 40 wt %, HFO-1234ze(E) in an amount of about 0.1 wt % to about 80 wt %, and HFC-134a in an amount of about 0.1 wt % to about 50 wt %, based on the total composition, with up to about 0.5 wt % containing one or more of the above-listed additional compounds.

The total amount of additional compounds in any of the blend compositions disclosed herein ranges from greater than 0 wt. % to less than or equal to about 2 wt. %, about 1 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, based on the total weight of the composition. In another embodiment, the total amount of additional compound(s) ranges from 0.01 ppm (weight) to about 1 wt. %, and all values therebetween up to 1 wt. %. In another embodiment, the total amount of additional compound(s) ranges from 0.1 ppm (weight) to about 1 wt. %. In another embodiment, the total amount of additional compound(s) ranges from 0.001 wt. % to about 1 wt. %. In another embodiment, the total amount of additional compound(s) ranges from 0.001 wt. % to about 0.5 wt. %. In another embodiment, the total amount of additional compound(s) ranges from 0.001 wt. % to 0.4 wt. % or less, based on the total weight of the composition. In another embodiment, the total amount of additional compound(s) ranges from 0.001 wt. % to 0.1 wt. % or less, based on the total weight of the composition. In one embodiment, the total amount of additional compound(s) is about 0.1 wt. % based on the total weight of the composition.

For any of the compositions or blend compositions disclosed herein, particularly the compositions/blend compositions comprising HFO-1234ze(Z) as a component thereof, the Group I additional compounds comprise:
i) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFC-1131(E), CFC-114a, HCFC-124a, HFC-227ca, HFO-1234yf, HFC-152a, HFO-1234zf, HFC-134, HFC-245cb and combinations thereof; or
ii) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327 isomer, HFO-1336mzz(E), CFO-1112a, HFC-227ea, HFC-245cb and combinations thereof; or
iii) one or more, two or more, or three or more additional compounds selected from HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327me, HFO-1336mzz(E), CFO-1112a, HFC-227ea, HFC-245cb, CFO-1112 and combinations thereof; or
iv) one or more, two or more, or three or more additional compounds selected from HFO-1234ze(E), HFC-236fa, HFC-227ea, HFC-245fa, HFO-1234zc, CFC-114, HCFO-1233xf, HCFO-1233zd(E), HCFO-1233zd(Z), HFO-1327me, HFO-1336mzz(E), CFO-1112 and combinations thereof.

In some embodiments, for any of the compositions or blend compositions disclosed herein, particularly the compositions/blend compositions comprising HFO-1234ze(Z) as a component thereof, the Group I additional compounds comprise at least two additional compounds selected from:
a) HFC-245fa and HCFO-1233ze(E);
b) HFO-1234zc and HFC-245fa;
c) HCFO-1233xf and HCFO-1233zd(E);
d) CFC-114 and HFC-245fa;
e) HFC-236fa and HFC-227ea;
f) HFC-236fa and HFC-245fa;
e) HFO-1234ze(E) and HFC-236fa;
f) HFO-1234ze(E) and HFC-245fa;
g) HFO-1234ze(E) and HFO-1234zc;
h) HFO-1234ze(E) and CFC-114; and
i) HFO-1234ze(E) and HCFO-1233zd(E).

In some embodiments, for any of the compositions or blend compositions disclosed herein, particularly the compositions/blend compositions comprising HFO-1234ze(Z) as a component thereof, the Group I additional compounds comprise at least three additional compounds selected from:
a) HFC-236fa, HFC-227ea, HFC-245fa;
b) HFO-1234zc, HFC-245fa and HCFO-1233xf;
c) HCFO-1233xf, HCFO-1233zd(E) and HCFO-1233zd(Z);
d) HFO-1234ze(E), CFC-114 and HFC-245fa;
e) HFO-1234ze(E), HFO-1234zc and HCFO-1233xf;
f) HFO-1234ze(E), HCFO-1233xf and HCFO-1233zd(E);
g) HFO-1234ze(E), CFC-114 and HFC-236fa;
h) HFC-245fa, HFC-236fa and CFC-114;
i) HFC-245fa, HCFO-1233xf and CFC-114; and
j) HFC-245fa, HCFO-1233zd(E) and CFC-114.

For any of the compositions or blend compositions disclosed herein, particularly the compositions/blend compositions comprising HFO-1234ze(E) as a component thereof, the Group II additional compounds comprise:
i) one or more, two or more, three or more or four or more additional compounds selected from HFC-134a, HFC-134, HFO-1225zc, HFO-1234yf, HFC-245cb, HFC-236fa, HFO-1225ye(E), HFO-1234zc, HFC-245fa, HCFC-124, CFC-114, trifluoropropyne, HFC-152a, HFO-1225ye(Z), HFO-1225ye(E), HCFO-1233xf, HFC-263fb, HFO-1243zf, HCFO-1233zd(E), HFO-1234ze(Z) and combinations thereof; or
ii) one or more, two or more, three or more of four or more additional compounds selected from HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne and combinations thereof; or
iii) one or more, two or more, three or more or four or more additional compounds selected from HFO-1234yf, HFC-143a, HFC-152a, HFO-1243zf, HCFO-1233xf, HCFO-1233zd(E), HCFO-1233zd(Z), HCFO-1224yd, HCFO-1224zc, HCFO-1326mxz, CFC-113, HFC-32, HFC-23, trifluoropropyne, HFC-125, HFC-143, HFC-134, HFC-263fb, CFC-114, CFC-114a, HCC-40, HCO-1140, HCFO-1113, CFC-13, CFC-12, HFC-227ca, HCFO-1131(E), HCFC-124, HCFC-124a, HFC-134a, HFC-227ea, CFC-217ca, CFC-217ba and combinations thereof.

In some embodiments, for any of the compositions or blend compositions disclosed herein, particularly the compositions/blend compositions comprising HFO-1234ze(E) as a component thereof, the Group II additional compounds comprise at least three additional compounds selected from:
a) HFO-1225zc, HFO-1243zf and HCFC-124;
b) HFO-1234yf, HFO-1225zc and HFC-245cb;
c) HFO-1234yf, HFC-245cb and HFC-134;
d) HFO-1234yf, HFC-245cb and HFC-134a;
e) HFO-1234yf, HFO-1243zf and HFC-134;
f) HFO-1234yf, HFO-1243zf and HFC-134a;
g) HFC-125, HFC-134a and HFC-134;
h) HFO-1225zc, HFO-1243zf and HFC-134a;
i) HFO-1225zc, HFO-1243zf and CFC-114;
j) HFO-1225zc, HFO-1225ye(Z) and HCFC-124;
k) HFO-1225zc, HFC-245cb and CFC-114;
l) HFO-1225zc, HFC-236fa and HFC-134a;
m) HFC-236fa, HFC-263fb and HFC-134;
n) HFC-134a, HFC-134 and HFO-1234yf;
o) HFO-1234ze(Z), HFC-134 and HFC-134a;
p) HFO-1234ze(Z), HFO-1225zc and HFC-134;
q) HFO-1234ze(Z), HFO-1225zc and CFC-114;
r) HFO-1234ze(Z), HFO-1234zc and HFO-1243zf;
s) HFO-1234ze(Z), HCFC-124 and CFC-114;
t) HFO-1234ze(Z), HFC-227ea and HFC-227ca; and
u) HFO-1243zf, HFC-134 and HFC-236fa.

In some embodiments, for any of the compositions or blend compositions disclosed herein, particularly the compositions/blend compositions comprising HFO-1234ze(E) as a component thereof, the Group II additional compounds comprise at least four additional compounds selected from:
a) HFO-1234yf, HFC-245cb, HFO-1225zc and HFO-1243zf;
b) HFO-1234yf, HFC-245cb, HFC-134a and HFC-134;
c) HFO-1234yf, HFC-245cb, HFO-1225zc and HFO-1243zf;
d) HCFC-124, CFC-114, HFC-134a and HFC-134a;
e) HFO-1234yf, HFC-263fb, HFO-1243zf and HFO-1225zc;
f) HFC-125, HFO-1234yf, HFC-245cb and HFO-1243zf;
g) HFC-125, HFC-134, HFC-134a and HFO-1234yf;
h) HFO-1234yf, HFO-1225zc, HFC-134 and HFC-134a;
i) HFO-1234yf, HFO-1243zf, HFO-1225zc and HFC-134;
j) HFO-1234yf, HFO-1243zf, HFO-1225zc and HFC-134a;
k) HFO-1234yf, HCFO-1233zd(E), HCFC-124 and HFO-1243zf;
l) HFO-1234yf, HCFO-1233zd(E), HFC-236fa and HCFC-124;
m) HFO-1234yf, HCFO-1233zd(E), CFC-114 and HFC-263fb;
n) HCFO-1233zd(E), CFC-114, HCFC-124 and HFC-263fb;
o) HFO-1234ze(Z), HFC-134, HFC-134a and HFC-245fa;
p) HFO-1234ze(Z), HFO-1225zc, HFC-134 and HCFC-124;
q) HFO-1234ze(Z), HFO-1225zc, HFC-134 and CFC-114;
r) HFO-1234ze(Z), HFO-1234zc, HFO-1243zf and HFC-245cb;
s) HFO-1234yf, HFC-134, HCFC-124 and CFC-114.

In some embodiments, for any of the compositions or blend compositions disclosed herein which HFO-1234ze(Z) and HFO-1234ze(E) as components thereof, the composition/blend comprises at least one Group I additional compound and at least one Group II additional compound, or at least two Group I additional compounds and at least two Group II additional compounds.

In some embodiments, for any of the compositions or blend compositions disclosed herein which HFO-1234ze(Z) and HFO-1234ze(E) as components thereof, the Group I and Group II additional compounds comprise at least two additional compounds selected from:
a) HCFC-124 and CFC-114;
b) HCFO-1233xf and HCFO-1233zd(E);
c) HFC-245fa, HCFO-1233zd(E);
d) HFC-236fa and HFC-134;
e) HFC-227ea and HFC-134;
f) HFC-227ca and HFC-134;
g) HFO-1225zc and HFC-134;
h) HFO-1225ye(Z) and HFC-134; and
i) HFO-1243zf and HFC-134.

In some embodiments, for any of the compositions or blend compositions disclosed herein which HFO-1234ze(Z) and HFO-1234ze(E) as components thereof, the Group I and Group II additional compounds comprise at least two additional compounds selected from:
a) HFO-1225zc, HFO-1243zf and HCFC-124;
b) HFO-1225zc, HFO-1243zf and HFC-134;
c) HFO-1225zc, HFC-134a and HFC-134;
d) HFO-1243zf, HFC-134 and HFC-134a;
e) HCFC-124, CFC-114 and HFO-1234zc;
f) HFC-236fa, HCFC-124 and CFC-114;
g) HFC-236fa, HFC-227ea and HFC-245fa;
h) HFO-1234zc, HFC-245fa and HCFO-1233xf;
i) HCFO-1233xf, HCFO-1233zd(E) and HCFO-1233zd(Z);
j) HFC-245fa, HFC-236fa and CFC-114;
k) HFC-245fa, HCFO-1233xf and CFC-114;
l) HFC-245fa, HCFO-1233zd(E) and CFC-114; and
m) HCFO-1233xf, HFO-1243zf and CFC-114.

Some of the additional compounds making up the compositions/blends according to the present invention are defined in Table 7.

TABLE 7

| Name | Formula | Chemical Name |
|---|---|---|
| HFO-1234ze | CHF═CH—CF3 | 1,3,3,3-tetrafluoropropene |
| HFC-263fb | CF3—CH2—CH3 | 1,1,1-trifluoropropane |
| HFO-1234zc | CF2═CH—CHF2 | 1,1,3,3-tetrafluoropropene |
| HFC-245fa | CF3—CH2—CHF2 | 1,1,1,3,3-Pentafluoropropane |
| HCFO-1233zd(E) | CHCl═CH—CF3 | 1-chloro-3,3,3-trifluoropropene |
| HCFO-1233zd(Z) | CHCl═CH—CF3 | 1-chloro-3,3,3-trifluoropropene |
| HCFO-1233xf | CH2═CCl—CF3 | 2-chloro-3,3,3-trifluoropropene |
| HCFC-124 | CHClF—CF3 | 1-Chloro-1,2,2,2- |
| | | tetrafluoroethane |
| HCC-40 | CH3Cl | Chloromethane |
| CFC-114 | CClF2—CClF2 | 1,2-Dichlorotetrafluoroethane |
| HCFO-1131(E) | CHCl═CHF | 1-chloro-2-fluoroethylene |
| CFC-114a | CCl2F—CF3 | 1,1-Dichlorotetrafluoroethane |
| HCFC-124a | CClF2—CHF2 | 1-Chloro-1,1,2,2- |
| | | tetrafluoroethane |
| HFC-227ca | CF3—CF2—CHF2 | 1,1,2,2,3,3,3- |
| | | Heptafluoropropane |
| HFO-1234yf | CH2═CF—CF3 | 2,3,3,3-tetrafluoropropene |
| HFC-152a | CHF2—CH3 | 1,1-Difluoroethane |
| HFO-1243zf | CH2—CH—CF3 | 3,3,3-trifluoropropene |
| HFC-245cb | CF3—CF2—CH3 | 1,1,1,2,2-Pentafluoropropane |
| HFC-125 | CF3—CHF2 | Pentafluoroethane |
| HFC-143a | CF3—CH3 | 1,1,1-trifluoropropane |
| N/A | CH:::C—CF3 | 3,3,3-trifluoropropyne |
| HFC-134a | CHF2—CHF2 | 1,1,1,2-Tetrafluoroethane |
| HFO-1225zc | CF2═CH—CF3 | 1,1,3,3,3-pentafluoropropene |
| HFO-1225ye(E) | CHF═CF—CF3 | 1,2,3,3,3-pentafluoropropene |
| HFO-1225ye(Z) | CHF═CF—CF3 | 1,2,3,3,3-pentafluoropropene |
| HFO-1225ye | CHF═CF—CF3 | 1,2,3,3,3-pentafluoropropene |
| HFC-236fa | CF3—CH2—CF3 | 1,1,1,3,3,3-Hexafluoropropane |
| HFC- 236ea | CF3—CHF—CHF2 | 1,1,1,2,3,3-Hexafluoropropane |

It will be readily understood by those skilled in the art that the additional compounds present in the compositions and respective amounts of each additional compound which is present will depend upon the method of manufacture and/or parameters thereof.

In some embodiments, any of the compositions disclosed herein are free of or substantially free of HFO-1132(Z), wherein “substantially free of” means that less than about 0.1 percent by weight (wt %) or 1000 ppm of HFO-1132(Z) is present, preferably less than about 0.01 wt % or 100 ppm is present, more preferably less than about 0.001 wt % or 10 ppm is present, and most preferably less than about 0.0001 wt % or 1 ppm is present.

In some embodiments, the production facility for the integrated process of the present invention may be located proximate one or more facilities for producing any of the blend components disclosed herein.

Additionally, the compositions of the present invention may be prepared, in part or in entirety, from recycled or reclaimed refrigerant. One or more of the refrigerant components of the compositions of the present invention may be recycled or reclaimed by means of removing contaminants, such as air, water, or residue, which may include lubricant or particulate residue from system components. The means of removing the contaminants may vary widely, but can include distillation, decantation, filtration, and/or drying by use of molecular sieves or other absorbents. Then the recycled or reclaimed component(s) may be combined with the other component(s) (virgin, recycled or reclaimed), if needed, to form any of the compositions as described above.

Some of the compounds making up the blend compositions of the present invention are defined in Table 8.

TABLE 8

| Name | Structure | Chemical name |
|---|---|---|
| HFO-1234ze | E(trans)-CF₃CH═CHF | E-1,3,3,3-tetrafluoropropene |
| HFO-1234yf | CF₃CF═CH₂ | 2,3,3,3-tetrafluoro-1-propene |
| HFO-1225ye | CHF₂CF═CHF | 1,2,3,3-tetrafluoro-1-propene |
| HFO-1336mzz | E- and/or Z-CF₃CH═CF₃CH | 1,1,1,4,4,4-hexafluoro-2-butene |
| HFO-1336yf | CF₃CF₂CF═CH₂ | 2,3,3,4,4,4-hexafluoro-1-butene |
| HFC-1336ze | CHF═CHCF₂CF₃ | 1,3,3,4,4,4-hexafluoro-1-butene |
| HCFO-1233zd | E- and/or Z-CF₃CH═CHCl | 1-chloro-3,3,3-trifluoropropene |
| HCFO-1224yd | E- and/or Z-CF₃CF═CHCl | 1-Chloro 2,3,3,3,-tetrafluoropropene |
| HFO-1132 | E- and/or Z-CHF═CHF | 1,2-Difluoroethylene |
| CFO-1112 | E- and/or Z-CClF═CClF | 1,2-dichloro-1,2-difluoroethylene |
| HFC-245fa | CF₃CH₂CHF₂ | 1,1,1,3,3-pentafluoropropane |
| HFC-236a | CF₃CH₂CF₃ | 1,1,1,2,3,3-Hexafluoropropane |
| HFC-227ea | CF₃CF₂CHF₂ | 1,1,1,2,2,3,3,3-heptafluoropropane |
| Trans-1,2-DCE | ClCH═CHCl | trans-1,2-Dichloroethylene |
| HFC-152a | CF₂HCH₃ | 1,1-Difluoroethane |
| HFC-134a | CF₂HCFH₂ | 1,1,1,2-tetrafluoroethane |
| HFC-32 | CF₂H₂ | Difluoromethane |
| HFC-125 | CF₃CF₂H | Pentafluoroethane |
| Ammonia | NH₃ | — |
| Isobutene | (CH₃)₂C═CH₂ | 2-methylpropene |
| Propane | CH₃CH₂CH₃ | — |
| Butane | CH₃CH₂CH₂CH₃ | — |
| Isobutane | CH(CH₃)₃ | — |
| Pentane | CH₃(CH₂)₃CH₃ | — |
| Isopentane | CH(CH₃)₂(CH₂CH₃) | — |
| HFO-1327mz | E- and/or Z-C₄HF₇ | 1,1,1,2,4.4,4-heptafluoro-1-butene |
| HFO-1326mxz | E- and/or Z-CF₃CH═CClCF₃ | 2-chloro-1,1,1,4,4,4-hexafluoro-2-butene |
| HFC-356mff | CF₃CH₂CH₂CF₃ | 1,1,1,4,4,4-hexafluorobutane |
| CHFC-346mdf | CF₃CHClCH₂CF₃ | 2-chloro-1,1,1,1,4,4,4-hexafluorobutane |
| HFC-263fb | CF₃CH₂CH₃ | 1,1,1-trifluoropropane |
| HCFO-1233xf | CF₃CCl═CH₂ | 1,1,1-trifluoro-2-chloropropene |
| HFO-1336ft | CH₂═C(CF₃)₂ | 3,3,3-trifluoro-2- |
| | | (trifluoromethyl)-1-propene |
| HCFC-133a | C₂H₂F₃Cl | 1-chloro-2,2,2-trifluoroethane |
| HCO-1140 | C₂H₃Cl | Chloroethylene (vinyl chloride) |
| HFC-347mef | CF₃CHFCH₂CF₃ | 1,1,1,2,4,4,4-hepafluorobutane |
| HFO-1243zf | CF₃CH═CH₂ | 3,3,3-trifluoro-1-propene |

Certain of the compounds of any of the Tables exist as different configurational isomers or stereoisomers. When the specific isomer is not designated, the present invention is intended to include all single configurational isomers, single stereoisomers, single geometric or any combination thereof. For instance, HCFO-1233zd is meant to represent the E-isomer, Z-isomer, or any combination or mixture of both isomers in any ratio. As another example, HFO-1224zb is meant to represent the E-isomer, Z-isomer, or any combination or mixture of both isomers in any ratio.

In accordance with one embodiment of the present invention, the blend compositions may be azeotropic or azeotropic-like. In some embodiments, the blend compositions achieve a glide of less than about 10K, or less than about 5K, or less than about 1K.

In some embodiments, the HFO-1234ze(Z) compositions, HFO-1234ze(E)/HFO-1234ze(Z) compositions, and blends comprising HFO-1234ze(E) and/or HFO-1234ze(Z) (collectively referred to herein as the “HFO-1234ze composition” or “HFO-1234ze compositions”) have a flammability classification of 1, 2L or 2 as determined by ASHRAE Standard 34 and ASTM E681-09. Preferably, the HFO-1234ze compositions have a flammability rating of 1 or 2L, as determined by ASHRAE Standard 34 and ASTM E681-09.

In some embodiments, the HFO-1234ze compositions have a GWP of less than 700, preferably less than 300, more preferably less than 150, or less than 75, or less than 10 GWP, and all values and ranges therebetween. Since HFO-1234ze(Z) has a GWP of less than 1, it is possible that some compositions according to the present invention have a GWP of less than 1.

In some embodiments, the HFO-1234ze compositions according to the present invention and the degradation products thereof are preferably free of or substantially free of Group A Fluorinated Substances.

In one embodiment, as used herein, “Group A Fluorinated Substances” includes any substance that (i) contains at least one fully fluorinated methyl (—CF₃) or methylene (—CF₂—) carbon atom (without any H/Cl/Br/I attached to it); an; (ii) meets the criterion for persistence in soil/sediment and water established in Annex XIII (Section 1.1.1) of the European Union's REACH Regulation (https://reachonline.eu/reach/en/annex-xiii-1-1.1-1.1.1.html as accessed on May 2, 2023) and referenced in the Annex XV Restriction Report dated Mar. 22, 2023, the disclosure of which is hereby incorporated by reference (https://echa.europa.eu/documents/10162/f605d4b5-7c17-7414-8823-b49b9fd43aea as accessed on May 2, 2023). In one embodiment, Group A Fluorinated Substances include, but are not limited to, trifluoroacetic acid (TFA).

In another embodiment, as used herein, “Group A Fluorinated Substances” includes any substance that has a Henry's Law constant ≤250 Pa*m³/mol and contains at least one fully fluorinated methyl (—CF₃) or methylene (—CF₂—) carbon atom (without any H/Cl/Br/I attached to it). In one embodiment, Group A Fluorinated Substances include, but are not limited to, TFA.

Thus, according to some embodiments, compositions of the present invention comprise HFO-1234ze(Z) and/or HFO-1234ze(E), as a single fluid or blend, and are free of or substantially free of Group A Fluorinated Substances, such as TFA. In one embodiment, the phrase “free of” as used herein with respect to the presence of Group A Fluorinated Substances in the present compositions means that the amount of such substances in the compositions is sufficiently low so as to not be detectable, including but not limited to 0%, when measured by gas chromatography with a flame ionization detector, gas chromatography with a mass detector by analysis of a gas sample or liquid sample, and/or ion chromatography by analysis of a water sample after bubbling the thermal fluid through water. Such methodologies are well known to those skilled in the art. In one embodiment, the phrase “substantially free of” as used herein with respect to the presence of Group A Fluorinated Substances in the present compositions means that the amount of such substances in the compositions is >0 wt. % and ≤15 wt. %, or >0 wt. % and ≤10 wt. %, or >0 wt. % and ≤5 wt. %, or >0 wt. % and ≤4 wt. %, or >0 wt. % and ≤3 wt. %, or >0 wt. % and ≤2 wt. %, or >0 wt. % and ≤1 wt. %, and all values and ranges therebetween, when measured by gas chromatographic (GC) techniques, for example gas chromatography (GC) with a flame ionization or electron-capture detector, or GC coupled with a mass detector (gas chromatography/mass spectral (GC/MS) method), by ion chromatograph (IC) or ion chromatography mass spectrometry (IC-MS) techniques, or by high-performance liquid chromatography (HPLC) or high-performance liquid chromatography mass spectrometry (HPLC-MS) techniques. The TFA analytical standard may be used in either gas chromatography or ion chromatography and is available from, for example, Sigma Aldrich.

Further, in some embodiments, degradation products of such HFO-1234ze compositions of the present invention are free of or substantially free of Group A Fluorinated Substances, such as TFA. In one embodiment, the phrase “free of” as used herein with respect to the formation of Group A Fluorinated Substances by the present compositions means that the theoretical molar yield of such substances in environmental compartments of air, soil/sediment and water produced during tropospheric degradation of the compositions is sufficiently low so as to not be detectable, including but not limited to 0%, when measured by GC techniques, for example GC with a flame ionization or electron-capture detector or GC/MS method, by IC or IC-MS techniques, or by HPLC or HPLC-MS techniques. In one embodiment, the phrase “substantially free of” as used herein with respect to the formation of Group A Fluorinated Substances by the present compositions means that the theoretical molar yield of such substances in environmental compartments of air, soil/sediment and water produced during tropospheric degradation of the compositions is >0% and ≤5%, or >0% and ≤4%, or >0% and ≤3%, or >0% and ≤2%, or >0% and ≤1%, and all values and ranges therebetween, when measured by GC techniques, for example GC with a flame ionization or electron-capture detector or GC/MS method, by IC or IC-MS techniques, or by HPLC or HPLC-MS techniques.

In some embodiments, compositions of the present invention comprise, consist of or consist essentially of HFO-1234ze(Z) and further comprise one or more additional compounds selected from Group I, and are free of or substantially free of Group A Fluorinated Substances. Further, in some embodiments, degradation products of these compositions are free of or substantially free of Group A Fluorinated Substances.

According to some embodiments, compositions of the present invention comprise HFO-1234ze(Z); HFO-1234ze(E); and one or more compounds selected from HFO-1234yf, HFO-1234ze(E), HFO-1132(E), HFO-1132(Z), HFO-1252zc, HFO-1225ye(E), HFO-1225ye(Z), HFO-1243yc, HFO-1243zf, HFO-1336mzz(E), HFO-1336mzz(Z), HFO-1336yf, HFO-1336ze(E), HFO-1336ze(Z), HCFO-1233zd(E), HCFO-1233zd(Z), HCFO-1224yd(Z), HCFO-1224yd(E), CFO-1112(E), CFO-1112(Z), HFC-245fa, HFC-236fa, HFC-227ea, trans-1,2-dichloroethylene, HFO-1132(E), HFO-1132(Z), HFC-152a, HFC-134a, HFC-134, HFC-32, HFC-125, ammonia, carbon dioxide, butane, isobutane, cyclobutene, propane, cyclopropane, isobutene, cyclobutene, propylene, pentane and isopentane, and are free of or substantially free of Group A Fluorinated Substances. Further, degradation products of some of these compositions are free of or substantially free of Group A Fluorinated Substances.

According to some embodiments, compositions of the present invention comprise HFO-1234ze(Z); HFO-1234ze(E); one or more compounds selected from HFO-1234yf, HFO-1234ze(E), HFO-1132(E), HFO-1132(Z), HFO-1252zc, HFO-1225ye(E), HFO-1225ye(Z), HFO-1243yc, HFO-1243zf, HFO-1336mzz(E), HFO-1336mzz(Z), HFO-1336yf, HFO-1336ze(E), HFO-1336ze(Z), HCFO-1233zd(E), HCFO-1233zd(Z), HCFO-1224yd(Z), HCFO-1224yd(E), CFO-1112(E), CFO-1112(Z), HFC-245fa, HFC-236fa, HFC-227ea, trans-1,2-dichloroethylene, HFO-1132(E), HFO-1132(Z), HFC-152a, HFC-134a, HFC-134, HFC-32, HFC-125, ammonia, carbon dioxide, butane, isobutane, cyclobutene, propane, cyclopropane, isobutene, cyclobutene, propylene, pentane and isopentane; and one or more additional compounds selected from Group I, and are free of or substantially free of Group A Fluorinated Substances. Further, degradation products of some of these compositions are free of or substantially free of Group A Fluorinated Substances.

In some embodiments, any of the neat or blend compositions disclosed herein are free of or substantially free of Group A Fluorinated Substances, such as TFA. Further, degradation products of these compositions are free of or substantially free of Group A Fluorinated Substances, such as TFA. Examples of such compositions, which are discussed in greater detail herein including disclosure of the full compositional makeup thereof, are as follows:
HFO-1234ze(Z);
HFO-1234ze(Z)/HFO-1234ze(E);
HFO-1234ze(Z)/HFO-1336mzz(E);
HFO-1234ze(Z)/HFO-1336mzz(Z);
HFO-1234ze(Z)/HCFO-1233zd(E);
E-HFO-1234ze/Z-HFO-1234ze/HFC-245fa;
E-HFO-1234ze/Z-HFO-1234ze/E-HCFO-1233zd;
E-HFO-1234ze/Z-HFO-1234ze/HFC-245fa/E-HCFO-1233zd;
Z-HFO-1234ze/HFC-245fa/E-HCFO-1233zd;
HFO-1234ze(Z)/HFO-1234ze(E)/HFC-134a;
HFO-1234ze(Z)/HFO-1234ze(E)/HFC-227ea;
HFO-1234ze(Z)/isobutane;
HFO-1234ze(Z)/butane;
HFO-1234ze(Z)/pentane;
HFO-1234ze(Z)/propane;
HFO-1234ze(Z)/propylene; and
HFO-1234ze(Z)/ammonia.

The compositions of the present invention may be prepared by any convenient method to combine the desired amount of the individual components. A preferred method is to weigh the desired component amounts and thereafter combine, mix, or blend the components in an appropriate vessel. Agitation may be used, if desired.

In another embodiment, the compositions disclosed herein may be prepared by a method comprising (i) reclaiming a volume of one or more components of the refrigerant compositions disclosed herein from at least one refrigerant container, (ii) removing impurities sufficiently to enable reuse of said one or more of the reclaimed components, (iii) and optionally, combining all or part of said reclaimed volume of components with at least one additional refrigerant composition or component in order to produce a composition described in the various embodiments herein.

In another embodiment, a composition comprising, consisting of or consisting essentially of a mixture of HFO-1234ze(Z) and HFO-1234ze(E) may be formed directly from the integrated process disclosed herein.

A refrigerant container may be any container in which is stored a composition according to the present invention that has been used in a refrigeration apparatus, air-conditioning apparatus, or heat pump apparatus. Said container may be the refrigeration apparatus, air-conditioning apparatus, or heat pump apparatus in which the refrigerant composition was used. Additionally, the container may be a storage container for collecting reclaimed refrigerant components, including but not limited to pressurized gas cylinders.

Residual refrigerant means any amount of refrigerant or refrigerant blend component that may be moved out of the refrigerant container by any method known for transferring refrigerant blends or refrigerant blend components.

Impurities may be any component that is in the refrigerant or refrigerant blend component due to its use in a refrigeration apparatus, air-conditioning apparatus or heat pump apparatus. Such impurities include but are not limited to refrigeration lubricants, being those described earlier herein, particulates including but not limited to metal, metal salt or elastomer particles, that may have come out of the refrigeration apparatus, air-conditioning apparatus or heat pump apparatus, and any other contaminants that may adversely affect the performance of the refrigerant composition.

Such impurities may be removed sufficiently to allow reuse of the refrigerant or refrigerant blend component without adversely affecting the performance or equipment within which the refrigerant or refrigerant blend component will be used.

It may be necessary to provide additional refrigerant or refrigerant blend component to the residual refrigerant or refrigerant blend component in order to produce a composition that meets the specifications required for a given product. For instance, if a refrigerant blend has three components in a particular weight percentage range, it may be necessary to add one or more of the components in a given amount in order to restore the composition to within the specification limits.

In one embodiment, compositions of the present invention may further comprise at least one non-refrigerant component. That is, in one embodiment, the present invention relates to compositions comprising a refrigerant composition, such as any of the compositions comprising HFO-1234ze(Z) disclosed herein, and one or more non-refrigerant components.

The optional non-refrigerant components (also referred to herein as “additives”) in the compositions disclosed herein may include one or more of the following components: lubricants, dyes (including UV dyes), solubilizing agents, compatibilizers, stabilizers, tracers, odorants, perfluoropolyethers, anti-wear agents, extreme pressure agents, corrosion and oxidation inhibitors, polymerization inhibitors, metal surface energy reducers, metal surface deactivators, acid scavengers, foam control agents, viscosity index improvers, pour point depressants, detergents, viscosity adjusters, performance enhancers, flame suppressants and mixtures thereof. Indeed, many of these optional non-refrigerant components fit into one or more of these categories and may have qualities that lend themselves to achieve one or more performance characteristics.

The additive component(s) and amounts thereof selected for the disclosed compositions are elected on the basis of utility, individual equipment components, and/or the system requirements.

Lubricants which may be included in compositions of the present invention comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. Lubricants of the present invention may comprise those commonly known as “mineral oils” in the field of compression refrigeration lubrication. Mineral oils comprise paraffins (i.e., straight-chain and branched-carbon-chain, saturated hydrocarbons), naphthenes (i.e., cyclic or ring structure saturated hydrocarbons, which may be paraffins) and aromatics (i.e., unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e., linear and branched alkyl alkylbenzenes), synthetic paraffins and naphthenes, silicones, and polyalphaolefins. Representative conventional lubricants of the present invention are the commercially available BVM 100 N (paraffinic mineral oil sold by BVA Oils), napthenic mineral oil commercially available under the trademark from Suniso® 3GS and Suniso® 5GS by Crompton Co., naphthenic mineral oil commercially available from Pennzoil under the trademark Sontex® 372LT, naphthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500 and branched alkylbenzene, sold by Nippon Oil as HAB 22.

Lubricants of the present invention further comprise those which have been designed for use with hydrofluorocarbon refrigerants and are miscible with refrigerants of the present invention under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), and polyvinyl ethers (PVEs) such as PVE-FVC68D.

In one particular embodiment, the foregoing refrigerant compositions are combined with a PAG lubricant or a POE lubricant for usage in an automotive A/C system having an internal combustion engine or an electric or hybrid electric drive train.

In the compositions of the present invention including a lubricant, the lubricant may be present in an amount of less than 80 weight percent of the total composition. The lubricant may further be present in an amount of less than 60 weight percent of the total composition. In other embodiments, the amount of lubricant may be between about 0.1 and 50 weight percent of the total composition. The lubricant may also be between about 0.1 and 20 weight percent of the total composition The lubricant may also be between about 0.1 and 5 weight percent of the total composition.

In one aspect of the invention, the inventive refrigerant composition is used to introduce lubricant into the A/C system as well as or alternatively other additives, such as a) acid scavengers, b) performance enhancers, and c) flame suppressants. In one preferred embodiment, the present compositions comprise an acid scavenger.

Examples of the acid scavengers that may be included in the present compositions include, but are not limited, the stabilizers and/or the epoxide component of the stabilizers disclosed in U.S. Pat. No. 8,535,555 and the acid scavengers disclosed in International Application Publication No. WO 2020/222864, the disclosure of each of which is incorporated herein by reference in its entirety.

In some embodiments, an acid scavenger may comprise one or more epoxides, one or more amines and/or one or more hindered amines, such as, for example but not limited to, epoxybutane.

In some embodiments, an acid scavenger may comprise a siloxane, an activated aromatic compound, or a combination of both. Serrano et al (paragraph 38 of US 2011/0272624 A1), which is hereby incorporated by reference, discloses that the siloxane may be any molecule having a siloxyfunctionality. The siloxane may include an alkyl siloxane, an aryl siloxane, or a siloxane containing mixtures of aryl and alkyl substituents. For example, the siloxane may be an alkyl siloxane, including a dialkylsiloxane or a polydialkylsiloxane. Preferred siloxanes include an oxygen atom bonded to two silicon atoms, i.e., a group having the structure: SiOSi. For example, the siloxane may be a siloxane of Formula IV: R1[Si(R2R3)4O]nSi(R2R3)R4, where n is 1 or more. Siloxanes of Formula IV have n that is preferably 2 or more, more preferably 3 or more, (e.g., about 4 or more). Siloxanes of formula IV have n that is preferably about 30 or less, more preferably about 12 or less, and most preferably about 7 or less. Preferably the R4 group is an aryl group or an alkyl group. Preferably the R2 groups are aryl groups or alkyl groups or mixtures thereof. Preferably the R3 groups are aryl groups or alkyl groups or mixtures thereof. Preferably the R4 group is an aryl group or an alkyl group. Preferably R1, R2, R3, R4, or any combination thereof are not hydrogen. The R2 groups in a molecule may be the same or different. Preferably the R2 groups in a molecule are the same. The R2 groups in a molecule may be the same or different from the R3 groups. Preferably, the R2 groups and R3 groups in a molecule are the same. Preferred siloxanes include siloxanes of Formula IV, wherein R1, R2, R3, R4, R5, or any combination thereof is a methyl, ethyl, propyl, or butyl group, or any combination thereof. Exemplary siloxanes that may be used include hexamethyldisiloxane, polydimethylsiloxane, polymethylphenylsiloxane, dodecamethylpentasiloxane, decamethylcyclo-pentasiloxane, decamethyltetrasiloxane, octamethyltrisiloxane, or any combination thereof.

Incorporated by previous reference from Serrano et al paragraph notes that in one aspect of the invention, the siloxane is an alkylsiloxane containing from about 1 to about 12 carbon atoms, such as hexamethyldisiloxane. The siloxane may also be a polymer such as polydialkylsiloxane, Where the alkyl group is a methyl, ethyl, propyl, butyl, or any combination thereof. Suitable polydialkylsiloxanes have a molecular weight from about 100 to about 10,000. Highly preferred siloxanes include hexamethyldisiloxane, polydimethylsiloxane, and combinations thereof. The siloxane may consist essentially of polydimethylsiloxane, hexamethyldisoloxane, or a combination thereof.

The activated aromatic compound may be any aromatic molecule activated towards a Friedel-Crafts addition reaction, or mixtures thereof. An aromatic molecule activated towards a Friedel-Crafts addition reaction is defined to be any aromatic molecule capable of an addition reaction with mineral acids. Especially aromatic molecules capable of addition reactions with mineral acids either in the application environment (AC system) or during the ASHRAE 97: 2007 “Sealed Glass Tube Method to Test the Chemical Stability of Materials for Use within Refrigerant Systems” thermal stability test. Such molecules or compounds are typically activated by substitution of a hydrogen atoms of the aromatic ring with one of the following groups: NH2, NHR, NRz, ADH, AD, NHCOCH3, NHCOR, 4OCH3, OR, CH3, 4c2H5, R, or C6H5, where R is a hydrocarbon (preferably a hydrocarbon containing from about 1 to about 100 carbon atoms). The activated aromatic molecule may be an alcohol, or an ether, where the oxygen atom (i.e., the oxygen atom of the alcohol or ether group) is bonded directly to an aromatic group. The activated aromatic molecule may be an amine Where the nitrogen atom (i.e., the nitrogen atom of the amine group) is bonded directly to an aromatic group. By way of example, the activated aromatic molecule may have the formula ArXRn, Where X is O (i.e., oxygen) or N (i.e., nitrogen); n:1 When X:O; n:2 When x:N; Ar is an aromatic group (i.e., group, C6H5); R may be H or a carbon containing group; and When n:2, the R groups may be the same or different. For example, R may be H (i.e., hydrogen), Ar, an alkyl group, or any combination thereof, Exemplary activated aromatic molecules that may be employed in a refrigerant composition according to the teachings herein include diphenyl oxide (i.e., diphenyl ether), methyl phenyl ether (e.g., anisole), ethyl phenyl ether, butyl phenyl ether or any combination thereof. One highly preferred aromatic molecule activated to Wards a Friedel-Crafts addition reaction is diphenyl oxide.

Incorporated by previous reference from Serrano et al. The acid scavenger (e.g., the activated aromatic compound, the siloxane, or both) may be present in any concentration that results in a relatively low total acid number, a relatively low total halides concentration, a relatively low total organic acid concentration, or any combination thereof.

Preferably the acid scavenger is present at a concentration greater than about 0.0050 wt %, more preferably greater than about 0.05 wt % and even more preferably greater than about 0.1 wt % (e.g. greater than about 0.5 wt %) based on the total weight of the refrigerant composition. The acid scavenger preferably is present in a concentration less than about 5 wt %, less than about 4 wt %, less than about 3 wt %, more preferably less than about 2.5 wt % and most preferably greater than about 2 wt % (e. g. less than about 1.8 wt %) based on the total weight of the refrigerant composition.

Additional examples of acid scavengers which may be included in the refrigerant composition and preferably are excluded from the refrigerant composition include those described by Kaneko (U.S. patent application Ser. No. 11/575,256, published as U.S. Patent Publication 2007/0290164, paragraph 42, expressly incorporated herein by reference), such as one or more of: phenyl glycidyl ethers, alkyl glycidyl ethers, alkyleneglycolglycidylethers, cyclohexeneoxides, otolenoxides, or epoxy compounds such as epoxidized soybean oil, and those described by Singh et al. (U.S. patent application Ser. No. 11/250,219, published as 20060116310, paragraphs 34-42, expressly incorporated herein by reference).

Preferred additives include those described in U.S. Pat. Nos. 5,152,926; 4,755,316, which are hereby incorporated by reference. In particular, the preferred extreme pressure additives include mixtures of (A) tolyltriazole or substituted derivatives thereof, (B) an amine (e.g. Jeffamine M-600) and (C) a third component which is (i) an ethoxylated phosphate ester (e.g. Antara LP-700 type), or (ii) a phosphate alcohol (e.g. ZELEC 3337 type), or (iii) a Zinc dialkyldithiophosphate (e.g. Lubrizol 5139, 5604, 5178, or 5186 type), or (iv) a mercaptobenzothiazole, or (v) a 2,5-dimercapto-1,3,4-triadiaZole derivative (e. g. Curvan 826) or a mixture thereof. Additional examples of additives which may be used are given in U.S. Pat. No. 5,976,399 (Schnur, 5:12-6:51, hereby incorporated by reference).

Acid number is measured according to ASTM D664-01 in units of mg KOH/g. The total halides concentration, the fluorine ion concentration, and the total organic acid concentration is measured by ion chromatography. Chemical stability of the refrigerant system is measured according to ASHRAE 97: 2007 (RA 2017) “Sealed Glass Tube Method to Test the Chemical Stability of Materials for Use within Refrigerant Systems”. The viscosity of the lubricant is tested at 40° C. according to ASTM D-7042.

Mouli et al. (WO 2008/027595 and WO 2009/042847) teach the use of alkyl silanes as a stabilizer in refrigerant compositions containing fluoroolefins. Phosphates, phosphites, epoxides, and phenolic additives also have been employed in certain refrigerant compositions. These are described for example by Kaneko (U.S. patent application Ser. No. 11/575,256, published as U.S. Publication 2007/0290164) and Singh et al. (U.S. patent application Ser. No. 11/250,219, published as U.S. Publication 2006/0116310). All of these aforementioned applications are expressly incorporated herein by reference.

Preferred flame suppressants include the flame retardants described in patent application “Refrigerant compositions containing fluorine substituted olefins CA 2557873 A1” and incorporated by reference, as well as fluorinated products such as HFC-125 and/or Krytox® lubricants, also incorporated by reference and described in patent application “Refrigerant compositions comprising fluoroolefins and uses thereof WO2009018117A1.”

In one embodiment, compositions of the present invention include a composition comprising HFO-1234ze(Z) and at least one acid scavenger. In particular, in some embodiments, any of the HFO-1234ze(Z) compositions disclosed herein may include at least one acid scavenger.

Additionally, the present compositions may further comprise at least one tracer compound or mixture of tracer compounds. Tracers may be used to identify the process by which a refrigerant, or refrigerant mixture is produced. The tracer compounds may be specific to the manner of production or may be added as a single tracer or mixture of tracers in particular amounts in order to detect dilution, adulteration, contamination, or other unauthorized practices.

The tracer may be a single compound or two or more tracer compounds from the same class of compounds or from different classes of compounds. In some embodiments, the tracer is present in the compositions at a total concentration of about 1 part per million by weight (ppm) to about 5000 ppm, based on the weight of the total composition. In other embodiments, the tracer is present at a total concentration of about 1 ppm to about 1000 ppm. In other embodiments, the tracer is present at a total concentration of about 2 ppm to about 500 ppm. Alternatively, the tracer is present at a total concentration of about 10 ppm to about 300 ppm.

The tracer compound or compounds in amounts up to 100 ppm, 200 ppm, 300, ppm, 400 ppm, 500 ppm, 600 ppm, 700 ppm, 800 ppm and 900 ppm may be selected from hydrofluorocarbons, hydrofluoroolefins, hydrochlorocarbons, hydrochloroolefins, hydrochlorofluorocarbons, hydrochlorofluoroolefins, hydrochlorocarbons, hydrochloroolefins, chlorofluorocarbons, chlorofluoroolefins, hydrocarbons, perfluorocarbons, perfluoroolefins, and combinations thereof. In particular, the tracers may include, but are not limited to compounds selected from HFC-23 (trifluoromethane), HCFC-31 (chlorofluoromethane), HFC-41 (fluoromethane), HFC-161 (fluoroethane), HFC-152a (1,1-difluoromethane), HFC-143a (1,1,1-trifluoroethane), HFC-227ca (1,1,1,2,2,3,3-heptafluoropropane), HFC-227ea (1,1,1,2,3,3,3-heptafluoropropane), HFC-236fa (1,1,1,3,3,3-hexafluoropropane), HFC-236cb (1,1,1,2,2,3-hexafluoropropane), HFC-236ea (1,1,1,2,3,3-hexafluoropropane), HFC-245cb (1,1,1,2,2-pentafluoropropane), HFC-245fa (1,1,1,3,3-pentafluoropropane) HFC-245eb (1,1,1,2,3-pentafluoropropane), HFC-254eb (1,1,1,2-tetrafluoropropane), HFC-263fb (1,1,1-trifluoropropane), HFC-272ca (2,2-difluoropropane), HFC-281ea (2-fluoropropane), HFC-281fa (1-fluoropropane), HFC-329p (1,1,1,2,2,3,3,4,4-nonafluorobutane), HFC-329mmz (2-trifluoromethyl-1,1,1,3,3,3-hexafluoropropane), HFC-338mf (1,1,1,2,2,4,4,4-octafluorobutane), HFC-338pcc (1,1,2,2,3,3,4,4-octafluorobutane), CFC-12 (dichlorodifluoromethane), CFC-11 (trichlorofluoromethane), CFC-114 (1,2-dichloro-1,1,2,2-tetrafluoroethane), CFC-114a (2,2-dichloro-1,1,1,2-tetrafluoroethane), CFC-115 (chloropentafluoroethane), HCFC-22 (chlorodifluoromethane), HCFC-123 (2,2-dichloro-1,1,1-trifluoroethane), HCFC-124 (2-chloro-1,1,1,2-tetrafluoroethane), HCFC-124a (1-chloro-1,1,2,2-tetrafluoroethane), HCFC-141b (1,1-dichloro-1-fluoroethane), HCFC-142b (1-chloro-1,1-difluoroethane), HCFC-151a (1-chloro-1-fluoroethane), HCFC-244bb (2-chloro-1,1,1,2-tetrafluoropropane), HCC-40 (chloromethane), HFO-1141 (fluoroethylene), HCO-1130 (1,2-dichloroethylene, E- and/or Z-isomer), HCO-1130a (1,1-dichloroethylene), HCFO-1131 (1-chloro-2-fluoroethylene, E- and/or Z-isomer), HCFO-1131a (1-chloro-1-fluoroethylene), HCFO-1122 (2-chloro-1,1-difluoroethylene), HFO-1123 (trifluoroethylene), HFO-1234ye (1,2,3,3-tetrafluoropropene), HFO-1243zf (3,3,3-trifluoropropene), HFO-1225yeZ (1,2,3,3,3-pentafluoropropene), HFO-1225zc (1,1,3,3,3-pentafluoropropene), PFC-116 (hexafluoroethane), PFC-C216 (hexafluorocyclopropane), PFC-218 (octafluoropropane), PFC-C318 (octafluorocyclebutane), PFC-1216 (hexafluoropropene), PFC-31-10mc (decafluorobutane), PFC-31-10my (2-trifluoromethyl-1,1,1,2,3,3,3-heptafluoropropane), 2-chloro-1,1,2-trifluoroethylene (CFO-1113), 1,1,1,3,3-pentafluorobutane (HFC-365mfc), 1,1,1,2,3,4,4,5,5,5-decafluoropentane (HFC-43-10mee), 1,1,1,2,2,3,4,5,5,6,6,7,7,7-tetradecafluoroheptane, hexafluorobutadiene, 3,3,3-trifluoropropyne, deuterated hydrocarbons, deuterated hydrofluorocarbons, perfluorocarbons, fluoroethers, and mixtures thereof.

In some embodiments, the tracer is a blend containing two or more hydrofluorocarbons, or one hydrofluorocarbon in combination with one or more perfluorocarbons. In other embodiments, the tracer is a blend of at least one CFC and at least one HCFC, HFC, or PFC. In one embodiment, compositions of the present invention may comprise HFO-1234ze(Z), HFO-1336mzz(Z), HFO-1336mzz(E), HCFO-1224yd(E), HCFO-1224yd(Z), HFO-1327mz(Z), HFO-1327mz(E), one or more hydrofluoroethers, and one or more hydrofluorocarbons.

In some embodiments, any of the compositions disclosed herein, and more preferably any of the compositions comprising a hydrocarbon (e.g., isobutane, butane, propane or propylene) or ammonia as a refrigerant compound, further comprises an odorant. Examples of suitable odorants include mercaptan compounds, such as but not limited to, methanethiol (methyl mercaptan), ethanethiol (ethyl mercaptan), dimercaptosuccinic acid (DMSA) and grapefruit mercaptan ((R)-2-(4-methylcyclohex-3-enyl)propane-2-thiol)).

### Utility and Systems

The compositions comprising HFO-1234ze(Z) or HFO-1234ze(Z) and HFO-1234ze(E), discussed relative to the following utilities, systems and methods, include the single component composition disclosed herein and any of the blend compositions disclosed herein. For the sake of brevity, these compositions are collectively referred to in this discussion as the “HFO-1234ze composition” or “HFO-1234ze compositions”.

The HFO-1234ze compositions disclosed herein are useful as low global warming potential (GWP) heat transfer compositions, working fluids, aerosol propellants, foaming agents, blowing agents, solvents, cleaning agents, carrier fluids, displacement drying agents, buffing abrasion agents, polymerization media, expansion agents for polyolefins and polyurethane, gaseous dielectrics, extinguishing agents, and fire suppression agents in liquid or gaseous form. The disclosed compositions can act as a working fluid for heat transfer and refrigeration applications, particularly to carry heat from a heat source to a heat sink. Such heat transfer compositions may also be useful as a refrigerant in a cycle wherein the fluid undergoes a phase change; that is, from a liquid to a gas and back or vice versa.

In one embodiment, the HFO-1234ze compositions are useful in heat transfer systems. Examples of heat transfer systems include but are not limited to air conditioners, freezers, refrigerators, heat pumps, flooded evaporator heat pumps, direct expansion heat pumps, water chillers, flooded evaporator chillers, direct expansion chillers, walk-in coolers, mobile refrigerators, mobile air conditioning units, submerged (immersion) cooling systems, data center cooling systems, semiconductor chip cooling systems, outdoor communication equipment cooling systems, and combinations thereof.

In one embodiment, the HFO-1234ze compositions are useful in mobile heat transfer systems, including refrigeration, air conditioning, or heat pump systems or apparatus. In another embodiment, the compositions are useful in stationary heat transfer systems, including refrigeration, air conditioning, chillers, or heat pump systems or apparatus.

As used herein, mobile refrigeration apparatus, mobile air conditioning or mobile heating apparatus refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “containers’ (combined sea/land transport) as well as “swap bodies” (combined road/rail transport).

As used herein, stationary heat transfer systems are systems that are fixed in place during operation. A stationary heat transfer system may be associated within or attached to buildings of any variety or may be stand-alone devices located out of doors, such as a soft drink vending machine. These stationary applications may be stationary air conditioning and heat pumps (including but not limited to chillers, high temperature heat pumps, including trans-critical heat pumps with condenser or supercritical heat rejection heat exchanger temperatures above 50° C., 70° C., 80° C., 100° C., 120° C., 140° C., 160° C., 180° C., or 200° C.), residential, commercial or industrial air conditioning systems, and including window, ductless, ducted, packaged terminal, chillers, and those exterior but connected to the building such as rooftop systems). In stationary refrigeration applications, the disclosed compositions may be useful in high temperature, medium temperature and/or low temperature refrigeration equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigerator systems.

More particularly, high temperature refrigeration systems include those specifically for the supermarket produce section. Medium temperature refrigeration systems includes supermarket and convenience store refrigerated cases, such as cases for beverages, dairy, fresh food, and other refrigerated items. Medium temperature refrigeration systems may also include fresh food transport systems. Low temperature refrigeration systems include supermarket and convenience store freezer cabinets and displays, ice machines, and frozen food transport systems. Other specific uses may be in commercial, industrial, and/or residential refrigerators and freezers, ice machines, self-contained coolers and freezers, supermarket rack and distributed systems, walk-in and reach-in coolers and freezers, and combination systems.

Therefore, in accordance with the present invention, the HFO-1234ze compositions as disclosed herein may be useful in methods for producing cooling, producing heating, and transferring heat.

In some embodiments, the HFO-1234ze compositions disclosed herein may be useful as heat transfer fluids for submerged (immersion) cooling systems, data center cooling systems, semiconductor chip cooling systems, outdoor communication equipment cooling systems, semiconductor manufacturing, dielectric fluids, and the like.

In some embodiments, the HFO-1234ze compositions disclosed herein may be useful as heat transfer fluids for direct-to-chip cooling, for example, for cooling of data center servers. In some embodiments, the composition comprising HFO-1234ze(Z) and optionally one or more of the additional compounds, the composition comprising HFO-1234ze(Z), HFO-1234ze(E) and optionally one or more of the additional compounds, the composition comprising HFO-1234ze(Z), HFC-245fa, HCFO-1233zd(E) and optionally one or more of the additional compounds, the composition comprising HFO-1234ze(Z), HCFO-1233zd(E) and optionally one or more of the additional compounds, the composition comprising HFO-1234ze(Z), HFO-1336mzz(Z) and optionally one or more of the additional compounds, the composition comprising HFO-1234ze(Z), HFO-1336mzz(E) and optionally one or more of the additional compounds, are particularly suited for data center cooling, and more particularly as a heat transfer fluid, particularly coolant, for a direct to chip cooling loop. Any of these compositions can be used as a liquid coolant, in place of water, for cooling of data center servers, particularly by direct to chip cooling. In such an application, the HFO-1234ze(Z) containing composition circulates through a cold-plate heat exchanger located directly on the chip. The heat which dissipates from the computer chip is absorbed into the coolant loop, and is the heated fluid is then circulated through a piping network until it reaches a lower-temperature heat exchanger, to reject the heat to, for example, a cooled water loop, and/or to the server room's air conditioning system, and/or to outside ambient air.

In some embodiments, according to systems and method of the present invention, one or more non-condensable gases are purged during start up and operation of data center chiller systems and/or direct-to-chip liquid cooling systems. Examples of non-condensable gases include, but are not limited to, air, oxygen containing gases, nitrogen containing gases, CO₂ containing gases and combinations thereof.

In some embodiments, the present invention relates to compositions comprising HFO-Z-1234ze for use in a thermal management fluid for one or more data center cooling systems.

In one embodiment of the present invention, there is provided a composition comprising HFO-Z-1234ze. Preferably, the composition is free of or substantially free of chlorine-containing compounds.

As used herein, “substantially free of chlorine-containing compounds” means that an amount of each chlorine-containing compound is greater than 0 wt % but less than about than 0.1 wt %, or less than about 0.05 wt %, or less than about 0.01 wt %, inclusive of all values, integers and ranges therebetween; or preferably means that a total amount of all chlorine-containing compounds is greater than 0 wt % but less than about than 0.1 wt %, or less than about 0.05 wt %, or less than about 0.01 wt %, inclusive of all values, integers and ranges therebetween.

In one embodiment of the present invention, there is provided a composition comprising HFO-Z-1234ze and one or more additional compounds selected from Group I and combinations thereof, wherein the composition is free of or substantially free of chlorine-containing compounds.

In one embodiment of the present invention, there is provided a composition comprising HFO-Z-1234ze and one or more additional compounds selected from Group I, wherein the composition comprises no more than 0.1 wt %, or no more than 0.08 wt %, or no more than 0.06 wt %, or no more than 0.05 wt %, or no more than 0.04 wt %, or no more than 0.03 wt %, or no more than 0.02 wt %, or no more than 0.01 wt %, of each of HCFO-E-1233zd, HCFO-Z-1233zd, HCFO-1233xf, HCFC-124, HCC-40, CFC-114, HCFO-E-1131, CFC-114a and HCFC-124a. That is, each of HCFO-E-1233zd, HCFO-Z-1233zd, HCFO-1233xf, HCFC-124, HCC-40, CFC-114, HCFO-E-1131, CFC-114a and HCFC-124a is present in an amount of less than about than 0.1 wt %, or less than about 0.08 wt %, or less than about 0.06 wt %, or less than about 0.05 wt %, or less than about 0.04 wt %, or less than about 0.03 wt %, or less than about 0.02 wt %, or less than about 0.01 wt %, based on the total weight of the composition.

In one embodiment of the present invention, there is provided a composition comprising HFO-Z-1234ze and one or more additional compounds selected from Group I, wherein the composition comprises no more than 0.1 wt %, or no more than 0.08 wt %, or no more than 0.06 wt %, or no more than 0.05 wt %, or no more than 0.04 wt %, or no more than 0.03 wt %, or no more than 0.02 wt %, or no more than 0.01 wt %, total of HCFO-E-1233zd, HCFO-Z-1233zd, HCFO-1233xf, HCFC-124, HCC-40, CFC-114, HCFO-E-1131, CFC-114a and HCFC-124a. That is, the total amount of HCFO-E-1233zd, HCFO-Z-1233zd, HCFO-1233xf, HCFC-124, HCC-40, CFC-114, HCFO-E-1131, CFC-114a and HCFC-124a present in the composition is less than about than 0.1 wt %, or less than about 0.08 wt %, or less than about 0.06 wt %, or less than about 0.05 wt %, or less than about 0.04 wt %, or less than about 0.03 wt %, or less than about 0.02 wt %, or less than about 0.01 wt %, based on the total weight of the composition.

In one embodiment of the present invention, there is provided a composition comprising HFO-Z-1234ze and no more than 0.1 wt %, preferably no more than 0.05 wt %, of each of HCFO-E-1233zd, HCFO-Z-1233zd, HCFO-1233xf, HCFC-124, HCC-40, CFC-114, HCFO-E-1131, CFC-114a and HCFC-124a.

In one embodiment of the present invention, there is provided a composition comprising HFO-Z-1234ze and no more than 0.1 wt %, preferably no more than 0.05 wt %, total of HCFO-E-1233zd, HCFO-Z-1233zd, HCFO-1233xf, HCFC-124, HCC-40, CFC-114, HCFO-E-1131, CFC-114a and HCFC-124a.

In some embodiments, the present invention relates to a thermal management fluid comprising any of the above-mentioned HFO-Z-1234ze compositions.

In some embodiments, the present invention relates to a thermal management fluid comprising any of the above-mentioned HFO-Z-1234ze compositions for use in a data center cooling system.

In some embodiments, the present invention relates to a thermal management fluid comprising any of the above-mentioned HFO-Z-1234ze compositions for use in a chiller or air conditioning system at a data center.

In some embodiments, the present invention relates to a thermal management fluid comprising any of the above-mentioned HFO-Z-1234ze compositions for use in a DTC liquid cooling system at a data center.

In some embodiments, the present invention relates to a thermal management fluid comprising any of the above-mentioned HFO-Z-1234ze compositions for use in a chiller or air conditioning system and in a DTC liquid cooling system at a data center.

In some embodiments, the present invention relates to a data center cooling system, such as but not limited to one or more of a chiller, an air conditioning system and a DTC liquid cooling system, containing a thermal management fluid comprising any of the above-mentioned HFO-Z-1234ze composition.

In some embodiments, any of the above-mentioned HFO-Z-1234ze compositions is utilized in conjunction with one or more inline filter drier(s) for acid removal and/or one or more absorbent bed(s) for air removal.

In some embodiments, the absorbent bed(s) may contain a reduced metal oxide, wherein the metal oxide comprises at least one of Cu, Ti, V, Mn, Fe, Co, Zn, Ni, Pd and combinations, and preferably the column is operated at the DTC ambient temperature to remove and/or reduce oxygen.

In some embodiments, the present invention relates to compositions comprising a blend of HFO-Z-1234ze and HFO-E-1234ze (hereinafter referred to as a 1234zeE/1234zeZ blend) for use in a thermal management fluid for one or more data center cooling systems.

In one embodiment of the present invention, there is provided a composition comprising a 1234zeE/1234zeZ blend. Preferably, the composition is free of or substantially free of chlorine-containing compounds.

In one embodiment of the present invention, there is provided a composition comprising HFO-E-1234ze, HFO-Z-1234ze, one or more additional compounds selected from Group I and one or more additional compounds selected from Group II, wherein the composition is free of or substantially free of chlorine-containing compounds.

In one embodiment of the present invention, there is provided a composition comprising HFO-E-1234ze, HFO-Z-1234ze and one or more additional compounds selected from Group I and one or more additional compounds selected from Group II, wherein the composition comprises no more than 0.1 wt %, or no more than 0.08 wt %, or no more than 0.06 wt %, or no more than 0.05 wt %, or no more than 0.04 wt %, or no more than 0.03 wt %, or no more than 0.02 wt %, or no more than 0.01 wt %, of each of HCFO-E-1233zd, HCFO-Z-1233zd, HCFO-1233xf, HCFC-124, HCC-40, HCFC-114, HCFO-E-1131, HCFC-114a and HCFC-124a, based on a total weight of the composition, and more preferably comprises no more than 0.1 wt %, or no more than 0.08 wt %, or no more than 0.06 wt %, or no more than 0.05 wt %, or no more than 0.04 wt %, or no more than 0.03 wt %, or no more than 0.02 wt %, or no more than 0.01 wt %, total of HCFO-E-1233zd, HCFO-Z-1233zd, HCFO-1233xf, HCFC-124, HCC-40, HCFC-114, HCFO-E-1131, HCFC-114a and HCFC-124a, based on the total weight of the composition.

In one embodiment of the present invention, there is provided a composition comprising HFO-Z-1234ze, HFO-E-1234ze and no more than 0.1 wt %, preferably no more than 0.05 wt %, of each of HCFO-E-1233zd, HCFO-Z-1233zd, HCFO-1233xf, HCFC-124, HCC-40, HCFC-114, HCFO-E-1131, HCFC-114a and HCFC-124a, and more preferably no more than 0.1 wt % or no more than 0.05 wt %, total of HCFO-E-1233zd, HCFO-Z-1233zd, HCFO-1233xf, HCFC-124, HCC-40, HCFC-114, HCFO-E-1131, HCFC-114a and HCFC-124a, based on the total weight of the composition.

In some embodiments, the present invention relates to a thermal management fluid comprising any of the above-mentioned 1234zeE/1234zeZ blend compositions.

In some embodiments, the present invention relates to a thermal management fluid comprising any of the above-mentioned 1234zeE/1234zeZ blend compositions for use in a data center cooling system.

In some embodiments, the present invention relates to a thermal management fluid comprising any of the above-mentioned 1234zeE/1234zeZ blend compositions for use in a chiller or air conditioning system at a data center.

In some embodiments, the present invention relates to a thermal management fluid comprising any of the above-mentioned 1234zeE/1234zeZ blend compositions for use in a DTC liquid cooling system at a data center.

In some embodiments, the present invention relates to a thermal management fluid comprising any of the above-mentioned 1234zeE/1234zeZ blend compositions for use in a chiller or air conditioning system and in a DTC liquid cooling system at a data center.

In some embodiments, the present invention relates to a data center cooling system, such as but not limited to one or more of a chiller, an air conditioning system and a DTC liquid cooling system, containing a thermal management fluid comprising any of the above-mentioned 1234zeE/1234zeZ blend compositions.

In some embodiments, any of the above-mentioned 1234zeE/1234zeZ blend compositions is utilized in conjunction with one or more inline filter drier(s) for acid removal and/or one or more absorbent bed(s) for air removal.

The HFO-1234ze compositions disclosed herein may be useful as low global warming potential (GWP) replacements for currently used refrigerants, including but not limited to HCFO-E-1233zd, HFO-1336mzz(E) and HFO-1336mzz(Z), among others.

In many applications, some embodiments of the HFO-1234ze compositions are useful as refrigerants and provide at least comparable cooling performance (meaning cooling capacity and energy efficiency) as the refrigerant for which a replacement is being sought.

In another embodiment is provided a method for recharging a heat transfer system that contains a refrigerant to be replaced and a lubricant. The method comprises removing the refrigerant to be replaced from the heat transfer system while retaining a substantial portion of the lubricant in said system and introducing one of the HFO-1234ze compositions to the heat transfer system.

In one embodiment, a method for replacing a first refrigerant composition with a second refrigerant composition in a cooling or heating system is provided. The method comprises removing the first refrigerant composition from the cooling or heating system and charging second refrigerant composition to the cooling or heating system. In one embodiment, the first refrigerant is selected from any of R-1233zdE, R-1336mzzE and R-1336mzzZ, and the second refrigerant composition comprises any of the HFO-1234ze compositions disclosed herein (e.g., HFO-1234ze(Z); HFO-1234ze(Z)/HFO-1234ze(E); HFO-1234ze(Z)/isobutane; HFO-1234ze(Z)/HFO-1336mzz(E); HFO-1234ze(Z)/HFO-1336mzz(Z); HFO-1234ze(Z)/HCFO-1233zd(E); E-HFO-1234ze/Z-HFO-1234ze/HFC-245fa; E-HFO-1234ze/Z-HFO-1234ze/E-HCFO-1233zd; E-HFO-1234ze/Z-HFO-1234ze/HFC-245fa/E-HCFO-1233zd; Z-HFO-1234ze/HFC-245fa/E-HCFO-1233zd; HFO-1234ze(Z)/HFO-1234ze(E)/HFC-134a; and HFO-1234ze(Z)/HFO-1234ze(E)/HFC-227ea).

In another embodiment, a heat exchange system containing any of the HFO-1234ze(Z) compositions is provided, wherein said system is selected from the group consisting of air conditioners, freezers, refrigerators, heat pumps, water chillers, walk-in coolers, heat pumps, mobile refrigerators, mobile air conditioning units, and systems having combinations thereof. Additionally, the HFO-1234ze(Z) compositions may be useful in secondary loop systems wherein these compositions serve as the primary refrigerant thus providing cooling to a secondary heat transfer fluid that thereby cools a remote location.

Vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment, at a low temperature to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

In one embodiment, there is provided a heat transfer system containing any of the HFO-1234ze compositions. In another embodiment is disclosed a refrigeration, air-conditioning or heat pump apparatus containing any of the HFO-1234ze compositions. In another embodiment, is disclosed a stationary refrigeration or air-conditioning apparatus containing any of the HFO-1234ze compositions. In yet another embodiment is disclosed a mobile refrigeration or air conditioning apparatus containing a composition as disclosed herein.

In one embodiment, a method is provided for producing cooling comprising expanding any of the HFO-1234ze compositions in the vicinity of a body to be cooled, and thereafter compressing the composition.

In another embodiment, a method is provided for producing heating comprising compressing any of the HFO-1234ze compositions in the vicinity of a body to be heated, and thereafter expanding the composition.

The method for producing heating may further comprise passing a heat transfer medium through the condenser, whereby said condensation of working fluid heats the heat transfer medium and passing the heated heat transfer medium from the condenser to a body to be heated.

A body to be heated or cooled may be any space, object or fluid that may be heated such as water or air for space heating. In one embodiment, a body to be heated or cooled may be a room, building, or the passenger compartment of an automobile. Alternatively, in another embodiment, a body to be heated or cooled may be a second or the medium or heat transfer fluid, such as a chemical process stream.

In another embodiment, disclosed is a method of using the HFO-1234ze compositions as a heat transfer fluid composition. The method comprises transporting the working fluid from a heat source to a heat sink.

In another embodiment, the HFO-1234ze compositions of the present invention may be used to top-off a refrigerant charge in a heat transfer system. For instance, if a heat transfer system has diminished performance due to leakage of refrigerant, the compositions as disclosed herein may be added to bring performance back up to specification.

In accordance with this invention, a method is provided for converting heat from a heat source to mechanical energy. This method comprises heating a working fluid using heat supplied from the heat source; and expanding the heated working fluid to lower the pressure of the working fluid and generate mechanical energy as the pressure of the working fluid is lowered. The method is characterized by using a working fluid comprising a HFO-1234ze composition disclosed herein. The method for converting heat from a heat source to mechanical energy is a power cycle and may be an organic Rankine cycle (ORC).

The method is provided for converting heat from a heat source to mechanical energy may be a may be a sub-critical power cycle in which the organic working fluid used in the cycle receives heat at a pressure lower than the critical pressure of the organic working fluid and the working fluid remains below its critical pressure throughout the entire cycle.

The method is provided for converting heat from a heat source to mechanical energy may be a trans-critical power cycle, in which the organic working fluid used in the cycle receives heat at a pressure higher than the critical pressure of the organic working fluid. In a trans-critical cycle, the working fluid is compressed to a pressure above its critical pressure prior to being heated, and then during expansion the working fluid pressure is reduced to below its critical pressure.

The method is provided for converting heat from a heat source to mechanical energy may be a super-critical power cycle. In a super critical cycle, the working fluid remains above its critical pressure for the complete cycle (e.g., compression, heating, expansion and cooling).

In one preferred embodiment of the present invention is provided a heat pump apparatus containing a working fluid comprising any of the HFO-1234ze(Z) compositions, either as a single component working fluid or as a working fluid blend. In one embodiment, the present invention relates to a method for producing heating and/or cooling in a heat pump utilizing any of the HFO-1234ze(Z) compositions of the present invention as the working fluid.

A heat pump is a type of apparatus for producing heating and/or cooling. A heat pump includes an evaporator, a compressor, a condenser or supercritical working fluid cooler, and an expansion device. A working fluid circulates through these components in a repeating cycle. Heating is produced at the condenser where energy (in the form of heat) is extracted from the vapor working fluid as it is condensed to form liquid working fluid. Cooling is produced at the evaporator where energy is absorbed to evaporate the working fluid to form vapor working fluid.

In one embodiment, the high temperature heat pump apparatus of the present invention comprises (a) an evaporator through which a working fluid flows and is evaporated; (b) a compressor in fluid communication with the evaporator that compresses the evaporated working fluid to a higher pressure; (c) a condenser in fluid communication with the compressor through which the high pressure working fluid vapor flows and is condensed; and (d) a pressure reduction device in fluid communication with the condenser wherein the pressure of the condensed working fluid is reduced and said pressure reduction device further being in fluid communication with the evaporator such that the working fluid then repeats flow through components (a), (b), (c) and (d) in a repeating cycle.

A heat pump may be a residential heat pump for heating air. Residential heat pumps are used to produce heated air to warm a residence or home (including single family or multi-unit attached homes) and produce maximum condenser operating temperatures from about 30° C. to about 50° C. In another embodiment, a heat pump may be a high temperature heat pump, by which is meant a heat pump with condenser temperatures above 55° C., or with condenser temperatures above 80° C., or even with condenser temperatures above 100° C.

In one embodiment, the present invention relates to a method for producing heating in a high temperature heat pump comprising condensing a vapor working fluid comprising the HFO-1234ze(Z) composition, in a condenser, thereby producing a liquid working fluid. The high temperature heat pump may operate at a condenser temperature of at least about 100° C. The high temperature heat pump may comprise a centrifugal compressor or positive displacement compressor.

In some embodiments, a method and system are provided for producing heating in a high temperature heat pump having a condenser wherein a vapor working fluid is condensed to heat a heat transfer medium and the heated heat transfer medium is transported out of the condenser to a body to be heated. The method comprises condensing a vapor working fluid in a condenser, thereby producing a liquid working fluid wherein said vapor and liquid working fluid comprises any of the present compositions comprising HFO-1234ze(Z).

In one embodiment is provided a method for producing heating in a high temperature heat pump comprising extracting heat from a working fluid, thereby producing a cooled working fluid wherein said working fluid comprises any of the present compositions comprising HFO-1234ze(Z).

Heat pumps may include flooded evaporators or direct expansion evaporators.

One or more of the HFO-1234ze(Z) compositions disclosed herein are useful as heat transfer compositions, aerosol propellants, foaming agents, blowing agents, carrier fluids, displacement drying agents, buffing abrasion agents, polymerization media, expansion agents for polyolefins and polyurethane, and gaseous dielectrics.

In some embodiments, Z-HFO-1234ze is used as a dielectric in an electrical apparatus. In some embodiments, Z-HFO-1234ze is used alone. In some embodiments, Z-HFO-1234ze is used in admixture with one or more of the compounds disclosed herein. In an electrical apparatus for medium- or high-voltages, the functions of electrical insulation and electric arc extinction are typically performed by an insulating gas that is confined inside the apparatus. In the generally accepted sense of the term, “medium-voltage” denotes a voltage that is greater than 1,000 volts AC and strictly greater than 1,500 volts DC, but that does not exceed 52,000 volts AC or exceed 75,000 volts DC, whereas the term “high-voltage” denotes a voltage that is strictly greater than 52,000 volts AC and greater than 75,000 DC. In some embodiments, the insulating gas used inside these apparatuses contains Z-HFO-1234ze. In some embodiments, the insulating gas used inside these apparatuses is a blend comprising Z-HFO-1234ze.

Etching gases used in the semiconductor industry are used to etch deposits from a surface. Chemical vapor deposition (CVD) and plasma enhanced chemical vapor deposition (PECVD) chambers need to be regularly cleaned to remove deposits from the chamber walls and platens. This cleaning process reduces the productive capacity of the chamber since the chamber is out of active service during a cleaning cycle. The cleaning process may include, for example, the evacuation of reactant gases and their replacement with a cleaning gas, activation of that gas, followed by a flushing step to remove the cleaning gas from the chamber using an inert carrier gas. The cleaning gases typically work by etching the contaminant build-up from the interior surfaces, thus the etching rate of the cleaning gas is an important parameter in the utility and commercial use of the gases, and some cleaning gases can also be used as etching gases. These gases can generate relatively high amounts of toxic waste gases, which may pose additional GWP or Environmental, Health, and Safety (EHS) issues apart from the GWP of the cleaning or etch gas itself.

Thus, there is a need to reduce the harm of global warming caused by the cleaning and operation of CVD reactors with an effective and inexpensive cleaning/etching gas that has a high etch rate and a lower GWP and ESH impact than incumbent gases. In some embodiments, provided is a clean gas mixture that has low EHS and GWP, so that even if unreacted gases are released, they have reduced environmental impact. In some embodiments, provided are methods of using these gases, comprising activating the gas, either in a remote chamber or in situ in the process chamber, wherein the gas mixture comprises an oxygen source and a hydrofluoroolefin, and contacting the activated gas with the surface deposits for a time sufficient to remove said deposits. In some embodiments, the gas mixture is activated by a radio frequency (RF) source using sufficient power for a sufficient time such that the gas mixture reaches a neutral temperature of about 1000-3,000 K to form an activated gas mixture. In some embodiments, a glow discharge is used to activate the gas. In some embodiments, the activated gas mixture is contacted with the surface deposits and thereby removing at least some of the surface deposits.

In some embodiments, the gas mixtures comprise Z-HFO-1234ze. In some embodiments, the gas mixture comprises Z-HFO-1234ze alone. In some embodiments, the gas mixture comprises Z-HFO-1234ze in an admixture with one or more compounds. The Z-HFO-1234ze of these gas mixtures preferably has a purity greater than 99.5 wt. %, or greater than 99.6 wt. %, or greater than 99.7 wt. %, or greater than 99.8 wt. %, preferably 99.9 wt. % or greater, and preferably has a chlorinated compounds content of less than about 100 ppm, preferably less than about 50 ppm, more preferably less than about 10 ppm, and most preferably less than about 1 ppm.

In another embodiment, the present invention relates to blowing agent compositions comprising the HFO-1234ze compositions of the present invention.

In another embodiment, the present invention relates to foam expansion agent compositions comprising HFO-1234ze for use in preparing foams. In other embodiments the invention provides foamable compositions, and preferably thermoset (like polyurethane, polyisocyanurate, or phenolic) foam compositions, and thermoplastic (like polystyrene, polyethylene, or polypropylene) foam compositions and method of preparing foams. In such foam embodiments, one or more of the HFO-1234ze compositions are included as a foam expansion agent in foamable compositions, which composition preferably includes one or more additional components capable of reacting and/or mixing and foaming under the proper conditions to form a foam or cellular structure.

In one embodiment, the present invention further relates to a method of forming a foam comprising: (a) adding to a foamable composition a HFO-1234ze composition of the present invention; and (b) processing the foamable composition under conditions effective to form a foam.

Another embodiment of the present invention relates to the use of the HFO-1234ze compositions of the present invention as propellants in sprayable compositions. Additionally, the present invention relates to a sprayable composition comprising HFO-1234ze. The active ingredient to be sprayed together with inert ingredients, solvents and other materials may also be present in a sprayable composition. In one embodiment, a sprayable composition is an aerosol. The present compositions can be used to formulate a variety of industrial aerosols or other sprayable compositions such as contact cleaners, dusters, lubricant sprays, mold release sprays, insecticides, and the like, and consumer aerosols such as personal care products (such as, e.g., hair sprays, deodorants, and perfumes), household products (such as, e.g., waxes, polishes, pan sprays, room fresheners, and household insecticides), and automotive products (such as, e.g., cleaners and polishers), as well as medicinal materials such as anti-asthma and anti-halitosis medications. Examples of this includes metered dose inhalers (MDIs) for the treatment of asthma and other chronic obstructive pulmonary diseases and for delivery of medicaments to accessible mucous membranes or intra-nasally.

The present invention further relates to a process for producing aerosol products comprising the step of adding a composition of the present invention comprising HFO-1234ze to a formulation, including active, ingredients in an aerosol container, wherein said composition functions as a propellant. Additionally, the present invention further relates to a process for producing aerosol products comprising the step of adding a composition of the present invention comprising HFO-1234ze to a barrier type aerosol package (like a bag-in-a-can or piston can) wherein said composition is kept separated from other formulation ingredients in an aerosol container, and wherein said composition functions as a propellant. Additionally, the present invention further relates to a process for producing aerosol products comprising the step of adding only a composition of the present invention comprising HFO-1234ze to an aerosol package, wherein said composition functions as the active ingredient (e.g., a duster, or a cooling or freezing spray). In one embodiment, the Z-HFO-1234ze is of sufficiently high purity to be suitable for use as a pharmaceutical grade propellant. For pharmaceutical grade applications, the Z-HFO-1234ze preferably has a purity of at least 99.9%.

Also provided is a method for detecting a leak from a container comprising sampling the air in the vicinity of the container and detecting at least one fluorinated compound with means for detecting the leak, wherein the composition of the present invention comprising HFO-1234ze is contained inside the container.

A container may be any known container or system or apparatus that is filled with a HFO-1234ze composition of the present invention. A container may include but is not limited to a storage container, a transport container, an aerosol can, a fire extinguishing system, a chiller apparatus, a heat pump apparatus, heat transfer container, and a power cycle apparatus (e.g., an organic Rankine cycle system).

Means for detecting a leak may be any known sensor designed to detect leaks. In particular, means for detecting the leak includes, but is not limited to, electrochemical, corona discharge and mass spectroscopic leak detectors.

By “in the vicinity of” the container is meant within 12 inches of the outside surface of the container. Alternatively, in the vicinity may be within 6 inches, within 3 inches or within one inch of the outside surface of the container.

In some embodiments, the HFO-1234ze compositions of the present invention may be used in a refrigeration system. One embodiment of a refrigeration system includes an evaporator, a condenser, a compressor, an expansion device, and a heat transfer media. The heat transfer media includes the HFO-1234ze compositions of the present invention.

In another embodiment, the HFO-1234ze compositions of the present invention may be used in a process to transfer heat. The process may include providing an article and contacting the article with a heat transfer media including the HFO-1234ze compositions of the present invention. In some embodiments, the article may include electrical equipment (e.g., circuit board, computer, display, semiconductor chip, data center, or transformer), a heat transfer surface (e.g., heat sink), or article of clothing (e.g., a body suit).

In another embodiment, provided herein is a storage container for refrigerant containing the HFO-1234ze compositions of the present invention, wherein the refrigerant comprises gaseous and liquid phases.

Another embodiment of the invention relates to storing the foregoing HFO-1234ze compositions in gaseous and/or liquid phases within a sealed container. The container will be properly prepared for loading with the present compositions by evacuation and heating such that there are limits on the amount of water and/or oxygen to prevent reaction or degradation of the refrigerant portion of the compositions within the container. In one embodiment, the water is limited to 0.1 to 200 ppm by weight, or 0.1 to 100 ppm by weight, or 0.1 to 50 ppm by weight or 0.1 to 10 ppm by weight. In another embodiment, the oxygen is limited to 0.6 volume percent or less of the vapor phase. In another embodiment, the oxygen is present from about 0.01 to 0.35 volume percent. In yet another embodiment, the oxygen is limited to 0.01 to 0.25 volume percent. And in yet another embodiment, the oxygen is limited to 0.01 to 0.15 volume percent.

The container for storing the HFO-1234ze compositions of the present invention can be constructed of any suitable material and design that is capable of sealing the compositions therein while maintaining gaseous and liquids phases. Examples of suitable containers comprise pressure resistant containers such as a tank, a filling cylinder, and a secondary filling cylinder. The container can be constructed from any suitable material such as carbon steel, manganese steel, chromium-molybdenum steel, among other low-alloy steels, stainless steel and in some cases an aluminum alloy. The container can include a pierce top or valves suitable for dispensing flammable substances.

While any suitable method can be employed for stabilizing the HFO-1234ze compositions of the present invention, examples of such methods including blending the foregoing inhibitors with the HFO-1234ze compositions of the present invention, purging lines and containers with a material comprising the inhibitor (e.g., an inhibitor with a nitrogen carrier, or the inventive stabilized composition); among other suitable methods.

Another embodiment of the invention includes a refrigerant charging kit comprising the HFO-1234ze compositions of the present invention (which may be in the stabilized form) in a sealed cannister, and optionally carbon dioxide, and a tube for connecting a discharge end of the refrigerant cannister to a valve of a refrigerant circuit. In certain embodiments, any of the above-mentioned additives can be included in the stabilized refrigerant blend. Thus, the refrigerant charging kit can include any of the disclosed refrigerant blends which have been stabilized, but without a lubricant.

In another embodiment, the present invention relates to processes for the reclamation of any of the foregoing compositions, such integrated processes being described in U.S. Provisional Application No. 63/402,727, titled “Liquid Reclamation and Solid Foam Recycling/Reclamation: Compositions and Methods”, filed on Aug. 31, 2022, and U.S. Provisional Application No. 63/422,656, titled “Integrated System and Process for Producing Reclaimed, Stabilized and Traceable Refrigerant Compositions”, filed on Nov. 4, 2022, the entire contents of both of which are incorporated herein in their entireties.

For example, in one embodiment, provided herein is a process comprising the following steps: a) providing a recovered refrigerant comprising at least HFO-Z-1234ze or at least HFO-Z-1234ze and HFO-E-1234ze; testing the recovered refrigerant composition comprising at least HFO-Z-1234ze or at least HFO-Z-1234ze and HFO-E-1234ze and which may further comprise contaminants, non-condensable gases (NCG), and physical properties; checking and comparing the purity of the recovered refrigerant composition relative to AHRI 700 standards; and if the recovered refrigerant composition of does not meet AHRI 700 standards, treating and purifying the recovered refrigerant composition and providing at least one first treated product; and optionally repeating the procedure on the first treated product if needed to meet AHRI 700 standards; and optionally adding additional refrigerant components to the first treated product to form a first target refrigerant or refrigerant blend if the first treated product meets or exceeds AHRI 700 standards, or (2) further purifying the first treated product does not meet AHRI 700 standards to produce a second treated product and repeating the procedure as needed to obtain a second treated product which meets or exceeds AHRI 700 standards.

In another embodiment, a system for heating and/or cooling is provided. The system comprises an evaporator, compressor, condenser, and expansion device. The system contains any of the compositions disclosed herein.

Without further elaboration, it is believed that one skilled in the art can, using the description herein, utilize the present invention to its fullest extent. The following specific embodiments are, therefore, to be construed as merely illustrative, and do not constrain the remainder of the disclosure in any way whatsoever.

The invention will be described in greater detail below by way of specific examples. The following examples are offered for illustrative purposes and are not intended to limit the invention in any manner. Those of skill in the art will readily recognize a variety of non-critical parameters which can be changed or modified to yield essentially the same results.

### EXAMPLES

### Materials

The materials used to prepare the Examples are commercially available or may be prepared by known methods.

Purification methods to obtain final products in each of the following Examples comprised one or more, preferably at least two or more, of the following techniques/equipment/instrumentation: distillation columns, sulfuric acid drier, molecular sieves and/or alumina drier, water scrubber, caustic scrubber, and the like.

### Example 1: Preparation of HCC-240fa

Vinyl chloride (7.4 g, 0.118 mol) is added to a mixture of CCl₄ (159 g, 1.03 mol), chopped Fe wire (1.27 0.62 g, 0.011 mol) and tributyl phosphate (2.7 g, 0.01 mol) in a 210 mL Hastelloy reactor. The reactor is heated up to 110° C. for 5 hours. The pressure of the reaction is controlled to be no higher than 40 psig. A mixture comprising HCC-240fa is produced. The mixture is transferred to a container and analyzed by GC. Conversion of the reaction is 56.4% with 94% selectivity of HCC-240fa. The reaction product is found to comprise HCC-240fa and less than 5 wt. % of one or more of 1-chlorobutane, HCO-1240xd, HCO-1230xd, 1,1,1,3-tetrachloropropane, 1,4 dichlorobutane, 1,2-dichloro-cyclobutane, 1,1,4,4-tetrachlorobutadiene, 1,1,3,4 tetrachlorobutadiene, 1,1,1,2,3-pentachloropropane (HCC-240db), 1,1,3,3-tetrachloro-1-propene (CCl2=CH—CHCl2), C₅H₇Cl₃ isomer(s) and C₄H₇Cl₃ isomer(s) is obtained by distillation.

### Example 2: Preparation of HFC-245fa (Free of Superacid)

A 240 mL Hastelloy® C shaker tube is charged with SbCl5 (63 g, 0.21 mol) and cooled to −20° C. with dry ice/acetone. HF (12.6 g, 0.63 mol) is added to the shaker tube and the shaker tube is cooled and evacuated 3 times. The mixture is heated to 100° C. for an hour. After venting off HCl, the reaction product of Example 1 (i.e., HCC-240fa and less than 5 wt. % of one or more of 1-chlorobutane, HCO-1240xd, HCO-1230xd, 1,1,1,3-tetrachloropropane, 1,4 dichlorobutane, 1,2-dichloro-cyclobutane, 1,1,4,4-tetrachlorobutadiene, 1,1,3,4 tetrachlorobutadiene, 1,1,1,2,3-pentachloropropane (HCC-240db), 1,1,3,3-tetrachloro-1-propene (CCl2=CH—CHCl2), C5H7Cl3 isomer(s) and C4H7Cl3 isomer(s)) (3.6 g, 0.017 mol) and HF (8.4 g, 0.42 mol) are co-fed to the shaker tube, which was free of superacid, and the shaker tube is heated to 95° C. for 30 minutes. Conversion of the reaction is 100% with 95% selectivity of HFC-245fa. The reaction product is purified by distillation and comprises HFC-245fa and one or more of the additional compounds of Tables 1 or 2 above.

### Example 3: Preparation of HFC-245fa (Substantially Free of Superacid)

A 240 mL Hastelloy® C shaker tube is charged with SbCl5 (63 g, 0.21 mol) and cooled to −20° C. with dry ice/acetone. HF (12.6 g, 0.63 mol) is added to the shaker tube and the shaker tube is cooled and evacuated 3 times. The mixture is heated to 100° C. for an hour. After venting off HCl, the reaction product of Example 1 (i.e., HCC-240fa and less than 5 wt. % of one or more of 1-chlorobutane, HCO-1240xd, HCO-1230xd, 1,1,1,3-tetrachloropropane, 1,4 dichlorobutane, 1,2-dichloro-cyclobutane, 1,1,4,4-tetrachlorobutadiene, 1,1,3,4 tetrachlorobutadiene, 1,1,1,2,3-pentachloropropane (HCC-240db), 1,1,3,3-tetrachloro-1-propene (CCl2=CH—CHCl2), C5H7Cl3 isomer(s) and C4H7Cl3 isomer(s)) (3.6 g, 0.017 mol) and HF (14.5 g, 0.725 mol) are co-fed to the shaker tube, which contains less than 5 mol % superacid, and the shaker tube is heated to 95° C. for 30 minutes. Conversion of the reaction is 100% with 92% selectivity of HFC-245fa. The reaction product is purified by distillation and comprises HFC-245fa and one or more of the additional compounds of Tables 1 or 2 above.

### Example 4: Preparation of HFO-1234ze(Z)/(E) from HFC-245fa

An inconel tube (½ inch {13 mm} OD) was filled with 5 cc of fluorinated Cr₂O₃ catalyst (Louisville Cr). A flow of air (3.6 vol % O₂) and CF₃CH₂CHF₂ (HFC-245fa) (including two or more of the additional compounds disclosed above) (e.g., as produced in Example 2 or 3) were fed at 0.7 ml/hr over the catalyst bed at 370° C. Contact time in the reactor was 47 seconds. The CF₃CH₂CHF₂ was vaporized at 80° C. Part of the reactor effluent was passed through a series of valves and analyzed by Agilent® 6890 GC/5975C MS and a Restek® PC2618 5% Krytox® CBK-D/60/80 6-meter×2 mm ID ⅛″ OD packed column purged with helium at 30 sccm. Samples were taken in hourly intervals. The data is shown in Table 9, with the amounts of components being expressed as mole percent.

TABLE 9
Example 4

| Inj. | Unknowns | 1141 | 143a | 152a | trifluoropropyne |
|---|---|---|---|---|---|
| 1 | 1.12% | 0.03% | 0.52% | 0.00% | 0.51% |
| 2 | 0.16% | 0.04% | 0.37% | 0.00% | 0.57% |
| 3 | 0.15% | 0.04% | 0.35% | 0.00% | 0.58% |
| 4 | 0.15% | 0.04% | 0.33% | 0.00% | 0.58% |
| 5 | 0.14% | 0.04% | 0.31% | 0.00% | 0.58% |
| 6 | 0.13% | 0.03% | 0.28% | 0.00% | 0.59% |
| 7 | 0.11% | 0.03% | 0.27% | 0.00% | 0.60% |
| 8 | 0.12% | 0.03% | 0.28% | 0.00% | 0.59% |
| 9 | 0.10% | 0.03% | 0.25% | 0.00% | 0.61% |
| 10 | 0.05% | 0.03% | 0.24% | 0.00% | 0.59% |
| 11 | 0.05% | 0.03% | 0.25% | 0.00% | 0.60% |
| 12 | 0.12% | 0.04% | 0.30% | 0.00% | 0.61% |
| 13 | 0.20% | 0.06% | 0.35% | 0.00% | 0.63% |
| 14 | 0.20% | 0.06% | 0.35% | 0.00% | 0.63% |

| Inj. | 1234yf | E-1234ze | Z-1234ze | 245fa | E-1233zd | Z-1233zd |
|---|---|---|---|---|---|---|
| 1 | 0.93% | 70.84% | 18.47% | 6.78% | 0.66% | 0.13% |
| 2 | 0.68% | 71.12% | 19.22% | 7.05% | 0.66% | 0.14% |
| 3 | 0.64% | 71.12% | 19.25% | 7.06% | 0.66% | 0.14% |
| 4 | 0.56% | 71.29% | 19.19% | 7.06% | 0.65% | 0.15% |
| 5 | 0.53% | 71.32% | 19.23% | 7.04% | 0.66% | 0.15% |
| 6 | 0.46% | 71.36% | 19.28% | 7.07% | 0.65% | 0.14% |
| 7 | 0.39% | 71.41% | 19.39% | 7.00% | 0.66% | 0.14% |
| 8 | 0.46% | 71.38% | 19.31% | 7.03% | 0.65% | 0.14% |
| 9 | 0.32% | 71.60% | 19.34% | 6.94% | 0.67% | 0.14% |
| 10 | 0.33% | 71.66% | 19.28% | 7.09% | 0.60% | 0.13% |
| 11 | 0.36% | 71.61% | 19.41% | 7.07% | 0.51% | 0.11% |
| 12 | 0.45% | 71.66% | 19.26% | 6.91% | 0.54% | 0.12% |
| 13 | 0.56% | 71.52% | 19.30% | 6.68% | 0.57% | 0.13% |
| 14 | 0.55% | 71.60% | 19.25% | 6.67% | 0.56% | 0.13% |

The analysis showed 93% conversion of HFC-245fa and a selectivity to E/Z-1234ze of greater than 97%. The E/Z ratio was 3.7:1.

The final reaction product, after purification, had a purity of greater than 99.5%. That is, the composition comprised about 99.5% by weight of HFO-1234ze(E) and HFO-1234ze(Z); one or more additional compounds selected from Group I; and one or more additional compounds selected from Group II.

### Example 5: Isomerization of HFO-1234ze(E) to HFO-1234ze(Z)

An inconel tube (½ inch {13 mm} OD) is filled with 4 cc of fluorinated Cr₂O₃ catalyst. A composition comprising E-HFO-1234ze one or more additional compounds selected from one or more additional compounds selected from Group II is fed at 0.45 ml/hr with 0.91 sccm air. The reaction is performed at 300° C. Contact time is 14 seconds at atmospheric pressure. This reaction could optionally be run in the presence of an oxygen containing gas, such as air. Part of the reactor effluent is passed through a series of valves and analyzed by Agilent® 7890B GC/5977 MS and a Restek® PC2618 5% Krytox® CBK-D/60/80 6-meter×2 mm ID ⅛″ OD packed column purged with helium at 20 sccm. The conversion of E-HFO-1234ze to Z-HFO-1234ze is 20%.

In one embodiment, the final reaction product, after purification, has a purity of greater than 99%, 99.5%. That is, the composition comprises about 99%, 99.5% by weight of HFO-1234ze(Z), and further comprises HFO-245fa, one or more additional compounds selected from one or more additional compounds selected from Group 1, and one or more additional compounds selected from Tables 1 and/or 2.

In one embodiment, the final reaction product, after purification, has a purity of greater than 99.9% and is free of or substantially free of chlorinated compounds, making it suitable for etching gas applications. By “substantially free of” with respect to chlorinated compounds, for etching gas applications, is meant that the amount of chlorinated compounds present in the composition is less than about 100 ppm, preferably less than about 50 ppm, more preferably less than about 10 ppm, and most preferably less than about 1 ppm.

### Performance Examples for High Temperature

### Heat Pump Systems Comprising HFO Compositions

In the below Tables, “T_condenser” is condenser temperature, “T_evaporator” is evaporator temperature, “COP” is coefficient of performance (analogous to energy efficiency), and “CAP_c” is relative volumetric cooling capacity and “CAP_h” is relative volumetric heating capacity. In Examples 6-8, refrigerant performance has been determined for an exemplary composition of the present invention in high temperature heat pumps as compared to HFO-1234ze(Z). It will be understood by those skilled in the art that the weight percents in the refrigerant performance data are nominal weight fractions. The data are based on the conditions set forth in Table 10.

TABLE 10
High Temp Heat Pump Cooling Mode
Conditions for Examples 6-8

| | | |
|---|---|---|
| T_condenser | 130° | C. |
| T_evaporator | 50° | C. |

| | |
|---|---|
| Compressor Efficiency | 0.85 |

### Example 6: HFO-1234ze(Z)/Pentane

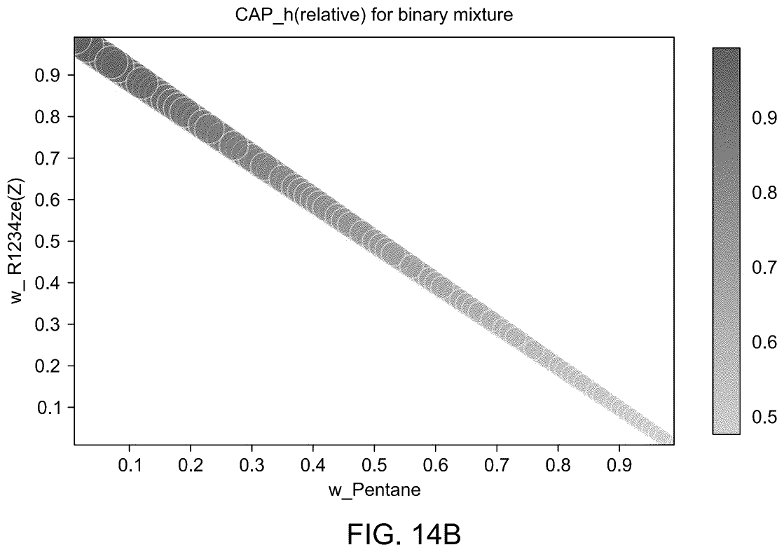

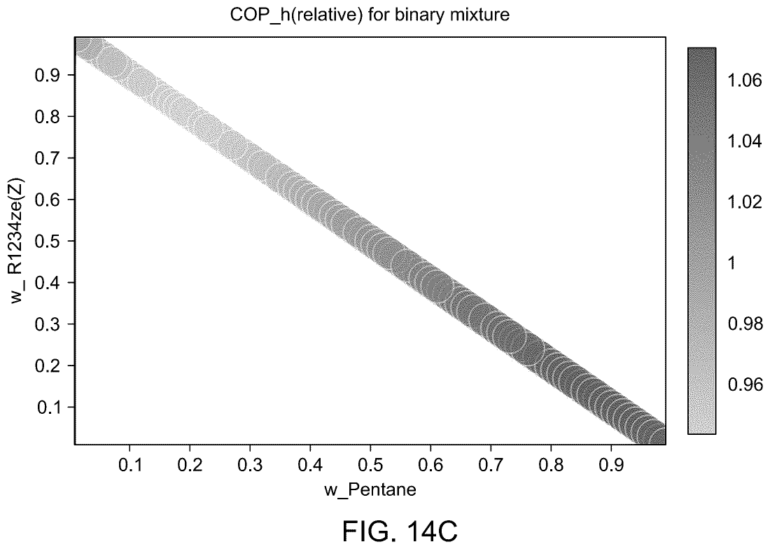

Refrigerant performance has been determined for an exemplary composition of the present invention comprising HFO-1234ze(Z) and pentane in high temperature heat pump systems as compared to HFO-1234ze(Z), in cooling mode. Performance metric and composition property ranges are summarized in Table 11, where the ASHRAE flammability class remains 2L or 2, the average temperature glide is <1 K and GWP <3. Table 12 tabulates several compositions about the compositions of optimal cooling efficiency and capacity. FIGS. 14A, 14B and 14C provide graphical representations of the average glide, the CAP for cooling relative to the incumbent fluid, and the COP for cooling relative to the incumbent fluid, respectively, for a composition according to Example 6.

TABLE 11
High Temperature Heat Pump Cooling Mode Condition,
cycle metric performance and fluid property
ranges for 1234zeZ/pentane in Ex. 6

| | MAXIMA | MINIMA |
|---|---|---|
| w_R1234ze(Z) (nominal weight fraction) | 1 | 0.87 |
| w_pentane (nominal weight fraction) | 0.13 | 0 |
| T_c (degC.) | 150 | 149 |
| average glide (K) | 0.14 | 0 |
| GWP AR5 | 2 | 1 |
| COP_h (% dev from R1234ze(Z)) | 1 | 0.95 |
| CAP_h (% dev from R1234ze(Z)) | 1 | 0.93 |

TABLE 12
High Temperature Heat Pump Cooling Mode Condition, cycle metric performance
and fluid property ranges for 1234zeZ/pentane in Ex. 6

| | | | | | | ASHRAE |
|---|---|---|---|---|---|---|
| | | Avg. | | COP_c (% | CAP_c (% | Flamma- |
| wt-% | wt-% | Glide | GWP | dev from | dev from | bility |
| Pentane | R1234ze(Z) | (K) | AR5 | R1234zdZ) | R1234zeZ) | Class |
| 0 | 1 | 0 | 1 | 1 | 1 | 2L |
| 0.01 | 0.99 | 0.0072 | 1.1 | 0.994261 | 0.99528225 | 2L |
| 0.02 | 0.98 | 0.0102 | 1.2 | 0.988741 | 0.990481058 | 2L |
| 0.03 | 0.97 | 0.0103 | 1.3 | 0.983222 | 0.985531375 | 2L |
| 0.04 | 0.96 | 0.009 | 1.4 | 0.978491 | 0.980532195 | 2L |
| 0.05 | 0.95 | 0.0075 | 1.5 | 0.97376 | 0.975483518 | 2 |
| 0.06 | 0.94 | 0.0071 | 1.6 | 0.969424 | 0.970335848 | 2 |
| 0.07 | 0.93 | 0.0091 | 1.7 | 0.965482 | 0.965188178 | 2 |
| 0.08 | 0.92 | 0.0146 | 1.8 | 0.961933 | 0.959941514 | 2 |
| 0.09 | 0.91 | 0.025 | 1.9 | 0.95878 | 0.954744347 | 2 |
| 0.1 | 0.9 | 0.0417 | 2 | 0.955626 | 0.949497683 | 2 |
| 0.11 | 0.89 | 0.066 | 2.1 | 0.95326 | 0.944251019 | 2 |
| 0.12 | 0.88 | 0.0991 | 2.2 | 0.950895 | 0.939053852 | 2 |
| 0.13 | 0.87 | 0.1426 | 2.3 | 0.948924 | 0.933807188 | 2 |

Results show that the HFO-1234ze(Z) and pentane compositions of the present invention provide similar CAP and similar energy efficiency relative to HFO-1234ze(Z), at lower costs, for cooling using high temperature heat pump systems. Additionally, in many cases, the HFO-1234ze(Z) and pentane compositions of the present invention provide similar cooling capacity relative to HFO-1234ze(Z), at lower costs. Up to 4 wt % pentane can be added to blends of these three components, where the ASHRAE flammability classification will remain 2L. Up to 14 wt % pentane can be added to blends of these three components, where the ASHRAE flammability classification will remain 2.

### Example 7: HFO-1234ze(Z)/Butane

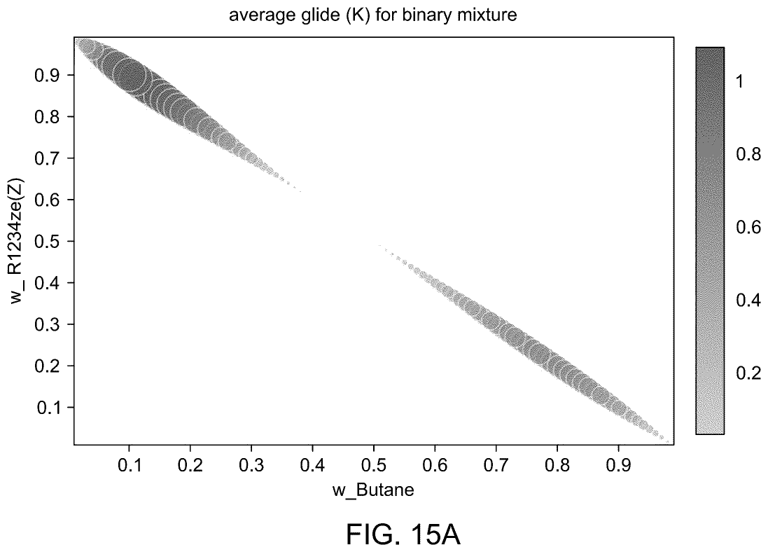

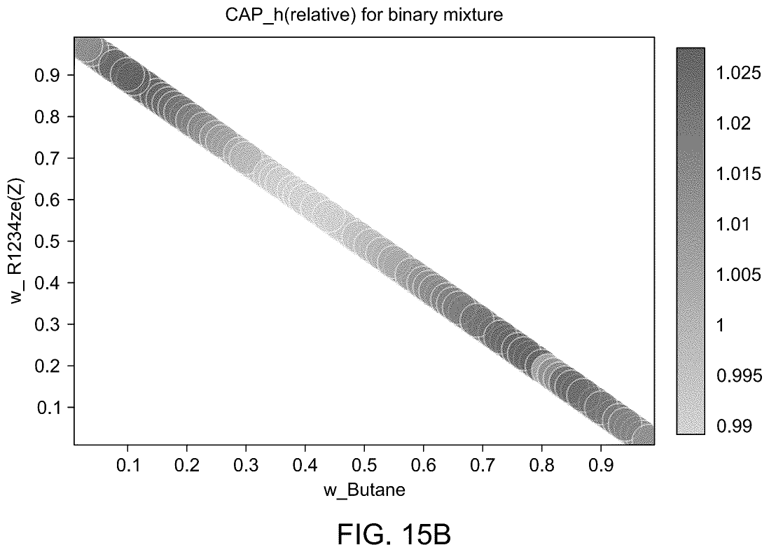

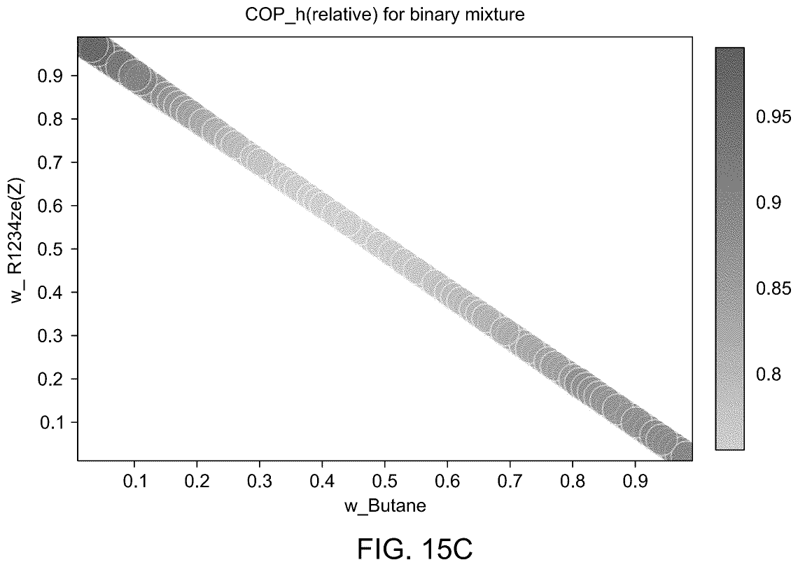

Refrigerant performance has been determined for an exemplary composition of the present invention comprising HFO-1234ze(Z) and butane in high temperature heat pump systems as compared to HFO-1234ze(Z). Performance metric and composition property ranges are summarized in Table 13, where the ASHRAE flammability class remains 2L or 2, the average temperature glide is <1 K or less than 1.5 K and GWP is about 1. Table 14 tabulates several compositions about the compositions of optimal heating efficiency and capacity. FIGS. 15A, 15B and 15C provide graphical representations of the average glide, the CAP for heating relative to the incumbent fluid, and the COP for heating relative to the incumbent fluid, respectively, for a composition according to Example 7.

TABLE 13
High Temperature Heat Pump Conditions, cycle metric performance
and fluid property ranges for 1234zeZ/butane in Ex. 7

| | Flammability = 2L | | Flammability = 2 | |
|---|---|---|---|---|
| | MAXIMA | MINIMA | MAXIMA | MINIMA |
| w_R1234ze(Z) | 100 | 96 | 95 | 87 |
| w_butane | 4 | 0 | 13 | 5 |
| T° c. (degC.) | 150.12 | 147.5 | 146.8 | 142.4 |
| avg glide_h (K) | 0.7 | 0 | 1.1 | 0.8 |
| COP_h (% dev) | 100 | 96.3 | 95.4 | 88.5 |
| CAP_h (% dev) | 101.6 | 100 | 102.7 | 101.9 |

TABLE 14
High Temperature Heat Pump Conditions, cycle metric performance
and fluid property ranges for 1234zeZ/butane in Ex. 7

| | | | | | | ASHRAE | | |
|---|---|---|---|---|---|---|---|---|
| | | Avg. | | del_h_{—} | | Flamma- | COP_h (% | CAP_h (% |
| wt-% | wt-% | Glide | GWP | comb | LFL | bility | dev from | dev from |
| butane | R1234zeZ | (K) | AR5 | (kcal/g) | (kg/m\hat{ }3) | Class | R1234zeZ | R1234zeZ |
| 0.01 | 0.99 | 0.2055 | 1.02 | 2.3154 | 0.26043938 | 2L | 0.990712551 | 1.004884635 |
| 0.02 | 0.98 | 0.3842 | 1.04 | 2.4008 | 0.247878329 | 2L | 0.981645146 | 1.009190859 |
| 0.03 | 0.97 | 0.5381 | 1.06 | 2.4862 | 0.236473174 | 2L | 0.972183506 | 1.013051612 |
| 0.04 | 0.96 | 0.6691 | 1.08 | 2.5716 | 0.226071381 | 2L | 0.963116101 | 1.0163679 |
| 0.05 | 0.95 | 0.7789 | 1.1 | 2.657 | 0.216546123 | 2 | 0.954048696 | 1.019238716 |
| 0.06 | 0.94 | 0.8694 | 1.12 | 2.7424 | 0.207791085 | 2 | 0.945375526 | 1.02166406 |
| 0.07 | 0.93 | 0.9422 | 1.14 | 2.8278 | 0.199716475 | 2 | 0.936308121 | 1.023643934 |
| 0.08 | 0.92 | 0.9988 | 1.16 | 2.9132 | 0.192245938 | 2 | 0.927634951 | 1.025178335 |
| 0.09 | 0.91 | 1.0409 | 1.18 | 2.9986 | 0.185314131 | 2 | 0.918961781 | 1.026366259 |
| 0.1 | 0.9 | 1.0697 | 1.2 | 3.084 | 0.178864807 | 2 | 0.910288611 | 1.027108712 |
| 0.11 | 0.89 | 1.0866 | 1.22 | 3.1694 | 0.172849286 | 2 | 0.902009676 | 1.027554183 |
| 0.12 | 0.88 | 1.0929 | 1.24 | 3.2548 | 0.167225224 | 2 | 0.893730741 | 1.027653177 |
| 0.13 | 0.87 | 1.0898 | 1.26 | 3.3402 | 0.161955613 | 2 | 0.885451806 | 1.027405693 |

Results show that the HFO-1234ze(Z) and butane compositions of the present invention provide improved CAP and similar energy efficiency relative to HFO-1234ze(Z), at lower costs, for heating using high temperature heat pump systems. Additionally, in many cases, the HFO-1234ze(Z) and butane compositions of the present invention provide improved heating capacity relative to HFO-1234ze(Z), at lower costs. Up to 4 wt % butane can be added to blends of these two components, where the ASHRAE flammability classification will remain 2L. Up to 13 wt % butane can be added to blends of these two components, where the ASHRAE flammability classification will remain 2.

### Example 8: HFO-1234ze(Z)/Isobutane

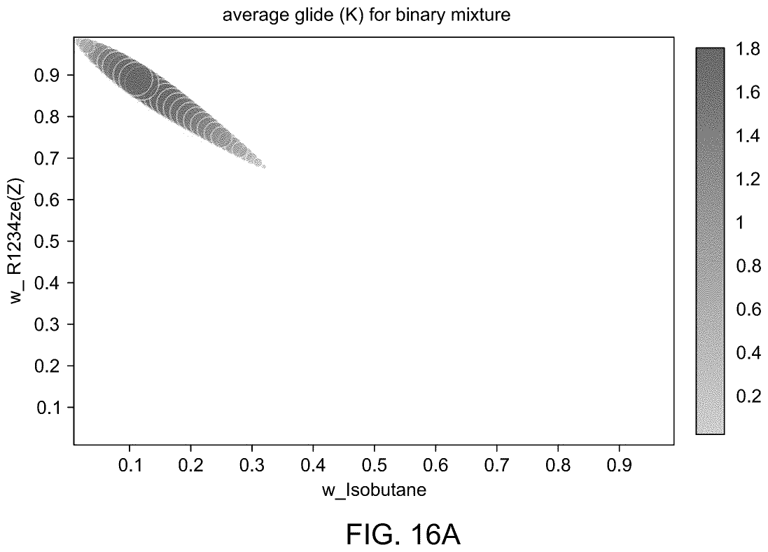

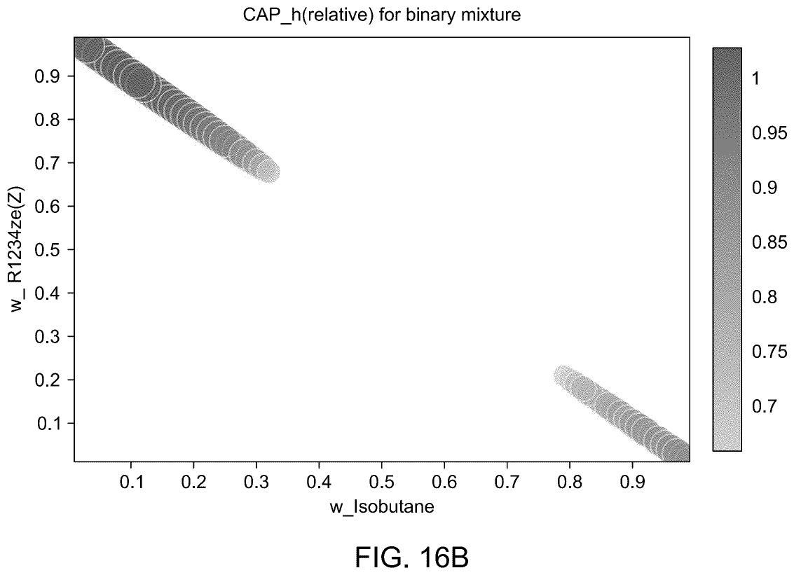

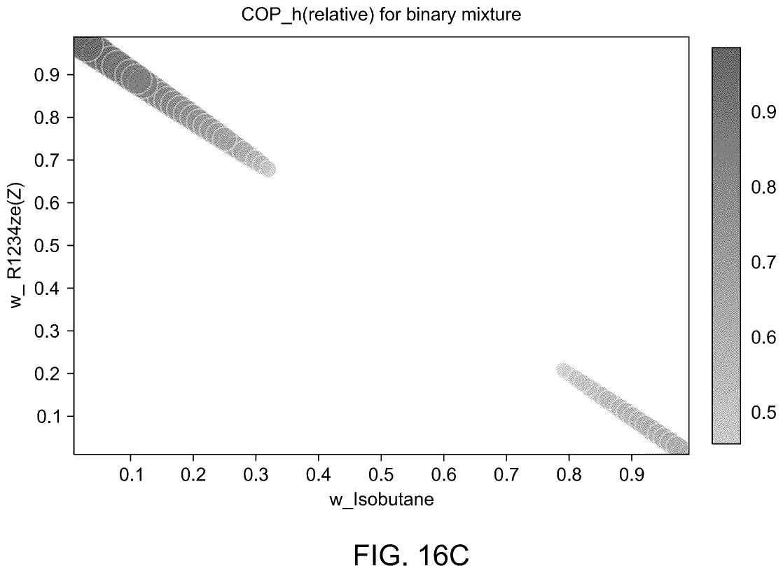

Refrigerant performance has been determined for an exemplary composition of the present invention comprising HFO-1234ze(Z) and isobutane in high temperature heat pump systems as compared to HFO-1234ze(Z). Performance metric and composition property ranges are summarized in Table 15, where the ASHRAE flammability class remains 2L or 2, the average temperature glide is <1 K or less than 2 K and GWP is about 1. Table 16 tabulates several compositions about the compositions of optimal heating efficiency and capacity. FIGS. 16A, 16B and 16C provide graphical representations of the average glide, the CAP for heating relative to the incumbent fluid, and the COP for heating relative to the incumbent fluid, respectively, for a composition according to Example 8.

TABLE 15
High Temperature Heat Pump Conditions, cycle metric performance
and fluid property ranges for 1234zeZ/isobutane in Ex. 8

| | Flammability = 2L | | Flammability = 2 | |
|---|---|---|---|---|
| | MAXIMA | MINIMA | MAXIMA | MINIMA |
| w_R1234ze(Z) | 100 | 96 | 95 | 87 |
| w_isobutane | 4 | 0 | 13 | 5 |
| T° C. (degC.) | 150.12 | 146.8 | 146 | 140 |
| avg glide_h (K) | 1.1 | 0 | 1.8 | 1.24 |
| COP_h (% dev) | 100 | 95.4 | 94.2 | 84.5 |
| CAP_h (% dev) | 102 | 100 | 102.9 | 102.2 |

TABLE 16
High Temperature Heat Pump Conditions, cycle metric performance
and fluid property ranges for 1234zeZ/isobutane in Ex. 8

| | | | | | | ASHRAE | | |
|---|---|---|---|---|---|---|---|---|
| wt-% | | Avg. | | | | Flamma- | COP_h (% | CAP_h (% |
| isobu- | wt-% | Glide | GWP | del_h_comb | LFL | bility | dev from | dev from |
| tane | R1234zeZ | (K) | AR5 | (kcal/g) | (kg/m\hat{ }3) | Class | R1234zeZ | R1234zeZ |
| 0.01 | 0.99 | 0.3198 | 1.02 | 2.3151 | 0.260466616 | 2L | 0.988741376 | 1.006270546 |
| 0.02 | 0.98 | 0.601 | 1.04 | 2.4002 | 0.24792768 | 2L | 0.977308561 | 1.011715198 |
| 0.03 | 0.97 | 0.846 | 1.06 | 2.4853 | 0.23654055 | 2L | 0.965481511 | 1.016417396 |
| 0.04 | 0.96 | 1.0573 | 1.08 | 2.5704 | 0.226153493 | 2L | 0.954048696 | 1.020377143 |
| 0.05 | 0.95 | 1.2373 | 1.1 | 2.6555 | 0.216640302 | 2 | 0.942221646 | 1.02354494 |
| 0.06 | 0.94 | 1.3884 | 1.12 | 2.7406 | 0.207895153 | 2 | 0.930394596 | 1.025970285 |
| 0.07 | 0.93 | 1.5126 | 1.14 | 2.8257 | 0.199828642 | 2 | 0.918567546 | 1.027653177 |
| 0.08 | 0.92 | 1.6122 | 1.16 | 2.9108 | 0.192364725 | 2 | 0.906740496 | 1.028593617 |
| 0.09 | 0.91 | 1.689 | 1.18 | 2.9959 | 0.185438309 | 2 | 0.894519211 | 1.028791604 |
| 0.1 | 0.9 | 1.7451 | 1.2 | 3.081 | 0.178993353 | 2 | 0.882297926 | 1.028197642 |
| 0.11 | 0.89 | 1.7823 | 1.22 | 3.1661 | 0.172981341 | 2 | 0.870076642 | 1.026910724 |
| 0.12 | 0.88 | 1.8022 | 1.24 | 3.2512 | 0.167360068 | 2 | 0.857855357 | 1.024881354 |
| 0.13 | 0.87 | 1.8065 | 1.26 | 3.3363 | 0.162092638 | 2 | 0.845239837 | 1.022109532 |

Results show that the HFO-1234ze(Z) and isobutane compositions of the present invention provide improved CAP and similar energy efficiency relative to HFO-1234ze(Z), at lower costs, for heating using high temperature heat pump systems. Additionally, in many cases, the HFO-1234ze(Z) and isobutane compositions of the present invention provide improved heating capacity relative to HFO-1234ze(Z), at lower costs. Up to 4 wt % isobutane can be added to blends of these two components, where the ASHRAE flammability classification will remain 2L. Up to 13 wt % isobutane can be added to blends of these two components, where the ASHRAE flammability classification will remain 2.

### Example 9: HFO-1234ze(Z)/HFO-1234ze(E)

In the below Tables, “T_condenser” is condenser temperature, “T_evaporator” is evaporator temperature, “COP” is coefficient of performance (analogous to energy efficiency), “CAP” is volumetric heating capacity, Tc is critical temperature, and NBP is nominal boiling point. In Example 9, refrigerant performance has been determined for an exemplary composition of the present invention in high temperature heat pumps as compared to HCFO-1233zd(E). It will be understood by those skilled in the art that the weight percents in the refrigerant performance data are nominal weight fractions. The data are based on the conditions set forth in Table 17.

TABLE 17
High Temp Heat Pump Heating Mode Conditions for Example 9

| | | |
|---|---|---|
| T_condenser | 130° | C. |
| T_evaporator | 40° | C. |

Refrigerant performance has been determined for an exemplary composition of the present invention comprising HFO-1234ze(Z) and HFO-1234ze(E) in high temperature heat pump systems as compared to HCFO-1233zd(E), in cooling mode.

Broadly, for a high temperature heat pump with a condenser operating at 130° C., a composition range of 1% to 36% of HFO-1234ze(E) and 64% to 99% of HFO-1234ze(Z) will have a GWP of about 6, an average glide of about 2.1 K or less, and a heating capacity range of 127.5% to 151% of the heating capacity of HCFO-1233zd(E) evaluated with the same conditions set. Table 18 lists example compositions within the GWP <6 range that have ASHRAE flammability classifications of 2L.

Preferred blend composition ranges for such a high temperature heat pump within a composition range of 15 wt. % to 23 wt. % of HFO-1234ze(E) and 77 wt. % to 85 wt. % of HFO-1234ze(Z) will have a GWP of about 6, an average heat exchanger glide of 1.8 K or less, an ASHRAE flammability classification of 2L, and the minimum and maximum heating capacities relative to HCFO-1233zd(E) evaluated at the same conditions set are 137.2% and 142.6%. For other cycle conditions (especially lower condenser/hot water temperatures), a composition range of 1 wt. % to 48 wt. %, preferably 15 wt. % to 48 wt. %, of HFO-1234ze(E) and 52 wt. % to 99 wt. %, preferably 52 wt. % to 85 wt. %, of HFO-1234ze(Z), which will have a GWP less than 6, a maximum average glide of about 2.1 K, and a heating capacity range of 127.5% to 157.5%, may be suitable.

TABLE 18
High Temperature Heat Pump Cooling Mode Condition, cycle metric performance
and fluid property ranges for 1234zeZ/1234zeE in Ex. 9

| | | | | | Avg. | |
|---|---|---|---|---|---|---|
| wt-% | wt-% | Tc | NBP | GWP | Glide | T_Discharge |
| R1234zeE | R1234zeZ | (° C.) | (° C.) | AR4 | (K) | (° C.) |
| 0.36 | 0.64 | 135.45 | −5.84 | 6 | 2.07 | 149.55 |
| 0.32 | 0.68 | 137.08 | −4.58 | 6 | 2.06 | 149.37 |
| 0.3 | 0.7 | 137.89 | −3.91 | 6 | 2.03 | 149.27 |
| 0.28 | 0.72 | 138.71 | −3.23 | 6 | 1.99 | 149.16 |
| 0.26 | 0.74 | 139.52 | −2.51 | 6 | 1.94 | 149.05 |
| 0.23 | 0.77 | 140.75 | −1.40 | 6 | 1.83 | 148.87 |
| 0.22 | 0.78 | 141.15 | −1.01 | 6 | 1.78 | 148.81 |
| 0.21 | 0.79 | 141.56 | −0.61 | 6 | 1.74 | 148.74 |
| 0.19 | 0.81 | 142.38 | 0.20 | 6 | 1.63 | 148.61 |
| 0.18 | 0.82 | 142.78 | 0.61 | 6 | 1.58 | 148.54 |
| 0.17 | 0.83 | 143.19 | 1.04 | 6 | 1.52 | 148.47 |
| 0.16 | 0.84 | 143.60 | 1.47 | 6 | 1.45 | 148.39 |
| 0.15 | 0.85 | 144.01 | 1.92 | 6 | 1.39 | 148.32 |
| 0.14 | 0.86 | 144.41 | 2.37 | 6 | 1.32 | 148.24 |
| 0.13 | 0.87 | 144.82 | 2.83 | 6 | 1.25 | 148.16 |
| 0.12 | 0.88 | 145.23 | 3.30 | 6 | 1.17 | 148.08 |
| 0.11 | 0.89 | 145.64 | 3.77 | 6 | 1.09 | 148.00 |
| 0.1 | 0.9 | 146.04 | 4.26 | 6 | 1.01 | 147.91 |
| 0.09 | 0.91 | 146.45 | 4.76 | 6 | 0.92 | 147.82 |
| 0.08 | 0.92 | 146.86 | 5.27 | 6 | 0.83 | 147.74 |
| 0.07 | 0.93 | 147.27 | 5.79 | 6 | 0.74 | 147.65 |
| 0.06 | 0.94 | 147.67 | 6.32 | 6 | 0.64 | 147.55 |
| 0.05 | 0.95 | 148.08 | 6.86 | 6 | 0.54 | 147.46 |
| 0.04 | 0.96 | 148.49 | 7.41 | 6 | 0.44 | 147.37 |
| 0.03 | 0.97 | 148.90 | 7.97 | 6 | 0.34 | 147.27 |
| 0.02 | 0.98 | 149.30 | 8.54 | 6 | 0.23 | 147.17 |
| 0.01 | 0.99 | 149.71 | 9.13 | 6 | 0.11 | 147.07 |

| | | | ASHRAE | | |
|---|---|---|---|---|---|
| | | | Flamma- | CAP_h (% | COP_h (% |
| wt-% | wt-% | P_Discharge | bility | dev from | dev from |
| R1234zeE | R1234zeZ | (bar) | Class | R1233zdE) | R1233zdE) |
| 0.36 | 0.64 | 32.87 | 2L | 50.97 | −12.31 |
| 0.32 | 0.68 | 31.83 | 2L | 48.49 | −11.00 |
| 0.3 | 0.7 | 31.33 | 2L | 47.21 | −10.38 |
| 0.28 | 0.72 | 30.83 | 2L | 45.92 | −9.77 |
| 0.26 | 0.74 | 30.33 | 2L | 44.61 | −9.18 |
| 0.23 | 0.77 | 29.61 | 2L | 42.61 | −8.32 |
| 0.22 | 0.78 | 29.37 | 2L | 41.94 | −8.04 |
| 0.21 | 0.79 | 29.13 | 2L | 41.27 | −7.77 |
| 0.19 | 0.81 | 28.67 | 2L | 39.91 | −7.23 |
| 0.18 | 0.82 | 28.44 | 2L | 39.23 | −6.96 |
| 0.17 | 0.83 | 28.21 | 2L | 38.55 | −6.70 |
| 0.16 | 0.84 | 27.98 | 2L | 37.87 | −6.45 |
| 0.15 | 0.85 | 27.75 | 2L | 37.18 | −6.19 |
| 0.14 | 0.86 | 27.53 | 2L | 36.49 | −5.94 |
| 0.13 | 0.87 | 27.30 | 2L | 35.80 | −5.70 |
| 0.12 | 0.88 | 27.08 | 2L | 35.11 | −5.45 |
| 0.11 | 0.89 | 26.86 | 2L | 34.42 | −5.21 |
| 0.1 | 0.9 | 26.64 | 2L | 33.73 | −4.97 |
| 0.09 | 0.91 | 26.42 | 2L | 33.04 | −4.74 |
| 0.08 | 0.92 | 26.21 | 2L | 32.35 | −4.51 |
| 0.07 | 0.93 | 25.99 | 2L | 31.66 | −4.28 |
| 0.06 | 0.94 | 25.78 | 2L | 30.96 | −4.05 |
| 0.05 | 0.95 | 25.57 | 2L | 30.27 | −3.83 |
| 0.04 | 0.96 | 25.36 | 2L | 29.58 | −3.61 |
| 0.03 | 0.97 | 25.15 | 2L | 28.89 | −3.39 |
| 0.02 | 0.98 | 24.94 | 2L | 28.19 | −3.17 |
| 0.01 | 0.99 | 24.73 | 2L | 27.50 | −2.96 |

### Performance Examples for Medium Temperature Refrigeration Systems Comprising HFO Compositions

In the below Tables, “T_condenser” is condenser temperature, “T_evaporator” is evaporator temperature, “COP” is coefficient of performance (analogous to energy efficiency), and “CAP” is volumetric cooling capacity. In Examples 10-12, refrigerant performance has been determined for an exemplary composition of the present invention in medium temperature refrigeration systems as compared to HFO-1234ze(Z). It will be understood by those skilled in the art that the weight percents in the refrigerant performance data are nominal weight fractions. The data are based on the conditions set forth in Table 19.

TABLE 19
Medium Temperature Refrigeration Conditions

| | | |
|---|---|---|
| T_condenser | 40° | C. |
| T_evaporator | −7.0° | C. |
| T_return | 18° | C. |

| | |
|---|---|
| Compressor Efficiency | 0.7 |

### Example 10: HFO-1234ze(Z)/Isobutane

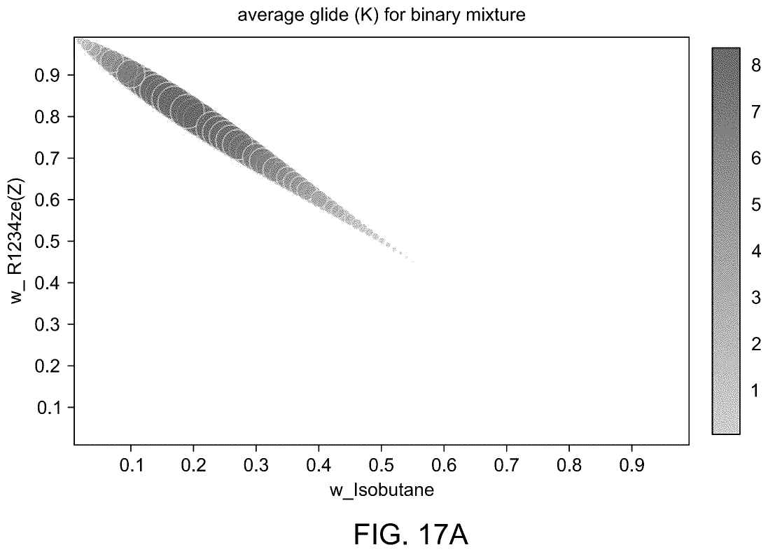

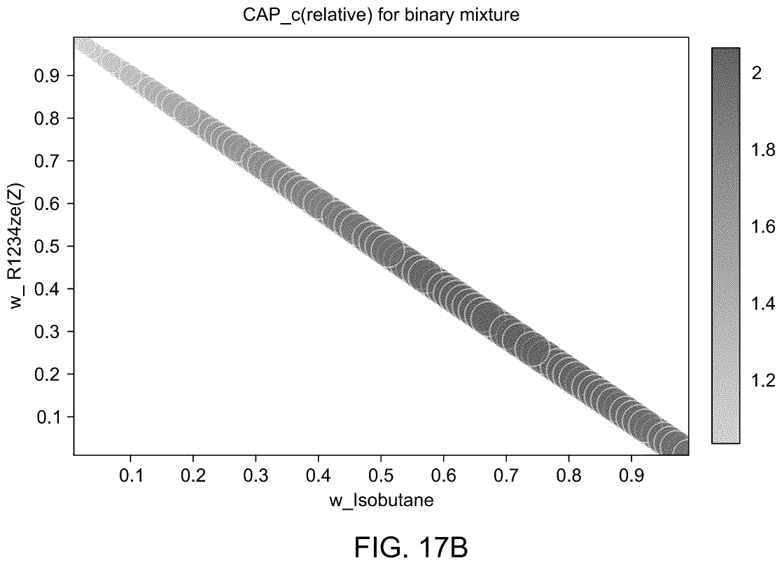

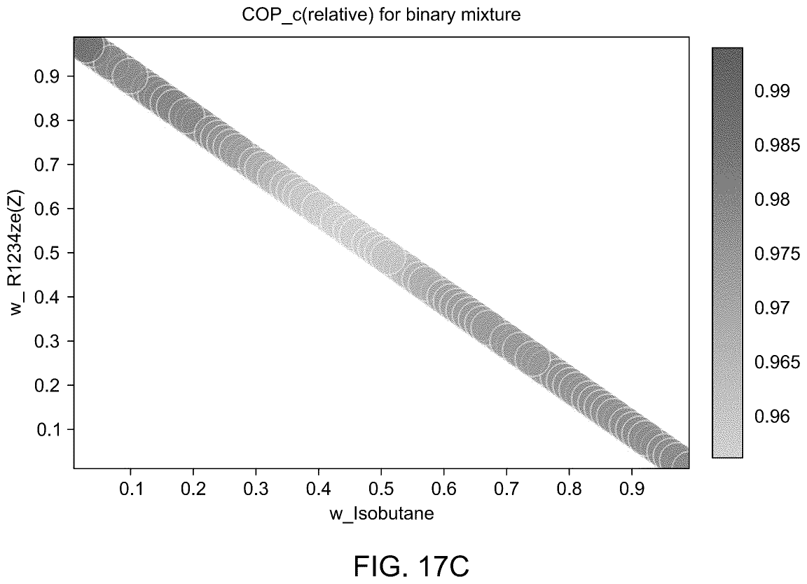

Refrigerant performance has been determined for an exemplary composition of the present invention comprising HFO-1234ze(Z) and isobutane in medium temperature refrigeration systems as compared to HFO-1234ze(Z). Performance metric and composition property ranges are summarized in Table 12, where the ASHRAE flammability class remains 2L or 2, the average temperature glide is <9 K and GWP <2. Table 21 tabulates several compositions about the compositions of optimal cooling efficiency and capacity. FIGS. 17A, 17B and 17C provide graphical representations of the average glide, the CAP for cooling relative to the incumbent fluid, and the COP for cooling relative to the incumbent fluid, respectively, for a composition according to Example 10.

TABLE 20
Medium Temp Refrigeration System, cycle metric performance
and fluid property ranges for 1234zeZ/isobutane in Ex. 10

| | MAXIMA | MINIMA |
|---|---|---|
| w_R1234ze(Z) (nominal weight fraction) | 1 | 0.87 |
| w_isobutane (nominal weight fraction) | 0.13 | 0 |
| T_c (degC.) | 149 | 140 |
| average glide (K) | 7.8 | 0 |
| GWP AR5 | 1.2 | 1 |
| COP_c (% dev from R1234zeZ) | 1 | 0.98 |
| CAP_c (% dev from R1234zeZ) | 1.39 | 1.03 |

TABLE 21
Medium Temp Refrigeration System, cycle metric performance
and fluid property ranges for 1234zeZ/isobutane in Ex. 10

| | | | | | | ASHRAE |
|---|---|---|---|---|---|---|
| wt-% | | Avg. | | COP_c (% | CAP_c (% | Flamma- |
| Isobu- | wt-% | Glide | GWP | dev from | dev from | bility |
| tane | R1234ze(Z) | (K) | AR5 | R1234zeZ) | R1234zeZ) | Class |
| 0 | 1 | 0 | 1 | 1 | 1 | 2L |
| 0.01 | 0.99 | 1.1053 | 1.02 | 0.993980121 | 1.031128544 | 2L |
| 0.02 | 0.98 | 2.0976 | 1.04 | 0.989513463 | 1.06250975 | 2L |
| 0.03 | 0.97 | 2.9873 | 1.06 | 0.985940138 | 1.093668394 | 2L |
| 0.04 | 0.96 | 3.7837 | 1.08 | 0.983260143 | 1.124604476 | 2L |
| 0.05 | 0.95 | 4.495 | 1.1 | 0.981175703 | 1.155317996 | 2 |
| 0.06 | 0.94 | 5.1283 | 1.12 | 0.979984595 | 1.185808954 | 2 |
| 0.07 | 0.93 | 5.6899 | 1.14 | 0.979091263 | 1.215854789 | 2 |
| 0.08 | 0.92 | 6.1855 | 1.16 | 0.978495709 | 1.245455501 | 2 |
| 0.09 | 0.91 | 6.6201 | 1.18 | 0.978197932 | 1.27483365 | 2 |
| 0.1 | 0.9 | 6.998 | 1.2 | 0.978197932 | 1.303544115 | 2 |
| 0.11 | 0.89 | 7.3232 | 1.22 | 0.978495709 | 1.331809456 | 2 |
| 0.12 | 0.88 | 7.5992 | 1.24 | 0.978495709 | 1.359407112 | 2 |
| 0.13 | 0.87 | 7.829 | 1.26 | 0.978793486 | 1.386337083 | 2 |

Results show that the HFO-1234ze(Z) and isobutane compositions of the present invention provide improved CAP or similar energy efficiency relative to HFO-1234ze(Z), at lower costs, in medium temperature refrigeration systems. Additionally, in many cases, the HFO-1234ze(Z) and isobutane compositions of the present invention provide improved cooling capacity relative to HFO-1234ze(Z), at lower costs. It was determined that up to 4 wt % and 13 wt % isobutane can be added to a mixture of these components and maintain an ASHRAE flammability classification of 2L and 2 respectively. The max CAP_c (39% greater than that of R-1234zeZ) in this range is at 13/87 wt-% isobutane/R-1234zeZ and is a class 2.

### Example 11: HFO-1234ze(Z)/Butane

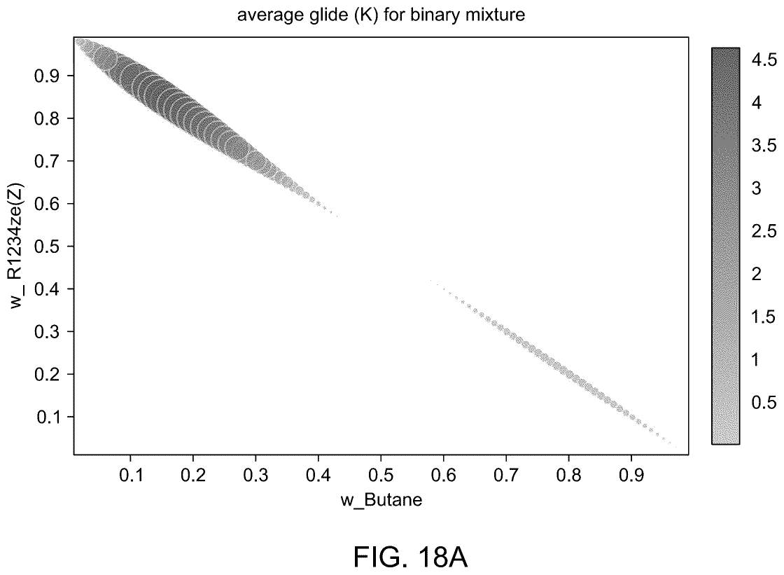

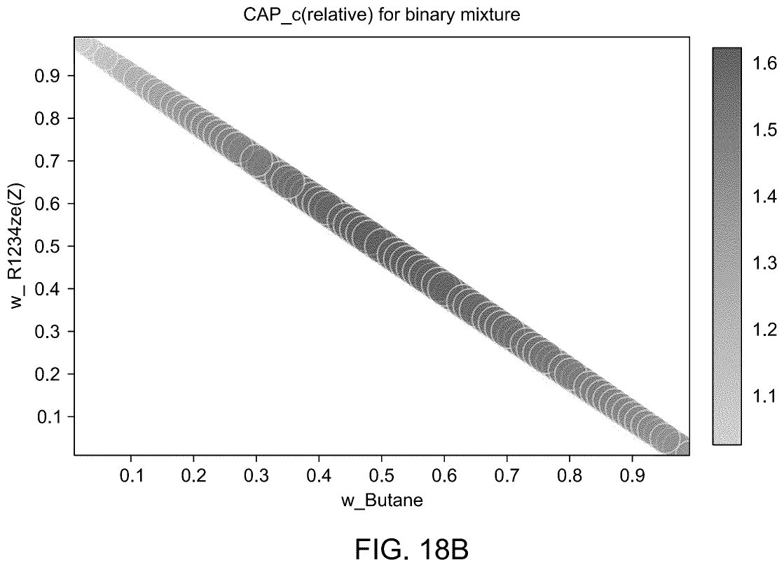

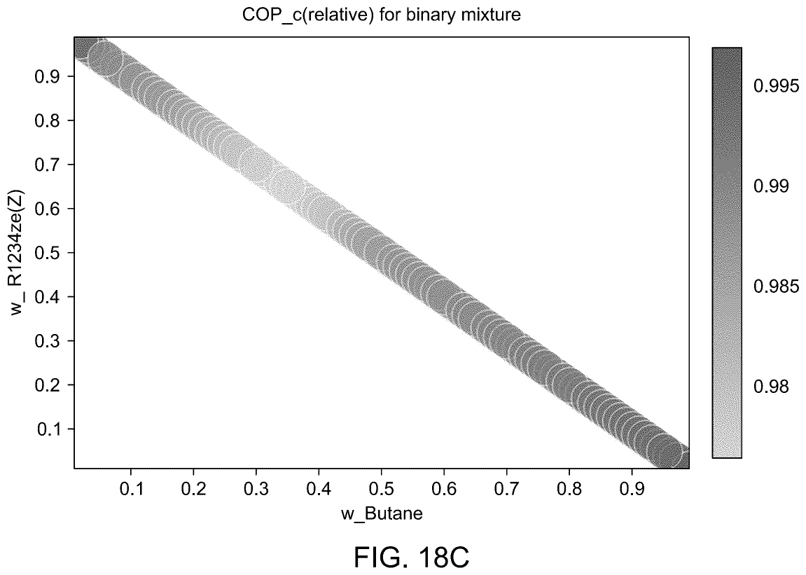

Refrigerant performance has been determined for an exemplary composition of the present invention comprising HFO-1234ze(Z) and butane in medium temperature refrigeration systems as compared to HFO-1234ze(Z). Performance metric and composition property ranges are summarized in Table 22, where the ASHRAE flammability class remains 2L or 2, the average temperature glide is <9 K and GWP <2. Table 23 tabulates several compositions about the compositions of optimal cooling efficiency and capacity. FIGS. 18A, 18B and 18C provide graphical representations of the average glide, the CAP for cooling relative to the incumbent fluid, and the COP for cooling relative to the incumbent fluid, respectively, for a composition according to Example 11.

TABLE 22
Medium Temp Refrigeration System, cycle metric performance
and fluid property ranges for 1234zeZ/butane in Ex. 11

| | MAXIMA | MINIMA |
|---|---|---|
| w_R1234ze(Z) (nominal weight fraction) | 1 | 0.87 |
| w_butane (nominal weight fraction) | 0.13 | 0 |
| T_c (degC.) | 149 | 142 |
| average glide (K) | 4.6 | 0 |
| GWP AR5 | 1 | 1 |
| COP_c (% dev from R1234zeZ) | 1 | 0.99 |
| CAP_c (% dev from R1234zeZ) | 1.29 | 1 |

TABLE 23
Medium Temp Refrigeration System, cycle metric performance
and fluid property ranges for 1234zeZ/butane in Ex. 11

| | | Avg. | | COP_c | CAP_c | ASHRAE |
|---|---|---|---|---|---|---|
| wt-% | wt-% | Glide | GWP | (% dev from | (% dev from | Flammability |
| Butane | R1234ze(Z) | (K) | AR5 | R1234zeZ) | R1234zeZ) | Class |
| 0 | 1 | 0 | 1 | 1 | 1 | 2L |
| 0.01 | 0.99 | 0.7128 | 1.02 | 0.996957892 | 1.025119377 | 2L |
| 0.02 | 0.98 | 1.347 | 1.04 | 0.994277898 | 1.049823731 | 2L |
| 0.03 | 0.97 | 1.9091 | 1.06 | 0.992491235 | 1.074305522 | 2L |
| 0.04 | 0.96 | 2.4046 | 1.08 | 0.991002349 | 1.09834219 | 2L |
| 0.05 | 0.95 | 2.8389 | 1.1 | 0.990109018 | 1.121711173 | 2 |
| 0.06 | 0.94 | 3.2163 | 1.12 | 0.989215686 | 1.144857594 | 2 |
| 0.07 | 0.93 | 3.5411 | 1.14 | 0.988620132 | 1.167113768 | 2 |
| 0.08 | 0.92 | 3.8171 | 1.16 | 0.988322355 | 1.18914738 | 2 |
| 0.09 | 0.91 | 4.0477 | 1.18 | 0.988024578 | 1.210290746 | 2 |
| 0.1 | 0.9 | 4.236 | 1.2 | 0.987726801 | 1.230766426 | 2 |
| 0.11 | 0.89 | 4.3848 | 1.22 | 0.987429023 | 1.250796982 | 2 |
| 0.12 | 0.88 | 4.4971 | 1.24 | 0.987429023 | 1.269937292 | 2 |
| 0.13 | 0.87 | 4.5752 | 1.26 | 0.987131246 | 1.288409917 | 2 |

Results show that the HFO-1234ze(Z) and butane compositions of the present invention provide improved CAP and similar energy efficiency relative to HFO-1234ze(Z), at lower costs, in medium temperature refrigeration systems. Additionally, in many cases, the HFO-1234ze(Z) and butane compositions of the present invention provide improved cooling capacity relative to HFO-1234ze(Z), at lower costs. It was determined that up to 4 wt % and 13 wt % butane can be added to a mixture of these components and maintain an ASHRAE flammability classification of 2L and 2 respectively. The max CAP_c (29% greater than that of R-1234zeZ) in this range is at 13/87 wt-% butane/R-1234zeZ and is a class 2.

### Example 12: HFO-1234ze(Z)/Pentane

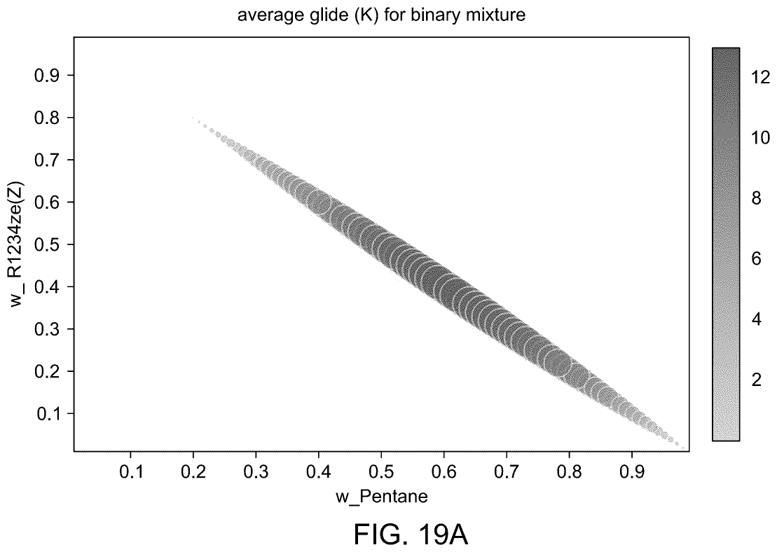

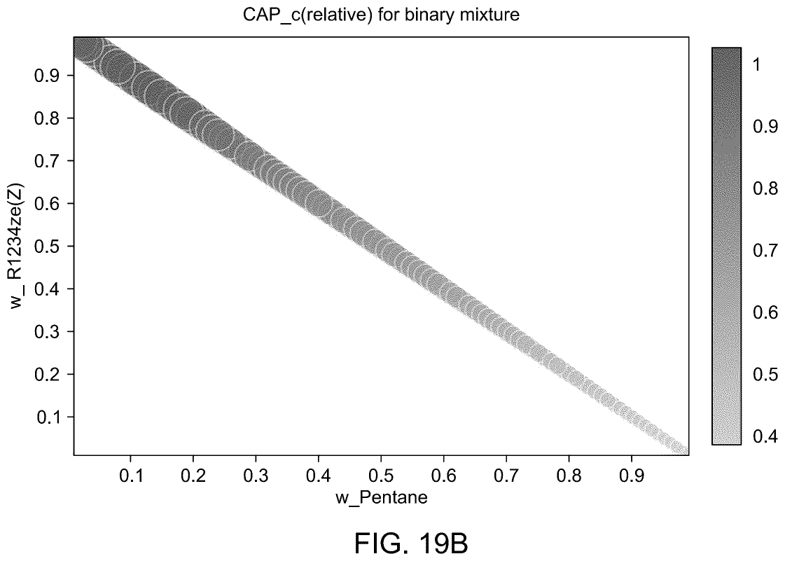

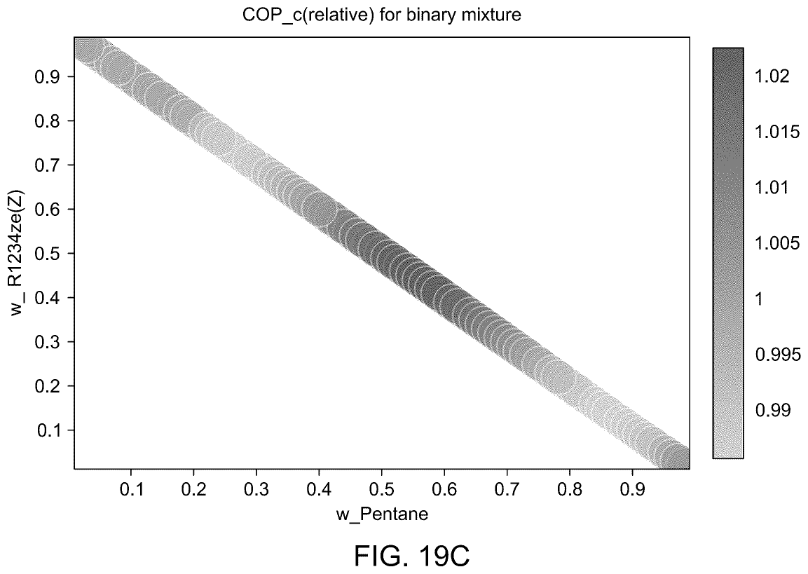

Refrigerant performance has been determined for an exemplary composition of the present invention comprising HFO-1234ze(Z) and butane in medium temperature refrigeration systems as compared to HFO-1234ze(Z). Performance metric and composition property ranges are summarized in Table 24, where the ASHRAE flammability class remains 2L or 2, the average temperature glide is <1 K and GWP <3. Table 25 tabulates several compositions about the compositions of optimal cooling efficiency and capacity. FIGS. 19A, 19B and 19C provide graphical representations of the average glide, the CAP for cooling relative to the incumbent fluid, and the COP for cooling relative to the incumbent fluid, respectively, for a composition according to Example 12.

TABLE 24
Medium Temp Refrigeration System, cycle metric performance
and fluid property ranges for 1234zeZ/pentane in Ex. 12

| | MAXIMA | MINIMA |
|---|---|---|
| w_R1234ze(Z) (nominal weight fraction) | 1 | 0.87 |
| w_pentane (nominal weight fraction) | 0.13 | 0 |
| T_c (degC.) | 150 | 149 |
| condenser glide (K) | 0.1 | 0 |
| GWP AR5 | 2.3 | 1 |
| COP_c (% dev from R1234zeZ) | 1 | 1 |
| CAP_c (% dev from R1234zeZ) | 1.03 | 1 |

TABLE 25
Medium Temp Refrigeration System, cycle metric performance
and fluid property ranges for 1234zeZ/pentane in Ex. 12

| | | | | | | ASHRAE |
|---|---|---|---|---|---|---|
| | | Avg. | | COP_c (% | CAP_c (% | Flamma- |
| wt-% | wt-% | Glide | GWP | dev from | dev from | bility |
| Pentane | R1234ze(Z) | (K) | AR5 | R1234zeZ) | R1234zeZ) | Class |
| 0 | 1 | 0 | 1 | 1 | 1 | 2L |
| 0.01 | 0.99 | 0.0541 | 1.1 | 0.999637886 | 1.005533944 | 2L |
| 0.02 | 0.98 | 0.0875 | 1.2 | 0.999340109 | 1.010430303 | 2L |
| 0.03 | 0.97 | 0.1039 | 1.3 | 0.999042332 | 1.014881537 | 2L |
| 0.04 | 0.96 | 0.1065 | 1.4 | 0.998744555 | 1.018442525 | 2L |
| 0.05 | 0.95 | 0.0987 | 1.5 | 0.998446778 | 1.02155839 | 2 |
| 0.06 | 0.94 | 0.0836 | 1.6 | 0.998149001 | 1.02422913 | 2 |
| 0.07 | 0.93 | 0.0645 | 1.7 | 0.998149001 | 1.026009624 | 2 |
| 0.08 | 0.92 | 0.0445 | 1.8 | 0.998149001 | 1.027567557 | 2 |
| 0.09 | 0.91 | 0.027 | 1.9 | 0.998149001 | 1.028457804 | 2 |
| 0.1 | 0.9 | 0.0152 | 2 | 0.998149001 | 1.028902927 | 2 |
| 0.11 | 0.89 | 0.0127 | 2.1 | 0.998149001 | 1.028680365 | 2 |
| 0.12 | 0.88 | 0.0232 | 2.2 | 0.998446778 | 1.02801268 | 2 |
| 0.13 | 0.87 | 0.0507 | 2.3 | 0.998446778 | 1.02667731 | 2 |

Results show that the HFO-1234ze(Z) and pentane compositions of the present invention provide improved CAP and similar energy efficiency relative to HFO-1234ze(Z), at lower costs, in medium temperature refrigeration systems. Additionally, in many cases, the HFO-1234ze(Z) and pentane compositions of the present invention provide improved cooling capacity relative to HFO-1234ze(Z), at lower costs. It was determined that up to 4 wt % and 13 wt % pentane can be added to a mixture of these components and maintain an ASHRAE flammability classification of 2L and 2 respectively. The max CAP_c (3% greater than that of R-1234zeZ) in this range is at 13/87 wt-% Pentane/R-1234zeZ and is a class 2.

### Performance Examples for High Temperature

### Heat Pump Systems Comprising Hydrocarbon Compositions

### Example 13: Isobutene/HFO-1234ze(Z)

In Example 13, refrigerant performance has been determined for an exemplary composition of the present invention in high temperature heat pumps as compared to isobutene. It will be understood by those skilled in the art that the weight percents in the refrigerant performance data are nominal weight fractions. The data are based on the conditions set forth in Table 10. Table 26 tabulates several compositions about the compositions of optimal cooling efficiency and capacity, where the average temperature glide is <4 K and GWP˜1.

TABLE 26
High Temperature Heat Pump Cooling Mode Condition, cycle metric performance
and fluid property ranges for Isobutene/1234zeZ in Ex. 13

| | | average | | | |
|---|---|---|---|---|---|
| | | glide | GWP | del_h_comb | LFL |
| w_Isobutene | w_R1234ze(Z) | (K) | AR5 | (kcal/g) | (kg/m\hat{ }3) |
| 0.99 | 0.01 | 0.0104 | 1 | 10.641436 | 0.043365792 |
| 0.94 | 0.06 | 0.0502 | 1 | 10.216616 | 0.045291666 |
| 0.89 | 0.11 | 0.0708 | 1 | 9.791796 | 0.047396546 |
| 0.84 | 0.16 | 0.0746 | 1 | 9.366976 | 0.049706605 |
| 0.79 | 0.21 | 0.0653 | 1 | 8.942156 | 0.052253382 |
| 0.74 | 0.26 | 0.0474 | 1 | 8.517336 | 0.055075226 |
| 0.69 | 0.31 | 0.0273 | 1 | 8.092516 | 0.058219245 |
| 0.64 | 0.36 | 0.0128 | 1 | 7.667696 | 0.061743954 |
| 0.59 | 0.41 | 0.0134 | 1 | 7.242876 | 0.065722953 |
| 0.54 | 0.46 | 0.0394 | 1 | 6.818056 | 0.070250119 |
| 0.49 | 0.51 | 0.1006 | 1 | 6.393236 | 0.07544711 |
| 0.44 | 0.56 | 0.2034 | 1 | 5.968416 | 0.081474459 |
| 0.39 | 0.61 | 0.3482 | 1 | 5.543596 | 0.088548455 |
| 0.34 | 0.66 | 0.5279 | 1 | 5.118776 | 0.096967641 |
| 0.29 | 0.71 | 0.7275 | 1 | 4.693956 | 0.107156036 |
| 0.24 | 0.76 | 0.9235 | 1 | 4.269136 | 0.119736786 |
| 0.19 | 0.81 | 1.0803 | 1 | 3.844316 | 0.135664611 |
| 0.14 | 0.86 | 1.1441 | 1 | 3.419496 | 0.156480176 |

| | | ASHRAE | | |
|---|---|---|---|---|
| | | flammability | COP_h | CAP_h |
| w_Isobutene | w_R1234ze(Z) | class | (relative) | (relative) |
| 0.99 | 0.01 | 3 | 0.998117287 | 0.999398407 |
| 0.94 | 0.06 | 3 | 0.987418397 | 0.995726878 |
| 0.89 | 0.11 | 3 | 0.976719507 | 0.99114778 |
| 0.84 | 0.16 | 3 | 0.96557483 | 0.98561986 |
| 0.79 | 0.21 | 3 | 0.954430153 | 0.979225624 |
| 0.74 | 0.26 | 3 | 0.943731263 | 0.972006326 |
| 0.69 | 0.31 | 3 | 0.93347816 | 0.964126978 |
| 0.64 | 0.36 | 3 | 0.924116631 | 0.955835098 |
| 0.59 | 0.41 | 3 | 0.91653825 | 0.947460712 |
| 0.54 | 0.46 | 3 | 0.911188805 | 0.939375098 |
| 0.49 | 0.51 | 3 | 0.90895987 | 0.931990787 |
| 0.44 | 0.56 | 3 | 0.910743018 | 0.925596551 |
| 0.39 | 0.61 | 3 | 0.917429825 | 0.920357403 |
| 0.34 | 0.66 | 3 | 0.929020289 | 0.916025824 |
| 0.29 | 0.71 | 3 | 0.945514411 | 0.911983017 |
| 0.24 | 0.76 | 3 | 0.967803765 | 0.90728016 |
| 0.19 | 0.81 | 3 | 0.994550991 | 0.900762165 |
| 0.14 | 0.86 | 3 | 1.025756087 | 0.890985172 |

Results show that the HFO-1234ze(Z) and isobutene compositions of the present invention provide similar CAP and similar energy efficiency relative to isobutene, for cooling using high temperature heat pump systems. Additionally, in many cases, the HFO-1234ze(Z) and isobutene compositions of the present invention provide similar cooling capacity relative to isobutene. Adding 73 wt % of R-1234zeZ to isobutene reduces the heat of combustion to below 4.54 kcal/g (8169 Btu/lbm), which is an 2L requirement, while the heating capacity remains within 10% of the CAP of isobutene.

### Example 14: Pentane/HFO-1234ze(Z)

In Example 14, refrigerant performance has been determined for an exemplary composition of the present invention in high temperature heat pumps as compared to pentane. It will be understood by those skilled in the art that the weight percents in the refrigerant performance data are nominal weight fractions. The data are based on the conditions set forth in Table 10. Table 27 tabulates several compositions about the compositions of optimal cooling efficiency and capacity, where the average temperature glide is <4 K and GWP˜1.

TABLE 27
High Temperature Heat Pump Cooling Mode Condition, cycle metric performance
and fluid property ranges for Pentane/1234zeZ in Ex. 14

| | | average | | | |
|---|---|---|---|---|---|
| | | glide | GWP | del_h_comb | LFL |
| w_Pentane | w_R1234ze(Z) | (K) | AR5 | (kcal/g) | (kg/m\hat{ }3) |
| 0.99 | 0.01 | 0.4358 | 10.9 | 10.6153 | 0.049481646 |
| 0.94 | 0.06 | 2.3911 | 10.4 | 10.1918 | 0.051618427 |
| 0.89 | 0.11 | 3.9966 | 9.9 | 9.7683 | 0.053948083 |
| 0.84 | 0.16 | 5.2813 | 9.4 | 9.3448 | 0.056497964 |
| 0.79 | 0.21 | 6.2709 | 8.9 | 8.9213 | 0.059300845 |
| 0.74 | 0.26 | 6.987 | 8.4 | 8.4978 | 0.062396347 |
| 0.69 | 0.31 | 7.4473 | 7.9 | 8.0743 | 0.065832818 |
| 0.64 | 0.36 | 7.6653 | 7.4 | 7.6508 | 0.069669878 |
| 0.59 | 0.41 | 7.6497 | 6.9 | 7.2273 | 0.073981907 |
| 0.54 | 0.46 | 7.405 | 6.4 | 6.8038 | 0.078862913 |
| 0.49 | 0.51 | 6.9309 | 5.9 | 6.3803 | 0.084433469 |
| 0.44 | 0.56 | 6.2245 | 5.4 | 5.9568 | 0.0908508 |
| 0.39 | 0.61 | 5.2855 | 4.9 | 5.5333 | 0.098323865 |
| 0.34 | 0.66 | 4.1347 | 4.4 | 5.1098 | 0.107136537 |
| 0.29 | 0.71 | 2.8518 | 3.9 | 4.6863 | 0.117684483 |
| 0.24 | 0.76 | 1.6199 | 3.4 | 4.2628 | 0.130536202 |
| 0.19 | 0.81 | 0.6956 | 2.9 | 3.8393 | 0.146538973 |
| 0.14 | 0.86 | 0.1979 | 2.4 | 3.4158 | 0.167013602 |

| | | ASHRAE | | |
|---|---|---|---|---|
| | | flammability | COP_h | CAP_h |
| w_Pentane | w_R1234ze(Z) | class | (relative) | (relative) |
| 0.99 | 0.01 | 3 | 1.001012699 | 1.011255715 |
| 0.94 | 0.06 | 3 | 1.004716039 | 1.066325138 |
| 0.89 | 0.11 | 3 | 1.005827041 | 1.120236313 |
| 0.84 | 0.16 | 3 | 1.004716039 | 1.173410422 |
| 0.79 | 0.21 | 3 | 1.001383033 | 1.22637394 |
| 0.74 | 0.26 | 3 | 0.996198358 | 1.279758638 |
| 0.69 | 0.31 | 3 | 0.989532347 | 1.333880404 |
| 0.64 | 0.36 | 3 | 0.981384999 | 1.389265713 |
| 0.59 | 0.41 | 3 | 0.97212665 | 1.446125155 |
| 0.54 | 0.46 | 3 | 0.961386965 | 1.504774617 |
| 0.49 | 0.51 | 3 | 0.949536279 | 1.564898213 |
| 0.44 | 0.56 | 3 | 0.936944924 | 1.626180057 |
| 0.39 | 0.61 | 3 | 0.923983235 | 1.687356605 |
| 0.34 | 0.66 | 3 | 0.910651213 | 1.747480201 |
| 0.29 | 0.71 | 3 | 0.898800526 | 1.806024368 |
| 0.24 | 0.76 | 3 | 0.890282845 | 1.863410287 |
| 0.19 | 0.81 | 3 | 0.886949839 | 1.919743253 |
| 0.14 | 0.86 | 3 | 0.889912511 | 1.975339152 |

Results show that the HFO-1234ze(Z) and pentane compositions of the present invention provide improved CAP and similar energy efficiency relative to pentane, for cooling using high temperature heat pump systems. Additionally, in many cases, the HFO-1234ze(Z) and pentane compositions of the present invention provide improved cooling capacity relative to pentane. Adding 73 wt-% of R-1234zeZ to pentane reduces the heat of combustion to below 4.54 kcal/g (8169 Btu/lbm), which is an 2L requirement, while the heating capacity is increased to 83% of the CAP of pentane.

### Example 15: Isobutane/HFO-1234ze(Z)

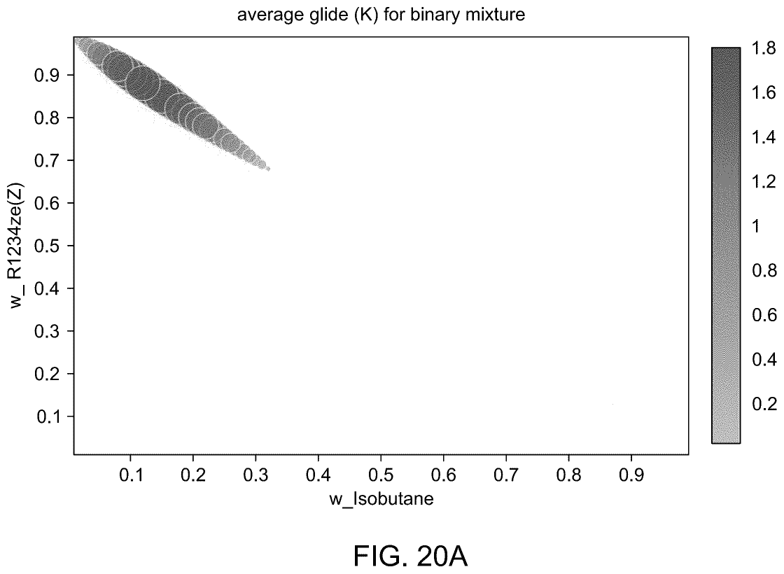

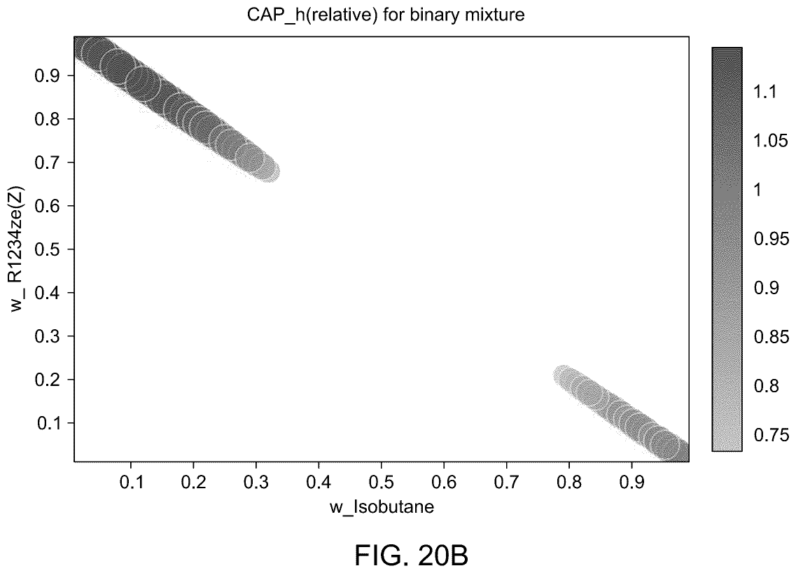

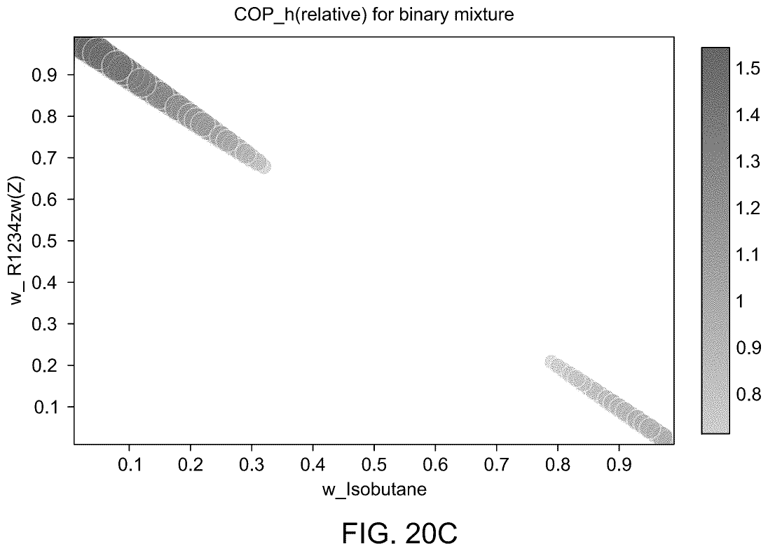

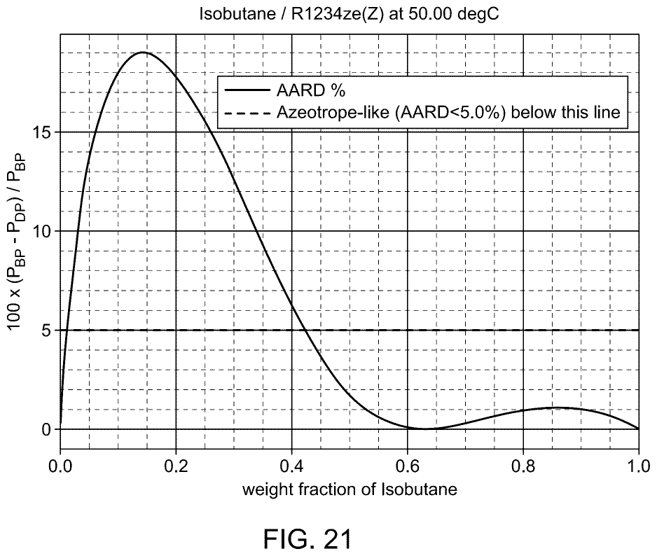

Refrigerant performance has been determined for an exemplary composition of the present invention comprising isobutane and HFO-1234ze(Z) in high temperature heat pumps as compared to isobutane. It will be understood by those skilled in the art that the weight percents in the refrigerant performance data are nominal weight fractions. The data are based on the conditions set forth in Table 10. Table 28 tabulates several compositions about the compositions of optimal heating efficiency and capacity, where the average temperature glide is <1 K and GWP˜3 or less. FIGS. 20A, 20B and 20C provide graphical representations of the average glide, the CAP for heating relative to the incumbent fluid, and the COP for heating relative to the incumbent fluid, respectively, for a composition according to Example 15. FIG. 21 shows near azeotropic behavior from 43 to 100 wt-% isobutane, with an azeotrope at 62 wt-% isobutane at 50° C. for compositions according to Example 15.

TABLE 28
High Temperature Heat Pump Heating Mode Conditions, cycle metric performance
and fluid property ranges for Isobutane/1234zeZ in Ex. 15

| | | average | | del_h_{—} | | | |
|---|---|---|---|---|---|---|---|
| w_Iso- | w_{—} | glide | GWP | comb | del_h_comb | | LFL |
| butane | R1234ze(Z) | (K) | AR5 | (kcal/g) | (relative) | LFL (kg/m\hat{ }3) | (relative) |
| 0.99 | 0.01 | 0.0178 | 2.98 | 10.6549 | 0.99207635 | 0.043729249 | 1.016959276 |
| 0.96 | 0.04 | 0.0607 | 2.92 | 10.3996 | 0.9683054 | 0.044872272 | 1.043541206 |
| 0.93 | 0.07 | 0.0886 | 2.86 | 10.1443 | 0.944534451 | 0.046076653 | 1.071550065 |
| 0.9 | 0.1 | 0.1027 | 2.8 | 9.889 | 0.920763501 | 0.047347468 | 1.101103918 |
| 0.87 | 0.13 | 0.1041 | 2.74 | 9.6337 | 0.896992551 | 0.048690372 | 1.132334227 |
| 0.84 | 0.16 | 0.0939 | 2.68 | 9.3784 | 0.873221601 | 0.050111676 | 1.165387803 |
| 0.81 | 0.19 | 0.0715 | 2.62 | 9.1231 | 0.849450652 | 0.051618452 | 1.200429113 |
| 0.32 | 0.68 | 0.2875 | 1.64 | 4.9532 | 0.461191806 | 0.10143475 | 2.358947668 |
| 0.29 | 0.71 | 0.7356 | 1.58 | 4.6979 | 0.437420857 | 0.107804596 | 2.507083618 |
| 0.26 | 0.74 | 1.0259 | 1.52 | 4.4426 | 0.413649907 | 0.115028067 | 2.675071336 |
| 0.23 | 0.77 | 1.2884 | 1.46 | 4.1873 | 0.389878957 | 0.123289081 | 2.867187926 |
| 0.2 | 0.8 | 1.5187 | 1.4 | 3.932 | 0.366108007 | 0.132828472 | 3.089034244 |
| 0.17 | 0.83 | 1.6973 | 1.34 | 3.6767 | 0.342337058 | 0.143967868 | 3.348089963 |
| 0.14 | 0.86 | 1.7967 | 1.28 | 3.4214 | 0.318566108 | 0.157146661 | 3.654573509 |
| 0.11 | 0.89 | 1.7823 | 1.22 | 3.1661 | 0.294795158 | 0.172981341 | 4.022821893 |
| 0.08 | 0.92 | 1.6122 | 1.16 | 2.9108 | 0.271024209 | 0.192364725 | 4.473598248 |
| 0.05 | 0.95 | 1.2373 | 1.1 | 2.6555 | 0.247253259 | 0.216640302 | 5.038146569 |
| 0.02 | 0.98 | 0.601 | 1.04 | 2.4002 | 0.223482309 | 0.24792768 | 5.76575999 |

| | | ASHRAE | | |
|---|---|---|---|---|
| | | flamma- | | |
| w_Iso- | w_{—} | bility | COP_h | CAP_h |
| butane | R1234ze(Z) | class | (relative) | (relative) |
| 0.99 | 0.01 | 3 | 0.992910296 | 0.995422824 |
| 0.96 | 0.04 | 3 | 0.969475146 | 0.979897729 |
| 0.93 | 0.07 | 3 | 0.975642291 | 0.906181056 |
| 0.9 | 0.1 | 3 | 0.915204273 | 0.938717691 |
| 0.87 | 0.13 | 3 | 0.881284977 | 0.910640392 |
| 0.84 | 0.16 | 3 | 0.846132252 | 0.858119327 |
| 0.81 | 0.19 | 3 | 0.782610662 | 0.819031323 |
| 0.32 | 0.68 | 3 | 0.778910375 | 0.785008243 |
| 0.29 | 0.71 | 3 | 0.955907428 | 0.947746469 |
| 0.26 | 0.74 | 3 | 1.042864168 | 1.012984899 |
| 0.23 | 0.77 | 3 | 1.115019761 | 1.058128791 |
| 0.2 | 0.8 | 3 | 1.180391495 | 1.091656389 |
| 0.17 | 0.83 | 3 | 1.242679656 | 1.116265316 |
| 0.14 | 0.86 | 3 | 1.303117674 | 1.133001588 |
| 0.11 | 0.89 | 2 | 1.361088834 | 1.142195527 |
| 0.08 | 0.92 | 2 | 1.41844328 | 1.144067347 |
| 0.05 | 0.95 | 2 | 1.473947582 | 1.138451887 |
| 0.02 | 0.98 | 2L | 1.52883517 | 1.125294094 |

Results show that the HFO-1234ze(Z) and isobutane compositions of the present invention provide similar CAP and similar energy efficiency relative to isobutane, for heating using high temperature heat pump systems. Additionally, in many cases, the HFO-1234ze(Z) and isobutane compositions of the present invention provide similar heating capacity relative to isobutane. Adding 73 wt % of HFO-1234ze(Z) to isobutane reduces the heat of combustion to below 4.54 kcal/g (8169 Btu/lbm), which is an 2L requirement, while the heating capacity remains similar to the CAP of isobutane.

### Example 16: Butane/HFO-1234ze(Z)

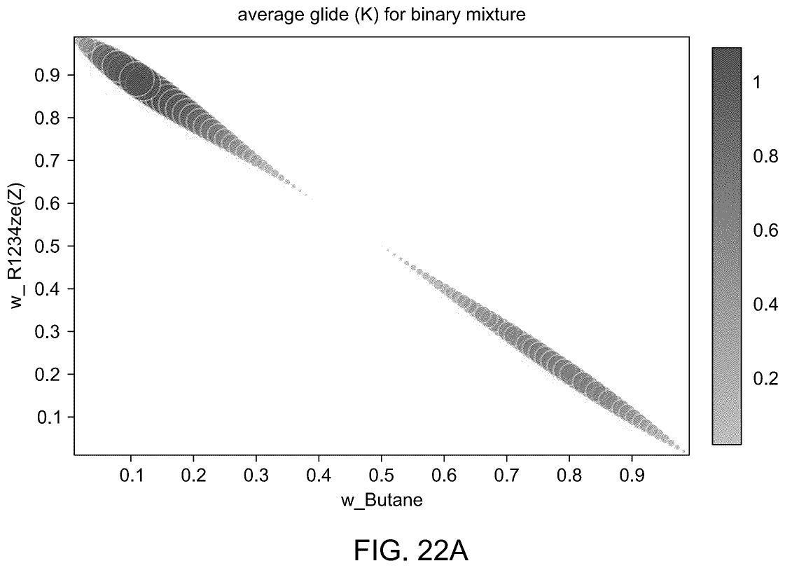

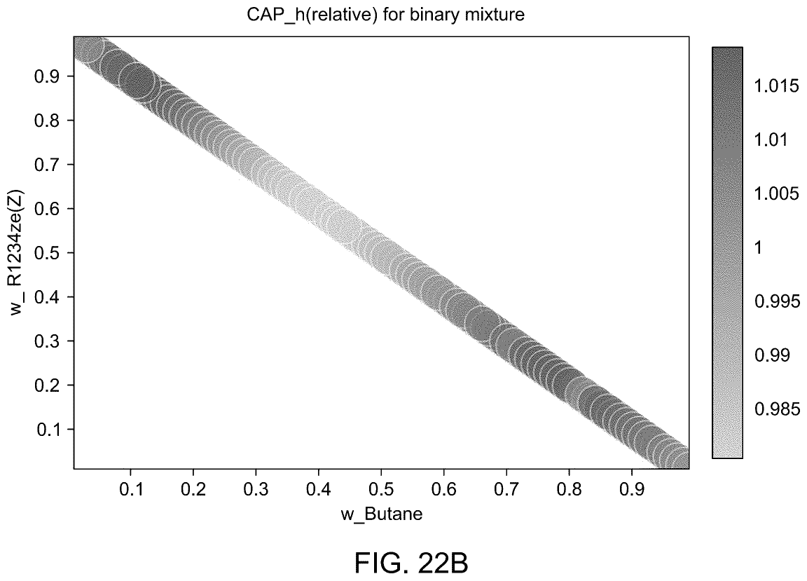

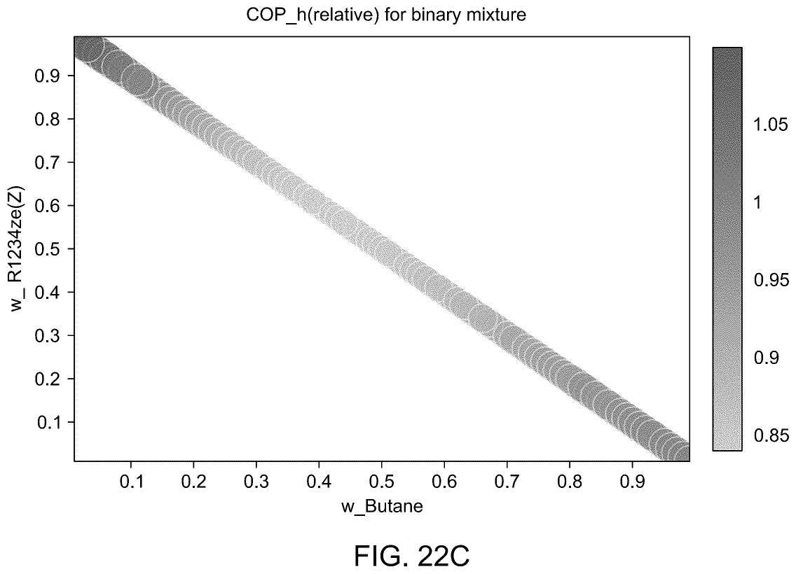

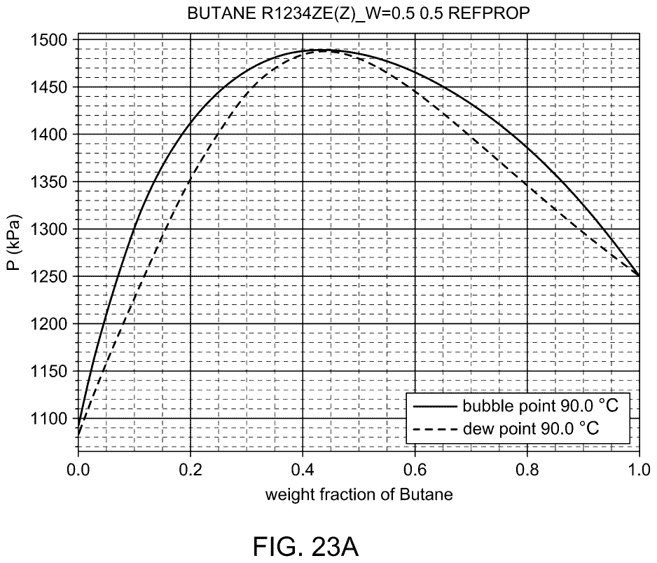

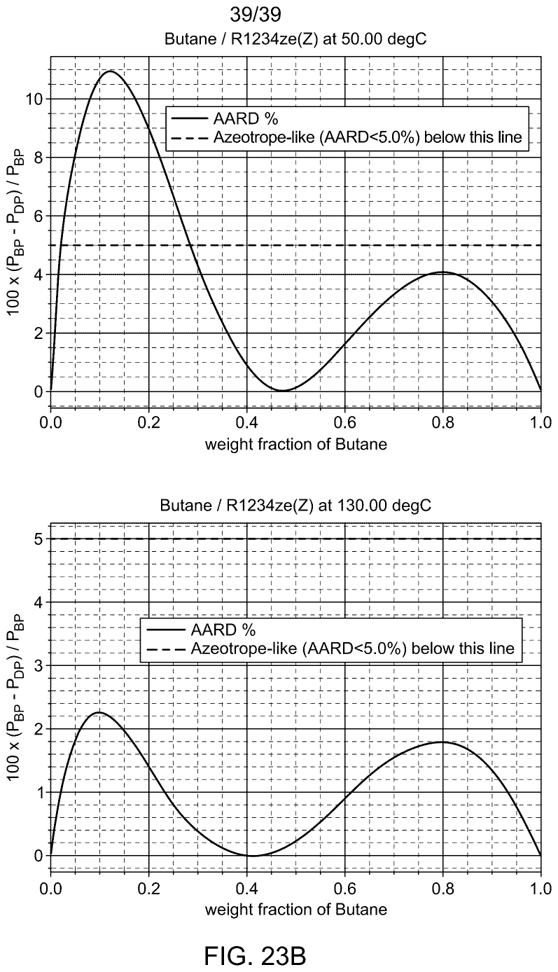

Refrigerant performance has been determined for an exemplary composition of the present invention comprising butane and HFO-1234ze(Z) in high temperature heat pumps as compared to butane. It will be understood by those skilled in the art that the weight percents in the refrigerant performance data are nominal weight fractions. The data are based on the conditions set forth in Table 10. Table 29 tabulates several compositions about the compositions of optimal heating efficiency and capacity, where the average temperature glide is <˜1 K and GWP˜3 or less. FIGS. 22A, 22B and 22C provide graphical representations of the average glide, the CAP for heating relative to the incumbent fluid, and the COP for heating relative to the incumbent fluid, respectively, for a composition according to Example 16. FIGS. 23A and 23B show an azeotrope at 44 wt-% butane and 90° C. as well as near azeotropic behavior over the majority of the composition range, from 28 to 100 wt-% butane at 50° C. and over the whole composition range at the condenser heating temperature of 130° C. for compositions according to Example 16.

TABLE 29
High Temperature Heat Pump Heating Mode Conditions, cycle metric performance
and fluid property ranges for Butane/1234zeZ in Ex. 16

| | | average | | del_h_{—} | | | |
|---|---|---|---|---|---|---|---|
| w_{—} | w_{—} | glide | GWP | comb | del_h_comb | LFL | LFL |
| Butane | R1234ze(Z) | (K) | AR5 | (kcal/g) | (relative) | (kg/m\hat{ }3) | (relative) |
| 0.99 | 0.01 | 0.0657 | 2.98 | 10.6846 | 0.992070566 | 0.04365337 | 1.015194653 |
| 0.94 | 0.06 | 0.344 | 2.88 | 10.2576 | 0.952423398 | 0.045589495 | 1.060220807 |
| 0.89 | 0.11 | 0.5398 | 2.78 | 9.8306 | 0.91277623 | 0.047705333 | 1.109426347 |
| 0.84 | 0.16 | 0.6567 | 2.68 | 9.4036 | 0.873129062 | 0.050027124 | 1.163421499 |
| 0.79 | 0.21 | 0.6998 | 2.58 | 8.9766 | 0.833481894 | 0.052586479 | 1.222941362 |
| 0.74 | 0.26 | 0.6763 | 2.48 | 8.5496 | 0.793834726 | 0.055421822 | 1.288879576 |
| 0.69 | 0.31 | 0.5959 | 2.38 | 8.1226 | 0.754187558 | 0.05858034 | 1.362333497 |
| 0.64 | 0.36 | 0.4721 | 2.28 | 7.6956 | 0.71454039 | 0.062120627 | 1.444665754 |
| 0.59 | 0.41 | 0.323 | 2.18 | 7.2686 | 0.674893222 | 0.066116351 | 1.537589564 |
| 0.54 | 0.46 | 0.1742 | 2.08 | 6.8416 | 0.635246054 | 0.070661437 | 1.643289236 |
| 0.49 | 0.51 | 0.0599 | 1.98 | 6.4146 | 0.595598886 | 0.075877544 | 1.764594047 |
| 0.44 | 0.56 | 0.019 | 1.88 | 5.9876 | 0.555951718 | 0.081925117 | 1.905235268 |
| 0.39 | 0.61 | 0.0773 | 1.78 | 5.5606 | 0.51630455 | 0.08902018 | 2.070236744 |
| 0.34 | 0.66 | 0.23 | 1.68 | 5.1336 | 0.476657382 | 0.09746069 | 2.26652768 |
| 0.29 | 0.71 | 0.4486 | 1.58 | 4.7066 | 0.437010214 | 0.107669443 | 2.503940544 |
| 0.24 | 0.76 | 0.6967 | 1.48 | 4.2796 | 0.397363045 | 0.120267109 | 2.796909521 |
| 0.19 | 0.81 | 0.9291 | 1.38 | 3.8526 | 0.357715877 | 0.136203331 | 3.167519319 |
| 0.14 | 0.86 | 1.0783 | 1.28 | 3.4256 | 0.318068709 | 0.157007969 | 3.651348122 |
| 0.09 | 0.91 | 1.0409 | 1.18 | 2.9986 | 0.278421541 | 0.185314131 | 4.309630954 |
| 0.04 | 0.96 | 0.6691 | 1.08 | 2.5716 | 0.238774373 | 0.226071381 | 5.257473982 |

| | | ASHRAE | | |
|---|---|---|---|---|
| | | flamma- | | |
| w_{—} | w_{—} | bility | COP_h | CAP_h |
| Butane | R1234ze(Z) | class | (relative) | (relative) |
| 0.99 | 0.01 | 3 | 0.997749373 | 1.001572304 |
| 0.94 | 0.06 | 3 | 0.98593392 | 1.008441462 |
| 0.89 | 0.11 | 3 | 0.972805639 | 1.013446134 |
| 0.84 | 0.16 | 3 | 0.958364529 | 1.016439125 |
| 0.79 | 0.21 | 3 | 0.943048201 | 1.017420433 |
| 0.74 | 0.26 | 3 | 0.926419045 | 1.016242863 |
| 0.69 | 0.31 | 3 | 0.90891467 | 1.01295548 |
| 0.64 | 0.36 | 3 | 0.891410295 | 1.007754546 |
| 0.59 | 0.41 | 3 | 0.874343529 | 1.001032584 |
| 0.54 | 0.46 | 3 | 0.859027201 | 0.993525576 |
| 0.49 | 0.51 | 3 | 0.847211748 | 0.986509222 |
| 0.44 | 0.56 | 3 | 0.840209998 | 0.981651746 |
| 0.39 | 0.61 | 3 | 0.841085217 | 0.980621372 |
| 0.34 | 0.66 | 3 | 0.850712623 | 0.984301278 |
| 0.29 | 0.71 | 3 | 0.869529826 | 0.992151744 |
| 0.24 | 0.76 | 3 | 0.897536826 | 1.00225922 |
| 0.19 | 0.81 | 3 | 0.932983186 | 1.011876041 |
| 0.14 | 0.86 | 3 | 0.974118467 | 1.017911087 |
| 0.09 | 0.91 | 2 | 1.020067451 | 1.017420433 |
| 0.04 | 0.96 | 2L | 1.069079701 | 1.007509219 |

Results show that the HFO-1234ze(Z) and butane compositions of the present invention provide similar CAP and similar energy efficiency relative to butane, for heating using high temperature heat pump systems. Additionally, in many cases, the HFO-1234ze(Z) and butane compositions of the present invention provide similar heating capacity relative to butane. Adding 73 wt % of HFO-1234ze(Z) to butane reduces the heat of combustion to below 4.54 kcal/g (8169 Btu/lbm), which is an 2L requirement, while the heating capacity remains similar to the CAP of butane.

### Example 17: Glide Reduction

The temperature glide for compositions containing either propane or isobutane with 2 wt. %, 0.5 wt. % or 0.1 wt. % of other hydrocarbon impurities at temperatures, and more particularly saturated liquid temperatures, of −30° C. (e.g., heat exchanger, evaporating; typical temperature for elective vehicle heat pump), 10° C. (common heat exchanger, evaporating, typical temperature for comfort cooling), and 50° C. (common heat exchanger, condensing, typical temperature for high ambient temperatures), were determined. The results are displayed in Tables 30-35.

TABLE 30
Propane Compositions at Saturated Liquid Temperature of −30° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.72 | 1.29 |
| Propane/Butane (98/2) | 1.41 | 2.53 |
| Propane/Cyclobutane (98/2) | 2.30 | 4.14 |
| Propane/Methane (98/2) | 42.76 | 76.98 |
| Propane/Ethane (98/2) | 2.66 | 4.79 |
| Propane/Propylene (98/2) | 0.04 | 0.08 |
| Propane/Butene (98/2) | 1.05 | 1.90 |
| Propane/Propyne (98/2) | 0.13 | 0.23 |
| Propane/Isobutene (98/2) | 0.66 | 1.19 |
| Propane/Ethylene (98/2) | 6.02 | 10.84 |
| Propane/Pentane (98/2) | 5.38 | 9.68 |
| Propane/Isopentane (98/2) | 3.66 | 6.59 |
| Propane/Cyclopentane (98/2) | 8.53 | 15.36 |
| Propane/Cyclobutene (98/2) | 1.74 | 3.13 |
| Propane/cis-Butene (98/2) | 1.74 | 3.14 |
| Propane/1-Butyne (98/2) | 2.18 | 3.93 |
| Propane/1-Pentene (98/2) | 4.40 | 7.93 |
| Propane/Cyclopropane (99.5/0.5) | 0.00 | 0.00 |
| Propane/Isobutane (99.5/0.5) | 0.18 | 0.33 |
| Propane/Butane (99.5/0.5) | 0.36 | 0.65 |
| Propane/Cyclobutane (99.5/0.5) | 0.59 | 1.07 |
| Propane/Methane (99.5/0.5) | 16.54 | 29.77 |
| Propane/Ethane (99.5/0.5) | 0.71 | 1.27 |
| Propane/Propylene (99.5/0.5) | 0.01 | 0.02 |
| Propane/Butene (99.5/0.5) | 0.27 | 0.49 |
| Propane/Propyne (99.5/0.5) | 0.03 | 0.06 |
| Propane/Isobutene (99.5/0.5) | 0.17 | 0.30 |
| Propane/Ethylene (99.5/0.5) | 1.65 | 2.96 |
| Propane/Pentane (99.5/0.5) | 1.44 | 2.59 |
| Propane/Isopentane (99.5/0.5) | 0.96 | 1.73 |
| Propane/Cyclopentane (99.5/0.5) | 2.33 | 4.19 |
| Propane/Cyclobutene (99.5/0.5) | 0.45 | 0.81 |
| Propane/cis-Butene (99.5/0.5) | 0.45 | 0.81 |
| Propane/1-Butyne (99.5/0.5) | 0.57 | 1.02 |
| Propane/1-Pentene (99.5/0.5) | 1.17 | 2.10 |
| Propane/Cyclopropane (99.9/0.1) | 0.00 | 0.00 |
| Propane/Isobutane (99.9/0.1) | 0.04 | 0.07 |
| Propane/Butane (99.9/0.1) | 0.07 | 0.13 |
| Propane/Cyclobutane (99.9/0.1) | 0.12 | 0.21 |
| Propane/Methane (99.9/0.1) | 4.07 | 7.32 |
| Propane/Ethane (99.9/0.1) | 0.14 | 0.26 |
| Propane/Propylene (99.9/0.1) | 0.00 | 0.00 |
| Propane/Butene (99.9/0.1) | 0.05 | 0.10 |
| Propane/Propyne (99.9/0.1) | 0.01 | 0.01 |
| Propane/Isobutene (99.9/0.1) | 0.03 | 0.06 |
| Propane/Ethylene (99.9/0.1) | 0.34 | 0.61 |
| Propane/Pentane (99.9/0.1) | 0.29 | 0.53 |
| Propane/Isopentane (99.9/0.1) | 0.19 | 0.35 |
| Propane/Cyclopentane (99.9/0.1) | 0.47 | 0.85 |
| Propane/Cyclobutene (99.9/0.1) | 0.09 | 0.16 |
| Propane/cis-Butene (99.9/0.1) | 0.09 | 0.16 |
| Propane/1-Butyne (99.9/0.1) | 0.11 | 0.21 |
| Propane/1-Pentene (99.9/0.1) | 0.24 | 0.43 |

TABLE 31
Propane Compositions at Saturated Liquid Temperature of 10° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.60 | 1.08 |
| Propane/Butane (98/2) | 1.09 | 1.97 |
| Propane/Cyclobutane (98/2) | 1.72 | 3.10 |
| Propane/Methane (98/2) | 29.12 | 52.42 |
| Propane/Ethane (98/2) | 2.10 | 3.78 |
| Propane/Propylene (98/2) | 0.04 | 0.07 |
| Propane/Butene (98/2) | 0.83 | 1.49 |
| Propane/Propyne (98/2) | 0.09 | 0.16 |
| Propane/Isobutene (98/2) | 0.53 | 0.95 |
| Propane/Ethylene (98/2) | 4.44 | 7.99 |
| Propane/Pentane (98/2) | 3.54 | 6.36 |
| Propane/Isopentane (98/2) | 2.54 | 4.58 |
| Propane/Cyclopentane (98/2) | 5.26 | 9.46 |
| Propane/Cyclobutene (98/2) | 1.30 | 2.34 |
| Propane/cis-Butene (98/2) | 1.30 | 2.34 |
| Propane/1-Butyne (98/2) | 1.46 | 2.64 |
| Propane/1-Pentene (98/2) | 2.98 | 5.36 |
| Propane/Cyclopropane (99.5/0.5) | 0.00 | 0.00 |
| Propane/Isobutane (99.5/0.5) | 0.15 | 0.28 |
| Propane/Butane (99.5/0.5) | 0.28 | 0.50 |
| Propane/Cyclobutane (99.5/0.5) | 0.44 | 0.79 |
| Propane/Methane (99.5/0.5) | 9.76 | 17.57 |
| Propane/Ethane (99.5/0.5) | 0.55 | 0.99 |
| Propane/Propylene (99.5/0.5) | 0.01 | 0.02 |
| Propane/Butene (99.5/0.5) | 0.21 | 0.38 |
| Propane/Propyne (99.5/0.5) | 0.02 | 0.04 |
| Propane/Isobutene (99.5/0.5) | 0.13 | 0.24 |
| Propane/Ethylene (99.5/0.5) | 1.18 | 2.12 |
| Propane/Pentane (99.5/0.5) | 0.90 | 1.63 |
| Propane/Isopentane (99.5/0.5) | 0.65 | 1.16 |
| Propane/Cyclopentane (99.5/0.5) | 1.34 | 2.42 |
| Propane/Cyclobutene (99.5/0.5) | 0.33 | 0.60 |
| Propane/cis-Butene (99.5/0.5) | 0.33 | 0.60 |
| Propane/1-Butyne (99.5/0.5) | 0.37 | 0.67 |
| Propane/1-Pentene (99.5/0.5) | 0.76 | 1.37 |
| Propane/Cyclopropane (99.9/0.1) | 0.00 | 0.00 |
| Propane/Isobutane (99.9/0.1) | 0.03 | 0.06 |
| Propane/Butane (99.9/0.1) | 0.06 | 0.10 |
| Propane/Cyclobutane (99.9/0.1) | 0.09 | 0.16 |
| Propane/Methane (99.9/0.1) | 2.19 | 3.94 |
| Propane/Ethane (99.9/0.1) | 0.11 | 0.20 |
| Propane/Propylene (99.9/0.1) | 0.00 | 0.00 |
| Propane/Butene (99.9/0.1) | 0.04 | 0.08 |
| Propane/Propyne (99.9/0.1) | 0.00 | 0.01 |
| Propane/Isobutene (99.9/0.1) | 0.03 | 0.05 |
| Propane/Ethylene (99.9/0.1) | 0.24 | 0.43 |
| Propane/Pentane (99.9/0.1) | 0.18 | 0.33 |
| Propane/Isopentane (99.9/0.1) | 0.13 | 0.23 |
| Propane/Cyclopentane (99.9/0.1) | 0.27 | 0.49 |
| Propane/Cyclobutene (99.9/0.1) | 0.07 | 0.12 |
| Propane/cis-Butene (99.9/0.1) | 0.07 | 0.12 |
| Propane/1-Butyne (99.9/0.1) | 0.07 | 0.13 |
| Propane/1-Pentene (99.9/0.1) | 0.15 | 0.27 |

TABLE 32
Propane Compositions at Saturated Liquid Temperature of 50° C.

| | Temp | Temp |
|---|---|---|
| Composition (wt. %) | Glide [K] | Glide [°R] |
| Propane/Cyclopropane (98/2) | 0.00 | 0.00 |
| Propane/Isobutane (98/2) | 0.47 | 0.84 |
| Propane/Butane (98/2) | 0.79 | 1.43 |
| Propane/Cyclobutane (98/2) | 1.21 | 2.17 |
| Propane/Methane (98/2) | 18.14 | 32.65 |
| Propane/Ethane (98/2) | 1.55 | 2.79 |
| Propane/Propylene (98/2) | 0.03 | 0.06 |
| Propane/Butene (98/2) | 0.60 | 1.09 |
| Propane/Propyne (98/2) | 0.05 | 0.08 |
| Propane/Isobutene (98/2) | 0.39 | 0.70 |
| Propane/Ethylene (98/2) | 3.06 | 5.51 |
| Propane/Pentane (98/2) | 2.27 | 4.09 |
| Propane/Isopentane (98/2) | 1.71 | 3.07 |
| Propane/Cyclopentane (98/2) | 3.21 | 5.78 |
| Propane/Cyclobutene (98/2) | 0.92 | 1.66 |
| Propane/cis-Butene (98/2) | 0.91 | 1.65 |
| Propane/1-Butyne (98/2) | 0.95 | 1.71 |
| Propane/1-Pentene (98/2) | 1.96 | 3.53 |
| Propane/Cyclopropane (99.5/0.5) | 0.00 | 0.00 |
| Propane/Isobutane (99.5/0.5) | 0.12 | 0.21 |
| Propane/Butane (99.5/0.5) | 0.20 | 0.36 |
| Propane/Cyclobutane (99.5/0.5) | 0.30 | 0.55 |
| Propane/Methane (99.5/0.5) | 5.85 | 10.53 |
| Propane/Ethane (99.5/0.5) | 0.41 | 0.73 |
| Propane/Propylene (99.5/0.5) | 0.01 | 0.01 |
| Propane/Butene (99.5/0.5) | 0.15 | 0.27 |
| Propane/Propyne (99.5/0.5) | 0.01 | 0.02 |
| Propane/Isobutene (99.5/0.5) | 0.10 | 0.18 |
| Propane/Ethylene (99.5/0.5) | 0.80 | 1.45 |
| Propane/Pentane (99.5/0.5) | 0.57 | 1.02 |
| Propane/Isopentane (99.5/0.5) | 0.43 | 0.77 |
| Propane/Cyclopentane (99.5/0.5) | 0.80 | 1.43 |
| Propane/Cyclobutene (99.5/0.5) | 0.23 | 0.42 |
| Propane/cis-Butene (99.5/0.5) | 0.23 | 0.42 |
| Propane/1-Butyne (99.5/0.5) | 0.24 | 0.43 |
| Propane/1-Pentene (99.5/0.5) | 0.49 | 0.88 |
| Propane/Cyclopropane (99.9/0.1) | 0.00 | 0.00 |
| Propane/Isobutane (99.9/0.1) | 0.02 | 0.04 |
| Propane/Butane (99.9/0.1) | 0.04 | 0.07 |
| Propane/Cyclobutane (99.9/0.1) | 0.06 | 0.11 |
| Propane/Methane (99.9/0.1) | 1.27 | 2.29 |
| Propane/Ethane (99.9/0.1) | 0.08 | 0.15 |
| Propane/Propylene (99.9/0.1) | 0.00 | 0.00 |
| Propane/Butene (99.9/0.1) | 0.03 | 0.06 |
| Propane/Propyne (99.9/0.1) | 0.00 | 0.00 |
| Propane/Isobutene (99.9/0.1) | 0.02 | 0.04 |
| Propane/Ethylene (99.9/0.1) | 0.16 | 0.29 |
| Propane/Pentane (99.9/0.1) | 0.11 | 0.20 |
| Propane/Isopentane (99.9/0.1) | 0.09 | 0.15 |
| Propane/Cyclopentane (99.9/0.1) | 0.16 | 0.29 |
| Propane/Cyclobutene (99.9/0.1) | 0.05 | 0.08 |
| Propane/cis-Butene (99.9/0.1) | 0.05 | 0.08 |
| Propane/1-Butyne (99.9/0.1) | 0.05 | 0.09 |
| Propane/1-Pentene (99.9/0.1) | 0.10 | 0.18 |

TABLE 33
Isobutane Compositions at Saturated Liquid
Temperature of −30° C.

| | Temp Glide | Temp |
|---|---|---|
| Composition (wt. %) | [K] | Glide [°R] |
| Isobutane/Cyclopropane (98/2) | 0.32 | 0.57 |
| Isobutane/Propane (98/2) | 1.02 | 1.83 |
| Isobutane/Butane (98/2) | 0.10 | 0.19 |
| Isobutane/Cyclobutane (98/2) | 0.48 | 0.86 |
| Isobutane/Methane (98/2) | 88.04 | 158.47 |
| Isobutane/Ethane (98/2) | 10.10 | 18.18 |
| Isobutane/Propylene (98/2) | 2.22 | 4.00 |
| Isobutane (100) | 0.00 | 0.00 |
| Isobutane/Butene (98/2) | 0.01 | 0.02 |
| Isobutane/Propyne (98/2) | 0.16 | 0.29 |
| Isobutane/Isobutene (98/2) | 0.01 | 0.01 |
| Isobutane/Ethylene (98/2) | 18.04 | 32.48 |
| Isobutane/Pentane (98/2) | 1.87 | 3.37 |
| Isobutane/Isopentane (98/2) | 1.18 | 2.12 |
| Isobutane/Cyclopentane (98/2) | 3.52 | 6.34 |
| Isobutane/Cyclobutene (98/2) | 0.20 | 0.36 |
| Isobutane/cis-Butene (98/2) | 0.21 | 0.38 |
| Isobutane/1-Butyne (98/2) | 0.40 | 0.72 |
| Isobutane/1-Pentene (98/2) | 1.40 | 2.51 |
| Isobutane/Cyclopropane (99.5/0.5) | 0.08 | 0.15 |
| Isobutane/Propane (99.5/0.5) | 0.27 | 0.48 |
| Isobutane/Butane (99.5/0.5) | 0.03 | 0.05 |
| Isobutane/Cyclobutane (99.5/0.5) | 0.12 | 0.22 |
| Isobutane/Methane (99.5/0.5) | 46.44 | 83.60 |
| Isobutane/Ethane (99.5/0.5) | 2.95 | 5.30 |
| Isobutane/Propylene (99.5/0.5) | 0.63 | 1.14 |
| Isobutane (100) | 0.00 | 0.00 |
| Isobutane/Butene (99.5/0.5) | 0.00 | 0.01 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 5.85 | 10.54 |
| Isobutane/Pentane (99.5/0.5) | 0.49 | 0.88 |
| Isobutane/Isopentane (99.5/0.5) | 0.30 | 0.54 |
| Isobutane/Cyclopentane (99.5/0.5) | 0.93 | 1.68 |
| Isobutane/Cyclobutene (99.5/0.5) | 0.05 | 0.09 |
| Isobutane/cis-Butene (99.5/0.5) | 0.05 | 0.10 |
| Isobutane/1-Butyne (99.5/0.5) | 0.10 | 0.18 |
| Isobutane/1-Pentene (99.5/0.5) | 0.36 | 0.65 |
| Isobutane/Cyclopropane (99.9/0.1) | 0.02 | 0.03 |
| Isobutane/Propane (99.9/0.1) | 0.05 | 0.10 |
| Isobutane/Butane (99.9/0.1) | 0.01 | 0.01 |
| Isobutane/Cyclobutane (99.9/0.1) | 0.02 | 0.04 |
| Isobutane/Methane (99.9/0.1) | 16.11 | 29.00 |
| Isobutane/Ethane (99.9/0.1) | 0.62 | 1.11 |
| Isobutane/Propylene (99.9/0.1) | 0.13 | 0.24 |
| Isobutane (100) | 0.00 | 0.00 |
| Isobutane/Butene (99.9/0.1) | 0.00 | 0.00 |
| Isobutane/Propyne (99.9/0.1) | 0.01 | 0.02 |
| Isobutane/Isobutene (99.9/0.1) | 0.00 | 0.00 |
| Isobutane/Ethylene (99.9/0.1) | 1.29 | 2.32 |
| Isobutane/Pentane (99.9/0.1) | 0.10 | 0.18 |
| Isobutane/Isopentane (99.9/0.1) | 0.06 | 0.11 |
| Isobutane/Cyclopentane (99.9/0.1) | 0.19 | 0.34 |
| Isobutane/Cyclobutene (99.9/0.1) | 0.01 | 0.02 |
| Isobutane/cis-Butene (99.9/0.1) | 0.01 | 0.02 |
| Isobutane/1-Butyne (99.9/0.1) | 0.02 | 0.04 |
| Isobutane/1-Pentene (99.9/0.1) | 0.07 | 0.13 |

TABLE 34
Isobutane Compositions at Saturated Liquid Temperature of 10° C.

| | Temp | Temp |
|---|---|---|
| Composition (wt. %) | Glide [K] | Glide [°R] |
| Isobutane/Cyclopropane (98/2) | 0.35 | 0.62 |
| Isobutane/Propane (98/2) | 0.86 | 1.55 |
| Isobutane/Butane (98/2) | 0.09 | 0.16 |
| Isobutane/Cyclobutane (98/2) | 0.40 | 0.72 |
| Isobutane/Methane (98/2) | 65.54 | 117.97 |
| Isobutane/Ethane (98/2) | 7.73 | 13.91 |
| Isobutane/Propylene (98/2) | 1.85 | 3.33 |
| Isobutane (100) | 0.00 | 0.00 |
| Isobutane/Butene (98/2) | 0.01 | 0.01 |
| Isobutane/Propyne (98/2) | 0.14 | 0.26 |
| Isobutane/Isobutene (98/2) | 0.00 | 0.00 |
| Isobutane/Ethylene (98/2) | 13.26 | 23.88 |
| Isobutane/Pentane (98/2) | 1.44 | 2.58 |
| Isobutane/Isopentane (98/2) | 0.95 | 1.71 |
| Isobutane/Cyclopentane (98/2) | 2.57 | 4.62 |
| Isobutane/Cyclobutene (98/2) | 0.16 | 0.30 |
| Isobutane/cis-Butene (98/2) | 0.16 | 0.29 |
| Isobutane/1-Butyne (98/2) | 0.26 | 0.47 |
| Isobutane/1-Pentene (98/2) | 1.10 | 1.97 |
| Isobutane/Cyclopropane (99.5/0.5) | 0.09 | 0.16 |
| Isobutane/Propane (99.5/0.5) | 0.22 | 0.40 |
| Isobutane/Butane (99.5/0.5) | 0.02 | 0.04 |
| Isobutane/Cyclobutane (99.5/0.5) | 0.10 | 0.18 |
| Isobutane/Methane (99.5/0.5) | 28.15 | 50.66 |
| Isobutane/Ethane (99.5/0.5) | 2.13 | 3.83 |
| Isobutane/Propylene (99.5/0.5) | 0.51 | 0.93 |
| Isobutane (100) | 0.00 | 0.00 |
| Isobutane/Butene (99.5/0.5) | 0.00 | 0.00 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 3.87 | 6.97 |
| Isobutane/Pentane (99.5/0.5) | 0.37 | 0.66 |
| Isobutane/Isopentane (99.5/0.5) | 0.24 | 0.44 |
| Isobutane/Cyclopentane (99.5/0.5) | 0.66 | 1.19 |
| Isobutane/Cyclobutene (99.5/0.5) | 0.04 | 0.08 |
| Isobutane/cis-Butene (99.5/0.5) | 0.04 | 0.07 |
| Isobutane/1-Butyne (99.5/0.5) | 0.07 | 0.12 |
| Isobutane/1-Pentene (99.5/0.5) | 0.28 | 0.50 |
| Isobutane/Cyclopropane (99.9/0.1) | 0.02 | 0.03 |
| Isobutane/Propane (99.9/0.1) | 0.05 | 0.08 |
| Isobutane/Butane (99.9/0.1) | 0.00 | 0.01 |
| Isobutane/Cyclobutane (99.9/0.1) | 0.02 | 0.04 |
| Isobutane/Methane (99.9/0.1) | 7.44 | 13.39 |
| Isobutane/Ethane (99.9/0.1) | 0.44 | 0.79 |
| Isobutane/Propylene (99.9/0.1) | 0.11 | 0.19 |
| Isobutane (100) | 0.00 | 0.00 |
| Isobutane/Butene (99.9/0.1) | 0.00 | 0.00 |
| Isobutane/Propyne (99.9/0.1) | 0.01 | 0.01 |
| Isobutane/Isobutene (99.9/0.1) | 0.00 | 0.00 |
| Isobutane/Ethylene (99.9/0.1) | 0.81 | 1.46 |
| Isobutane/Pentane (99.9/0.1) | 0.07 | 0.13 |
| Isobutane/Isopentane (99.9/0.1) | 0.05 | 0.09 |
| Isobutane/Cyclopentane (99.9/0.1) | 0.13 | 0.24 |
| Isobutane/Cyclobutene (99.9/0.1) | 0.01 | 0.02 |
| Isobutane/cis-Butene (99.9/0.1) | 0.01 | 0.01 |
| Isobutane/1-Butyne (99.9/0.1) | 0.01 | 0.02 |
| Isobutane/1-Pentene (99.9/0.1) | 0.06 | 0.10 |

TABLE 35
Isobutane Compositions at Saturated Liquid Temperature of 50° C.

| | Temp | Temp |
|---|---|---|
| Composition (wt. %) | Glide [K] | Glide [°R] |
| Isobutane/Cyclopropane (98/2) | 0.31 | 0.56 |
| Isobutane/Propane (98/2) | 0.71 | 1.28 |
| Isobutane/Butane (98/2) | 0.07 | 0.13 |
| Isobutane/Cyclobutane (98/2) | 0.32 | 0.57 |
| Isobutane/Methane (98/2) | 44.88 | 80.79 |
| Isobutane/Ethane (98/2) | 5.93 | 10.68 |
| Isobutane/Propylene (98/2) | 1.52 | 2.73 |
| Isobutane (100) | 0.00 | 0.00 |
| Isobutane/Butene (98/2) | 0.00 | 0.01 |
| Isobutane/Propyne (98/2) | 0.16 | 0.28 |
| Isobutane/Isobutene (98/2) | 0.00 | 0.00 |
| Isobutane/Ethylene (98/2) | 9.62 | 17.32 |
| Isobutane/Pentane (98/2) | 1.10 | 1.98 |
| Isobutane/Isopentane (98/2) | 0.76 | 1.37 |
| Isobutane/Cyclopentane (98/2) | 1.91 | 3.43 |
| Isobutane/Cyclobutene (98/2) | 0.13 | 0.23 |
| Isobutane/cis-Butene (98/2) | 0.12 | 0.22 |
| Isobutane/1-Butyne (98/2) | 0.16 | 0.30 |
| Isobutane/1-Pentene (98/2) | 0.86 | 1.54 |
| Isobutane/Cyclopropane (99.5/0.5) | 0.08 | 0.14 |
| Isobutane/Propane (99.5/0.5) | 0.18 | 0.33 |
| Isobutane/Butane (99.5/0.5) | 0.02 | 0.03 |
| Isobutane/Cyclobutane (99.5/0.5) | 0.08 | 0.14 |
| Isobutane/Methane (99.5/0.5) | 16.46 | 29.63 |
| Isobutane/Ethane (99.5/0.5) | 1.60 | 2.87 |
| Isobutane/Propylene (99.5/0.5) | 0.42 | 0.75 |
| Isobutane (100) | 0.00 | 0.00 |
| Isobutane/Butene (99.5/0.5) | 0.00 | 0.00 |
| Isobutane/Propyne (99.5/0.5) | 0.04 | 0.07 |
| Isobutane/Isobutene (99.5/0.5) | 0.00 | 0.00 |
| Isobutane/Ethylene (99.5/0.5) | 2.67 | 4.81 |
| Isobutane/Pentane (99.5/0.5) | 0.28 | 0.50 |
| Isobutane/Isopentane (99.5/0.5) | 0.19 | 0.35 |
| Isobutane/Cyclopentane (99.5/0.5) | 0.48 | 0.87 |
| Isobutane/Cyclobutene (99.5/0.5) | 0.03 | 0.06 |
| Isobutane/cis-Butene (99.5/0.5) | 0.03 | 0.06 |
| Isobutane/1-Butyne (99.5/0.5) | 0.04 | 0.08 |
| Isobutane/1-Pentene (99.5/0.5) | 0.22 | 0.39 |
| Isobutane/Cyclopropane (99.9/0.1) | 0.02 | 0.03 |
| Isobutane/Propane (99.9/0.1) | 0.04 | 0.07 |
| Isobutane/Butane (99.9/0.1) | 0.00 | 0.01 |
| Isobutane/Cyclobutane (99.9/0.1) | 0.02 | 0.03 |
| Isobutane/Methane (99.9/0.1) | 3.81 | 6.86 |
| Isobutane/Ethane (99.9/0.1) | 0.33 | 0.59 |
| Isobutane/Propylene (99.9/0.1) | 0.09 | 0.15 |
| Isobutane (100) | 0.00 | 0.00 |
| Isobutane/Butene (99.9/0.1) | 0.00 | 0.00 |
| Isobutane/Propyne (99.9/0.1) | 0.01 | 0.01 |
| Isobutane/Isobutene (99.9/0.1) | 0.00 | 0.00 |
| Isobutane/Ethylene (99.9/0.1) | 0.55 | 0.99 |
| Isobutane/Pentane (99.9/0.1) | 0.06 | 0.10 |
| Isobutane/Isopentane (99.9/0.1) | 0.04 | 0.07 |
| Isobutane/Cyclopentane (99.9/0.1) | 0.10 | 0.18 |
| Isobutane/Cyclobutene (99.9/0.1) | 0.01 | 0.01 |
| Isobutane/cis-Butene (99.9/0.1) | 0.01 | 0.01 |
| Isobutane/1-Butyne (99.9/0.1) | 0.01 | 0.02 |
| Isobutane/1-Pentene (99.9/0.1) | 0.04 | 0.08 |

The results demonstrate that additional compounds, such as cyclopropane, propane, butane, cyclobutene, methane, ethane, propylene, butene, propyne, ethylene, pentane, isopentane, cyclopentane, cyclobutene, cis-butene, 1-butyne and 1-pentene, generate glide against propane and isobutane at all temperatures. Thus, according to the present invention, the concentration of such additional compounds is limited to below 2 wt. %, preferably below 1 wt. %, more preferably below 0.5 wt. %, most preferably below 0.1 wt. %, in order to keep glide as low as possible.

### Example 18: Cooling Performance

The glide, pressures, discharge temperatures, relative COP (energy efficiency) and relative cooling capacity were determined for the following conditions, with relative COP and relative cooling capacity being compared to pure propane or isobutane:

Condenser Bubble Pt. Temp: 46.1° C.
Amount of Subcooling: 8.3° C.
Evaporator Dew Pt. Temp: 10° C.
Amount of Superheat: 11.1° C.
Compressor Isentropic Efficiency: 70%

The results are displayed in Tables 36-37.

TABLE 36

| | Condenser | Evaporator | Relative | Relative |
|---|---|---|---|---|
| Composition (wt. %) | Glide [° C.] | Glide [° C.] | Capacity | COP |
| R-410A | 0.1 | 0.1 | 1.706 | 0.932 |
| R-22 | 0.0 | 0.0 | 1.166 | 0.994 |
| R-134a | 0.0 | 0.0 | 0.778 | 1.018 |
| R-1234yf | 0.0 | 0.0 | 0.743 | 1.001 |
| Propane | 0.0 | 0.0 | 1.000 | 1.000 |
| Propane/Cyclopropane (98/2) | 0.0 | 0.0 | 1.001 | 1.000 |
| Propane/Isobutane (98/2) | 0.5 | 0.5 | 0.975 | 0.983 |
| Propane/Butane (98/2) | 0.8 | 1.0 | 0.960 | 0.969 |
| Propane/Cyclobutane (98/2) | 1.3 | 1.6 | 0.942 | 0.951 |
| Propane/Methane (98/2) | 19.1 | 5.1 | 1.007 | 0.643 |
| Propane/Ethane (98/2) | 1.6 | 1.1 | 1.014 | 0.950 |
| Propane/Propylene (98/2) | 0.0 | 0.0 | 1.004 | 0.999 |
| Propane/Butene (98/2) | 0.6 | 0.8 | 0.968 | 0.977 |
| Propane/Propyne (98/2) | 0.0 | 0.1 | 0.995 | 0.999 |
| Propane/Isobutene (98/2) | 0.4 | 0.5 | 0.977 | 0.986 |
| Propane/Ethylene (98/2) | 3.2 | 1.8 | 1.014 | 0.910 |
| Propane/Pentane (98/2) | 2.4 | 3.6 | 0.890 | 0.894 |
| Propane/Isopentane (98/2) | 1.8 | 2.5 | 0.919 | 0.924 |
| Propane/Cyclopentane (98/2) | 3.4 | 5.5 | 0.839 | 0.843 |
| Propane/Cyclobutene (98/2) | 1.0 | 1.2 | 0.955 | 0.964 |
| Propane/cis-Butene (98/2) | 1.0 | 1.2 | 0.955 | 0.963 |
| Propane/1-Butyne (98/2) | 1.0 | 1.4 | 0.950 | 0.959 |
| Propane/1-Pentene (98/2) | 2.1 | 3.0 | 0.906 | 0.911 |
| Propane/Cyclopropane (99.5/0.5) | 0.0 | 0.0 | 1.000 | 1.000 |
| Propane/Isobutane (99.5/0.5) | 0.1 | 0.1 | 0.994 | 0.996 |
| Propane/Butane (99.5/0.5) | 0.2 | 0.3 | 0.990 | 0.992 |
| Propane/Cyclobutane (99.5/0.5) | 0.3 | 0.4 | 0.985 | 0.987 |
| Propane/Methane (99.5/0.5) | 6.2 | 1.6 | 1.002 | 0.855 |
| Propane/Ethane (99.5/0.5) | 0.4 | 0.3 | 1.003 | 0.987 |
| Propane/Propylene (99.5/0.5) | 0.0 | 0.0 | 1.001 | 1.000 |
| Propane/Butene (99.5/0.5) | 0.2 | 0.2 | 0.992 | 0.994 |
| Propane/Propyne (99.5/0.5) | 0.0 | 0.0 | 0.999 | 1.000 |
| Propane/Isobutene (99.5/0.5) | 0.1 | 0.1 | 0.994 | 0.996 |
| Propane/Ethylene (99.5/0.5) | 0.8 | 0.5 | 1.003 | 0.975 |
| Propane/Pentane (99.5/0.5) | 0.6 | 0.9 | 0.972 | 0.972 |
| Propane/Isopentane (99.5/0.5) | 0.4 | 0.6 | 0.979 | 0.980 |
| Propane/Cyclopentane (99.5/0.5) | 0.8 | 1.3 | 0.959 | 0.957 |
| Propane/Cyclobutene (99.5/0.5) | 0.2 | 0.3 | 0.988 | 0.990 |
| Propane/cis-Butene (99.5/0.5) | 0.2 | 0.3 | 0.988 | 0.990 |
| Propane/1-Butyne (99.5/0.5) | 0.3 | 0.4 | 0.987 | 0.989 |
| Propane/1-Pentene (99.5/0.5) | 0.5 | 0.7 | 0.976 | 0.976 |
| Propane/Cyclopropane (99.9/0.1) | 0.0 | 0.0 | 1.000 | 1.000 |
| Propane/Isobutane (99.9/0.1) | 0.0 | 0.0 | 0.999 | 0.999 |
| Propane/Butane (99.9/0.1) | 0.0 | 0.1 | 0.998 | 0.998 |
| Propane/Cyclobutane (99.9/0.1) | 0.1 | — | 0.997 | 0.997 |
| Propane/Methane (99.9/0.1) | 1.3 | 0.3 | 1.000 | 0.965 |
| Propane/Ethane (99.9/0.1) | 0.1 | 0.1 | 1.001 | 0.997 |
| Propane/Propylene (99.9/0.1) | 0.0 | 0.0 | 1.000 | 1.000 |
| Propane/Butene (99.9/0.1) | 0.0 | 0.0 | 0.998 | 0.999 |
| Propane/Propyne (99.9/0.1) | 0.0 | 0.0 | 1.000 | 1.000 |
| Propane/Isobutene (99.9/0.1) | 0.0 | 0.0 | 0.999 | 0.999 |
| Propane/Ethylene (99.9/0.1) | 0.2 | 0.1 | 1.001 | 0.995 |
| Propane/Pentane (99.9/0.1) | 0.1 | 0.2 | 0.994 | 0.994 |
| Propane/Isopentane (99.9/0.1) | 0.1 | 0.1 | 0.996 | 0.996 |
| Propane/Cyclopentane (99.9/0.1) | 0.2 | 0.3 | 0.992 | 0.991 |
| Propane/Cyclobutene (99.9/0.1) | 0.0 | 0.1 | 0.998 | 0.998 |
| Propane/cis-Butene (99.9/0.1) | 0.0 | 0.1 | 0.998 | 0.998 |
| Propane/1-Butyne (99.9/0.1) | 0.1 | — | 0.997 | 0.998 |
| Propane/1-Pentene (99.9/0.1) | 0.1 | 0.1 | 0.995 | 0.995 |

| | Condenser | Evaporator | Compressor |
|---|---|---|---|
| | Pressure | Pressure | Discharge Temp |
| Composition (wt. %) | [Mpa] | [Mpa] | [° C.] |
| R-410A | 2.806 | 1.085 | 81.6 |
| R-22 | 1.775 | 0.681 | 84.6 |
| R-134a | 1.194 | 0.415 | 69.2 |
| R-1234yf | 1.186 | 0.438 | 60.8 |
| Propane | 1.573 | 0.637 | 68.5 |
| Propane/Cyclopropane (98/2) | 1.573 | 0.637 | 68.7 |
| Propane/Isobutane (98/2) | 1.555 | 0.619 | 69.1 |
| Propane/Butane (98/2) | 1.552 | 0.609 | 69.8 |
| Propane/Cyclobutane (98/2) | 1.549 | 0.597 | 70.9 |
| Propane/Methane (98/2) | 2.560 | 0.678 | 94.0 |
| Propane/Ethane (98/2) | 1.672 | 0.653 | 70.9 |
| Propane/Propylene (98/2) | 1.581 | 0.640 | 68.7 |
| Propane/Butene (98/2) | 1.554 | 0.614 | 69.5 |
| Propane/Propyne (98/2) | 1.564 | 0.631 | 68.8 |
| Propane/Isobutene (98/2) | 1.556 | 0.620 | 69.1 |
| Propane/Ethylene (98/2) | 1.743 | 0.656 | 73.1 |
| Propane/Pentane (98/2) | 1.551 | 0.566 | 73.2 |
| Propane/Isopentane (98/2) | 1.552 | 0.584 | 71.7 |
| Propane/Cyclopentane (98/2) | 1.549 | 0.534 | 76.2 |
| Propane/Cyclobutene (98/2) | 1.550 | 0.605 | 70.4 |
| Propane/cis-Butene (98/2) | 1.551 | 0.605 | 70.2 |
| Propane/1-Butyne (98/2) | 1.550 | 0.601 | 70.4 |
| Propane/1-Pentene (98/2) | 1.551 | 0.575 | 72.4 |
| Propane/Cyclopropane (99.5/0.5) | 1.573 | 0.637 | 68.6 |
| Propane/Isobutane (99.5/0.5) | 1.568 | 0.632 | 68.7 |
| Propane/Butane (99.5/0.5) | 1.568 | 0.630 | 68.9 |
| Propane/Cyclobutane (99.5/0.5) | 1.567 | 0.626 | 69.1 |
| Propane/Methane (99.5/0.5) | 1.834 | 0.647 | 76.4 |
| Propane/Ethane (99.5/0.5) | 1.598 | 0.641 | 69.1 |
| Propane/Propylene (99.5/0.5) | 1.575 | 0.637 | 68.6 |
| Propane/Butene (99.5/0.5) | 1.568 | 0.631 | 68.8 |
| Propane/Propyne (99.5/0.5) | 1.571 | 0.635 | 68.6 |
| Propane/Isobutene (99.5/0.5) | 1.569 | 0.633 | 68.7 |
| Propane/Ethylene (99.5/0.5) | 1.615 | 0.641 | 69.7 |
| Propane/Pentane (99.5/0.5) | 1.567 | 0.618 | 69.7 |
| Propane/Isopentane (99.5/0.5) | 1.568 | 0.623 | 69.3 |
| Propane/Cyclopentane (99.5/0.5) | 1.567 | 0.610 | 70.4 |
| Propane/Cyclobutene (99.5/0.5) | 1.567 | 0.628 | 69.0 |
| Propane/cis-Butene (99.5/0.5) | 1.567 | 0.628 | 69.0 |
| Propane/1-Butyne (99.5/0.5) | 1.567 | 0.628 | 69.0 |
| Propane/1-Pentene (99.5/0.5) | 1.567 | 0.621 | 69.5 |
| Propane/Cyclopropane (99.9/0.1) | 1.573 | 0.637 | 68.5 |
| Propane/Isobutane (99.9/0.1) | 1.572 | 0.636 | 68.6 |
| Propane/Butane (99.9/0.1) | 1.572 | 0.635 | 68.6 |
| Propane/Cyclobutane (99.9/0.1) | 1.572 | 0.635 | 68.7 |
| Propane/Methane (99.9/0.1) | 1.626 | 0.639 | 70.2 |
| Propane/Ethane (99.9/0.1) | 1.578 | 0.637 | 68.7 |
| Propane/Propylene (99.9/0.1) | 1.573 | 0.637 | 68.5 |
| Propane/Butene (99.9/0.1) | 1.572 | 0.635 | 68.6 |
| Propane/Propyne (99.9/0.1) | 1.572 | 0.636 | 68.5 |
| Propane/Isobutene (99.9/0.1) | 1.572 | 0.636 | 68.6 |
| Propane/Ethylene (99.9/0.1) | 1.581 | 0.638 | 68.8 |
| Propane/Pentane (99.9/0.1) | 1.572 | 0.633 | 68.8 |
| Propane/Isopentane (99.9/0.1) | 1.572 | 0.634 | 68.7 |
| Propane/Cyclopentane (99.9/0.1) | 1.572 | 0.631 | 68.9 |
| Propane/Cyclobutene (99.9/0.1) | 1.572 | 0.635 | 68.6 |
| Propane/cis-Butene (99.9/0.1) | 1.572 | 0.635 | 68.6 |
| Propane/1-Butyne (99.9/0.1) | 1.572 | 0.635 | 68.6 |
| Propane/1-Pentene (99.9/0.1) | 1.572 | 0.633 | 68.7 |

TABLE 37

| | Condenser | Evaporator | Relative | Relative |
|---|---|---|---|---|
| Composition (wt. %) | Glide [° C.] | Glide [° C.] | Capacity | COP |
| Isobutane/Cyclopropane (98/2) | 0.3 | 0.2 | 1.012 | 0.991 |
| Isobutane/Propane (98/2) | 0.7 | 0.5 | 1.013 | 0.979 |
| Isobutane/Butane (98/2) | 0.1 | 0.1 | 0.992 | 0.998 |
| Isobutane/Cyclobutane (98/2) | 0.3 | 0.4 | 0.979 | 0.989 |
| Isobutane/Methane (98/2) | 46.8 | 6.1 | 1.005 | 0.465 |
| Isobutane/Ethane (98/2) | 6.1 | 2.6 | 1.020 | 0.856 |
| Isobutane/Propylene (98/2) | 1.5 | 1.0 | 1.015 | 0.957 |
| Isobutane (100) | 0.0 | 0.0 | 1.000 | 1.000 |
| Isobutane/Butene (98/2) | 0.0 | 0.0 | 0.999 | 1.000 |
| Isobutane/Propyne (98/2) | 0.2 | 0.1 | 1.011 | 0.996 |
| Isobutane/Isobutene (98/2) | 0.0 | 0.0 | 0.999 | 1.000 |
| Isobutane/Ethylene (98/2) | 9.9 | 3.3 | 1.019 | 0.788 |
| Isobutane/Pentane (98/2) | 1.1 | 1.4 | 0.944 | 0.958 |
| Isobutane/Isopentane (98/2) | 0.8 | 0.9 | 0.960 | 0.972 |
| Isobutane/Cyclopentane (98/2) | 2.0 | 2.5 | 0.907 | 0.924 |
| Isobutane/Cyclobutene (98/2) | 0.1 | 0.1 | 0.989 | 0.996 |
| Isobutane/cis-Butene (98/2) | 0.1 | 0.1 | 0.989 | 0.996 |
| Isobutane/1-Butyne (98/2) | 0.2 | 0.2 | 0.985 | 0.994 |
| Isobutane/1-Pentene (98/2) | 0.9 | 1.0 | 0.955 | 0.968 |
| Isobutane/Cyclopropane (99.5/0.5) | 0.1 | 0.1 | 1.003 | 0.998 |
| Isobutane/Propane (99.5/0.5) | 0.2 | 0.1 | 1.003 | 0.994 |
| Isobutane/Butane (99.5/0.5) | 0.0 | 0.0 | 0.998 | 0.999 |
| Isobutane/Cyclobutane (99.5/0.5) | 0.1 | 0.1 | 0.995 | 0.997 |
| Isobutane/Methane (99.5/0.5) | 17.4 | 2.0 | 1.001 | 0.700 |
| Isobutane/Ethane (99.5/0.5) | 1.6 | 0.7 | 1.005 | 0.957 |
| Isobutane/Propylene (99.5/0.5) | 0.4 | 0.3 | 1.004 | 0.988 |
| Isobutane (100) | 0.0 | 0.0 | 1.000 | 1.000 |
| Isobutane/Butene (99.5/0.5) | 0.0 | 0.0 | 1.000 | 1.000 |
| Isobutane/Propyne (99.5/0.5) | 0.0 | 0.0 | 1.003 | 0.999 |
| Isobutane/Isobutene (99.5/0.5) | 0.0 | 0.0 | 1.000 | 1.000 |
| Isobutane/Ethylene (99.5/0.5) | 2.8 | 0.9 | 1.005 | 0.931 |
| Isobutane/Pentane (99.5/0.5) | 0.3 | 0.3 | 0.986 | 0.989 |
| Isobutane/Isopentane (99.5/0.5) | 0.2 | 0.2 | 0.990 | 0.993 |
| Isobutane/Cyclopentane (99.5/0.5) | 0.5 | 0.6 | 0.976 | 0.980 |
| Isobutane/Cyclobutene (99.5/0.5) | 0.0 | 0.0 | 0.997 | 0.999 |
| Isobutane/cis-Butene (99.5/0.5) | 0.0 | 0.0 | 0.997 | 0.999 |
| Isobutane/1-Butyne (99.5/0.5) | 0.0 | 0.1 | 0.996 | 0.998 |
| Isobutane/1-Pentene (99.5/0.5) | 0.2 | 0.3 | 0.988 | 0.992 |
| Isobutane/Cyclopropane (99.9/0.1) | 0.0 | 0.0 | 1.001 | 1.000 |
| Isobutane/Propane (99.9/0.1) | 0.0 | 0.0 | 1.001 | 0.999 |
| Isobutane/Butane (99.9/0.1) | 0.0 | 0.0 | 1.000 | 1.000 |
| Isobutane/Cyclobutane (99.9/0.1) | 0.0 | 0.0 | 0.999 | 0.999 |
| Isobutane/Methane (99.9/0.1) | 4.1 | 0.4 | 1.000 | 0.907 |
| Isobutane/Ethane (99.9/0.1) | 0.3 | 0.1 | 1.001 | 0.991 |
| Isobutane/Propylene (99.9/0.1) | 0.1 | 0.1 | 1.001 | 0.997 |
| Isobutane (100) | 0.0 | 0.0 | 1.000 | 1.000 |
| Isobutane/Butene (99.9/0.1) | 0.0 | 0.0 | 1.000 | 1.000 |
| Isobutane/Propyne (99.9/0.1) | 0.0 | 0.0 | 1.001 | 1.000 |
| Isobutane/Isobutene (99.9/0.1) | 0.0 | 0.0 | 1.000 | 1.000 |
| Isobutane/Ethylene (99.9/0.1) | 0.6 | 0.2 | 1.001 | 0.985 |
| Isobutane/Pentane (99.9/0.1) | 0.1 | 0.1 | 0.997 | 0.998 |
| Isobutane/Isopentane (99.9/0.1) | 0.0 | 0.0 | 0.998 | 0.999 |
| Isobutane/Cyclopentane (99.9/0.1) | 0.1 | 0.1 | 0.995 | 0.996 |
| Isobutane/Cyclobutene (99.9/0.1) | 0.0 | 0.0 | 0.999 | 1.000 |
| Isobutane/cis-Butene (99.9/0.1) | 0.0 | 0.0 | 0.999 | 1.000 |
| Isobutane/1-Butyne (99.9/0.1) | 0.0 | 0.0 | 0.999 | 1.000 |
| Isobutane/1-Pentene (99.9/0.1) | 0.0 | 0.1 | 0.998 | 0.998 |

| | Condenser | Evaporator | Compressor |
|---|---|---|---|
| | Pressure | Pressure | Discharge Temp |
| Composition (wt. %) | [Mpa] | [Mpa] | [° C.] |
| Isobutane/Cyclopropane (98/2) | 0.635 | 0.224 | 62.0 |
| Isobutane/Propane (98/2) | 0.644 | 0.225 | 62.3 |
| Isobutane/Butane (98/2) | 0.618 | 0.219 | 61.4 |
| Isobutane/Cyclobutane (98/2) | 0.615 | 0.215 | 62.0 |
| Isobutane/Methane (98/2) | 1.923 | 0.238 | 109.1 |
| Isobutane/Ethane (98/2) | 0.751 | 0.229 | 68.2 |
| Isobutane/Propylene (98/2) | 0.661 | 0.226 | 63.2 |
| Isobutane (100) | 0.621 | 0.221 | 61.3 |
| Isobutane/Butene (98/2) | 0.621 | 0.220 | 61.4 |
| Isobutane/Propyne (98/2) | 0.630 | 0.223 | 61.9 |
| Isobutane/Isobutene (98/2) | 0.621 | 0.220 | 61.4 |
| Isobutane/Ethylene (98/2) | 0.828 | 0.230 | 72.2 |
| Isobutane/Pentane (98/2) | 0.613 | 0.207 | 62.9 |
| Isobutane/Isopentane (98/2) | 0.614 | 0.211 | 62.3 |
| Isobutane/Cyclopentane (98/2) | 0.612 | 0.199 | 64.5 |
| Isobutane/Cyclobutene (98/2) | 0.617 | 0.217 | 61.8 |
| Isobutane/cis-Butene (98/2) | 0.617 | 0.218 | 61.7 |
| Isobutane/1-Butyne (98/2) | 0.616 | 0.216 | 61.8 |
| Isobutane/1-Pentene (98/2) | 0.614 | 0.210 | 62.6 |
| Isobutane/Cyclopropane (99.5/0.5) | 0.625 | 0.221 | 61.5 |
| Isobutane/Propane (99.5/0.5) | 0.627 | 0.222 | 61.6 |
| Isobutane/Butane (99.5/0.5) | 0.621 | 0.220 | 61.3 |
| Isobutane/Cyclobutane (99.5/0.5) | 0.620 | 0.219 | 61.5 |
| Isobutane/Methane (99.5/0.5) | 0.962 | 0.225 | 78.9 |
| Isobutane/Ethane (99.5/0.5) | 0.654 | 0.223 | 63.1 |
| Isobutane/Propylene (99.5/0.5) | 0.632 | 0.222 | 61.8 |
| Isobutane (100) | 0.622 | 0.221 | 61.3 |
| Isobutane/Butene (99.5/0.5) | 0.621 | 0.220 | 61.3 |
| Isobutane/Propyne (99.5/0.5) | 0.624 | 0.221 | 61.5 |
| Isobutane/Isobutene (99.5/0.5) | 0.622 | 0.221 | 61.3 |
| Isobutane/Ethylene (99.5/0.5) | 0.674 | 0.223 | 64.3 |
| Isobutane/Pentane (99.5/0.5) | 0.620 | 0.217 | 61.7 |
| Isobutane/Isopentane (99.5/0.5) | 0.620 | 0.218 | 61.6 |
| Isobutane/Cyclopentane (99.5/0.5) | 0.619 | 0.215 | 62.1 |
| Isobutane/Cyclobutene (99.5/0.5) | 0.620 | 0.220 | 61.4 |
| Isobutane/cis-Butene (99.5/0.5) | 0.620 | 0.220 | 61.4 |
| Isobutane/1-Butyne (99.5/0.5) | 0.620 | 0.220 | 61.4 |
| Isobutane/1-Pentene (99.5/0.5) | 0.620 | 0.218 | 61.6 |
| Isobutane/Cyclopropane (99.9/0.1) | 0.622 | 0.221 | 61.4 |
| Isobutane/Propane (99.9/0.1) | 0.623 | 0.221 | 61.4 |
| Isobutane/Butane (99.9/0.1) | 0.621 | 0.221 | 61.3 |
| Isobutane/Cyclobutane (99.9/0.1) | 0.621 | 0.220 | 61.4 |
| Isobutane/Methane (99.9/0.1) | 0.691 | 0.221 | 65.5 |
| Isobutane/Ethane (99.9/0.1) | 0.628 | 0.221 | 61.7 |
| Isobutane/Propylene (99.9/0.1) | 0.624 | 0.221 | 61.4 |
| Isobutane (100) | 0.622 | 0.221 | 61.3 |
| Isobutane/Butene (99.9/0.1) | 0.622 | 0.221 | 61.3 |
| Isobutane/Propyne (99.9/0.1) | 0.622 | 0.221 | 61.3 |
| Isobutane/Isobutene (99.9/0.1) | 0.622 | 0.221 | 61.3 |
| Isobutane/Ethylene (99.9/0.1) | 0.632 | 0.221 | 61.9 |
| Isobutane/Pentane (99.9/0.1) | 0.621 | 0.220 | 61.4 |
| Isobutane/Isopentane (99.9/0.1) | 0.621 | 0.220 | 61.4 |
| Isobutane/Cyclopentane (99.9/0.1) | 0.621 | 0.219 | 61.5 |
| Isobutane/Cyclobutene (99.9/0.1) | 0.621 | 0.220 | 61.3 |
| Isobutane/cis-Butene (99.9/0.1) | 0.621 | 0.220 | 61.3 |
| Isobutane/1-Butyne (99.9/0.1) | 0.621 | 0.220 | 61.3 |
| Isobutane/1-Pentene (99.9/0.1) | 0.621 | 0.220 | 61.4 |

The results demonstrate that the presence of additional compounds such as cyclopropane, propane, butane, cyclobutene, methane, ethane, propylene, butene, propyne, ethylene, pentane, isopentane, cyclopentane, cyclobutene, cis-butene, 1-butyne and 1-pentene, results in a composition having reduced COP and/or CAP against (pure) propane and isobutane. Thus, according to the present invention, the concentration of such additional compounds is limited to below 2 wt. %, preferably below 1 wt. %, more preferably below 0.5 wt. %, most preferably below 0.1 wt. %, in order to minimize any negative impact on COP and CAP.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A composition comprising:
(i) HFO-1234ze(Z);
(ii) a hydrocarbon component selected from the group consisting of propane and isobutane;
(iii) one or more additional compounds selected from the group consisting of:
(a) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFC-1131(E), CFC-114a, HCFC-124a, HFC-227ca, HFO-1234yf, HFC-152a, HFO-1234zf, HFC-134, HFC-245cb and combinations thereof;
(b) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131 (E), CFC-114a, HCFC-124a, HFC-227ca, HFO-1234yf, HFC-152a, HFO-1243zf, HCC-30, HFC-134a, HFC-236fa, HFO-1327 isomer, HFO-1336mzz(E), CFO-1112a, HFC-227ea, HFC-245cb and combinations thereof;
(c) one or more, two or more, or three or more additional compounds selected from the group consisting of HFO-1234ze(E), HFC-263fb, HFO-1234zc, HFC-245fa, HCFO-1233zd(E), HCFO-1233zd(Z), HCFO-1233xf, HCFC-124, HCC-40, CFC-114, HCFO-1131(E), CFC-114a, HCFC-124a, HFC-227ca, HFO-1234yf, HFC-152a, HFO-1243zf, HCC-30, HFC-134a, HFC-236fa, HFO-1327me, HFO-1336mzz(E), CFO-1112a, HFC-227ea, HFC-245cb, CFO-1112 and combinations thereof; and
(d) one or more, two or more, or three or more additional compounds selected from the group consisting of HFO-1234ze(E), HFC-236fa, HFC-227ea, HFC-245fa, HFO-1234zc, CFC-114, HCFO-1233xf, HCFO-1233zd(E), HCFO-1233zd(Z), HFO-1327me, HFO-1336mzz(E), CFO-1112 and combinations thereof; and
(iv) one or more additional compounds selected from the group consisting of:
(a) when the hydrocarbon component is propane, one or more additional compounds selected from the group consisting of butane, isobutane, propylene, pentane and isopentane, or one or more additional compounds selected from the group consisting of methane, ethane, butadiene, allene, butane, cyclobutane, acetylene, propyne and propylene; or
(b) when the hydrocarbon component is isobutane, one or more additional compounds selected from the group consisting of butane, propane, propylene, pentane and isopentane, or one or more additional compounds selected from the group consisting of methane, ethane, butadiene, allene, methyl cyclopropane, 2-methylpropene, propane, propyne and propylene.

2. The composition of claim 1, wherein when the hydrocarbon component is propane, the propane component comprises 99.9 wt. % propane and 0.1 wt. % one or more additional compounds selected from the group consisting of isobutane, butane, methane, ethane and combinations thereof.

3. The composition of claim 2, wherein a total amount of methane and ethane is less than 100 ppm, based on the total weight of the propane component.

4. The composition of claim 1, wherein when the hydrocarbon component is propane, the propane component comprises 99.9 wt. % propane and 0.1 wt. % one or more additional compounds selected from the group consisting of isobutane, butane, propylene, methane, ethane and combinations thereof.

5. The composition of claim 4, wherein a total amount of methane and ethane is less than 100 ppm, based on the total weight of the propane component.

6. The composition of claim 4, wherein a total amount of propylene, methane and ethane is less than 100 ppm, based on the total weight of the propane component.

7. The composition of claim 1, wherein when the hydrocarbon component is propane, the propane component comprises 99.9 wt. % propane and 0.1 wt. % one or more additional compounds selected from the group consisting of isobutane, butane, propylene, butadiene, allene, propyne, methane, ethane and combinations thereof.

8. The composition of claim 7, wherein a total amount of propylene, methane and ethane is less than 100 ppm, based on the total weight of the propane component.

9. The composition of claim 7, wherein a total amount of butadiene, allene and propyne is less than 100 ppm, based on the total weight of the propane component.

10. The composition of claim 1, wherein when the hydrocarbon component is isobutane, the isobutane component comprises 99.9 wt. % isobutane and 0.1 wt. % one or more additional compounds selected from the group consisting of butane, 2-methylpropene, methyl cyclopropane, methane, ethane and combinations thereof.

11. The composition of claim 10, wherein a total amount of methane and ethane is less than 100 ppm, based on the total weight of the isobutane component.

12. The composition of claim 10, wherein a total amount of butane, 2-methylpropene, methyl cyclopropane, methane and ethane is less than 100 ppm, based on the total weight of the isobutane component.

13. The composition of claim 11, wherein when the hydrocarbon component is isobutane, the isobutane component comprises 99.9 wt. % isobutane and 0.1 wt. % one or more additional compounds selected from the group consisting of propane, butane, butadiene, propyne, allene, propylene, methane, ethane and combinations thereof.

14. The composition of claim 13, wherein a total amount of methane and ethane is less than 100 ppm, based on the total weight of the isobutane component.

15. The composition of claim 13, wherein a total amount of butadiene, allene and propyne is less than 100 ppm, based on the total weight of the isobutane component.

16. The composition of claim 13, wherein a total amount of propane, butane, butadiene, propyne, allene, propylene, methane and ethane is less than 100 ppm, based on the total weight of the isobutane component.

17. A system for cooling or heating comprising an evaporator, compressor, condenser, and expansion device, said system containing the composition of claim 1.

18. A method for producing heating in a high temperature heat pump, the method comprising condensing the composition of claim 1 in a condenser, wherein the high temperature heat pump uses condenser operating temperatures greater than about 55° C., or from about 55° C. to about 160° C., or from about 55° C. to about 150° C.

19. A high temperature heat pump comprising a condenser and the composition of claim 1, wherein an operating temperature of the condenser is greater than about 55° C., or from about 55° C. to about 160° C., or from about 55° C. to about 150° C., or from about 55° C. to about 130° C.

20. The composition of claim 1, wherein the composition is at least one of a refrigerant composition, dielectric gas, an etching gas and a propellant.

21. A heating or cooling system comprising, in a serial arrangement:
a condenser;
an evaporator; and
a compressor, the system further comprising each of the condenser, evaporator and compressor operably connected, the composition of claim 1 being circulated through each of the condenser, evaporator and compressor.

22. The heating or cooling system of claim 21, wherein the system is an air conditioner for an automotive system, or wherein the system is an air conditioner for a stationary cooling system, or wherein the system is a heat pump for an automotive system, or wherein the system is heat pump for a residential heating or cooling system.

23. A heat pump system comprising the composition of claim 1.

24. The heat pump system of claim 23, wherein the heat pump system is selected from the group consisting of an HEV heat pump system, a MHEV heat pump system, a PHEV heat pump system, and an EV heat pump system.
